(19) United States
(12) Patent Application Publication
(10) Pub. No.: US 2008/0255637 A1
(43) Pub. Date: Oct. 16, 2008

(54) Thermotherapy System Based on Redox Potential

(76) Inventor: Takahiko Oishi, Osaka (JP)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 11/596,803

(22) PCT Filed: May 19, 2005
(86) PCT No.: PCT/JP05/09196

§ 371 Date: Feb. 5, 2008

(30) Foreign Application Priority Data
May 19, 2004 (JP) 2004-149797

(51) Int. Cl. A61H 33/00

(52) U.S. Cl. 607/85

(57) ABSTRACT

A method for treating a disease by returning the body to a natural condition. The method adjusts a parameter of a thermotherapy for treating or preventing the disease, disability, or condition of a patient and comprises (A) a step of measuring the redox potential (or pH value) of the patient and (B) a step of determining the parameter of thermotherapy suited to the patient according to the redox potential. Considering returning the biopotential to a range called homeostatic potential, a therapeutic potential of −75 mV to −90 mV (the potential in the cell is −75 mV) the absolute value of which is higher than that of the cell is given. It has been found that this therapy effects a cure.

### TECHNICAL FIELD

The present invention relates to a thermo-therapeutic apparatus for immersing a substantial whole body of a patient except for a cephalic portion, and particularly to a thermo-therapeutic apparatus for use in a treatment of difficult-to cure infective diseases such as cancers and HIV.

### BACKGROUND ARTS

Conventionally, for the treatment of cancer, a surgical treatment, a radio treatment and other treatment have been conducted, but all of these treatments are aggressive treatments, damaging patients. At the present situation, there is no appropriate treatment for a difficult to cure infective diseases such as HIV. In recent years, a thermotherapy (hyperthermia) has been aiming as an innocuous therapeutic method in which a difference of temperature sensitivity between normal cells and cancer cells or virus is used to kill cancer cells and virus while protecting normal cells by warming an affected area at a temperature from 41 to 43° C. It has been confirmed that a therapeutic effect is enhanced by combination of a radio therapy or a chemical therapy in combination with the thermotherapy.

There are two types in thermotherapy; one is a partial thermotherapy which only warms up a specific affected area, the other being a whole body thermotherapy which uniformly warms up a whole body. Attempts have been made to a method for irradiating a high frequency wave or a super sonic wave onto an affected area, and a method for inserting a needle of electric rod into an affected area and then warming up the affected area as for the partial thermotherapy and a method for warming up bloods through an extracorporeal circulation, and a method for irradiating an infrared ray onto a body as for a whole body thermotherapy.

However, there are the following problems in the conventional thermotherapy: In the case of the partial thermo-therapeutic methods such as a method for irradiating a high frequency wave or a super sonic wave onto an affected area, and a method for inserting a needle of electric rod into an affected area and then warming up the affected area, although it is effective for topical cancer etc., it does not give a therapeutic effect enough for treating a cancer which metastasizes to an entire body and for virus which circulates within blood.

In the case of the method for warming up bloods through an extracorporeal circulation, which warms up the whole body, it can be expected to have a therapeutic effect for treating a cancer which metastasizes to an entire body and for virus which circulates within blood. However, in order to warm up the depth temperature of whole body, it is required to warm up the blood to the temperature of from 45 to 46° C. Since heparin or such is administrated for preventing the coagulation of blood in a usual case, a limit of the therapeutic period is approximately 1 hour, and after such a treatment, the patient has physical load in such an extent not to be standing up over a several days after the therapy.

In the case of the method for irradiating an infrared ray, t can be expected to have a therapeutic effect for treating a cancer which metastasizes to an entire body and for virus which circulates within blood. However, in order to warm up the depth temperature of whole body, to 41 to 42° C., it is required to warm up the skin temperature up to 65° C. or more, leading to a low temperature burn injuries if the infrared ray is irradiated over a prolong time. For this reason, the limit of the therapeutic period is also approximately 1 hour, making it difficult to conduct a treatment which keep the depth temperature at a treatment temperature for a long time.

In contrast, in the case of a whole body immersion type thermotherapy which immerse a substantial whole body of a patient except for a cephalic portion to warm up the body temperature, since the patient directly immerses in warm water, thermal conductivity is drastically enhanced. For this reason, the whole body temperature can be increased to a required temperature within a short period without disposing the patient to too high temperature, the physical load of the patient can be reduced, making it possible to conduct a treatment for a long time.

We have provided a thermo therapeutic apparatus which is adapted to a cancer which metastasizes to an entire body and to difficult to cure infective diseases such as HIV, which can warm up a depth body temperature to a therapeutic temperature without disposing the patient to too high temperature and can keep the therapeutic temperature with good accuracy, and which can conduct a treatment in a non-invasive manner against the normal cell in Japanese Patent Laid-Open No. 2003-126135 (Patent Document 1), Japanese Patent Laid-Open No. 2003-126138 (Patent Document 2), and Japanese Patent Laid-Open No. 2001-299798 (Patent Document 3).

However, parameters of thermotherapy including a therapeutic temperature of a patient in order to exhibit the thermotherapy effect at the fullest extent differ depending upon individual patients. Also, in the case of the same patient, the parameters will be changed daily. In the conventional methods, the thermotherapy has been conducted utilizing parameters of a temperature ranges generally said to be preferable and other parameters and the like.

For this reason, the conventional methods are of problems that thermo therapeutic effect for individual patient cannot be obtained, as well as the physical strength of the patient is consumed. For example, if the actual therapeutic temperature of the patient is lower than the optimal therapeutic temperature, enough therapeutic effect cannot be obtained, and the period for loading the patient is increased. Conversely, if the actual therapeutic temperature of the patient is higher than the optimal therapeutic temperature, granulocytes are unduly increased. In some cases, even if a thermotherapy is conducted within a temperature range generally referred to be preferable, it has been reported that adverse effects that granulocytes will be deformed, necrotized or destroyed have been observed.

A method for adjusting therapeutic temperature and other parameters has not yet been unraveled in the existing techniques, the thermotherapy are often conducted without any plan. For example, Japanese Patent Laid-Open No. 07-112005 (Patent Document 4) suggests a technical idea that period equivalent to 43° C. considering in vivo information is used. This only considers a topical treatment, and the situation of whole body is not substantially considered.

Japanese Utility Model Laid-Open No. 06-64792 (Patent Document 5) suggests improvement of a bathtub for thermotherapy. This only suggests the improvement in the bathtub but does not consider parameters for human body.

In “Circulation, 2004, Apr. 13; 109 (4): 1763-8 Epub 2004 Mar. 29 (Thermal Treatment attenuates neoinitimal thickening with enhanced expression of heat-shock protein 72 and suppression of oxidative stress” (Non-Patent Document 1), thermotherapy increases the expression of HSP 72, dissolves having a possibility of cancer treatment. However, this has a disadvantage that no control of thermotherapy can be made.

### Patent Document 1: Japanese Patent Laid-Open No. 2003-126135

### Patent Document 2: Japanese Patent Laid-Open No. 2003-126138

### Patent Document 3: Japanese Patent Laid-Open No. 2001-299798

### Patent Document 4: Japanese Patent Laid-Open No. 07-112005

### Patent Document 5: Japanese Utility Model Laid-Open No. 06-64792

### Non-Patent Document 1: Circulation, 2004, Apr. 13; 109 (4): 1763-8 Epub 2004 Mar. 29

### SUMMARY OF THE INVENTION

The present invention has been conducted in order to dissolve the above disadvantages and an object of the present invention is to realize how to control the thermo-therapeutic apparatus for treating various diseases.

The present invention has been conducted in order to dissolve the above disadvantages and an object of the present invention is to provide a thermo-therapeutic apparatus, which is adapted to a cancer which metastasizes to an entire body and to difficult to cure infective diseases such as HIV, which can warm up a depth body temperature to a therapeutic temperature without disposing the patient to too high temperature and can keep the therapeutic temperature with good accuracy, which can conduct a treatment in a non-invasive manner against the normal cell, and which can undergo thermotherapy under the conditions (for example, temperature and time) optimal for an individual patient.

The above object has been dissolved by monitoring the redox electric potential in the living body to control the thermotherapy to obtain unexpected therapeutic effects.

Consequently, the preset invention provides a method for regulating a parameter for treating or preventing a situation of a disease or disorder of a patient comprising: (A)

a step for measuring a redox potential of the patient; and (B) a step for deciding parameters of the thermotherapy suitable for the patient.

The present invention also provide a method for treating or preventing a diseases or disorder of a patient, which comprises; a step for applying the patient to the thermotherapy based on the parameters decided according to the above method.

The present invention also provides a system for controlling parameters for thermotherapy for treating or preventing a diseases or disorder of a patient, which comprises; A) means for measuring redox electric potential of the patient; and B) means for determining parameters for thermotherapy suitable for the patient based on the redox electric potential.

The present invention further provides a system for treating or preventing a diseases or disorder of a patient, which comprises;

A) means for measuring redox electric potential of the patient; B) means for determining parameters for thermotherapy suitable for the patient based on the redox electric potential; and C) means for applying the patient to the thermotherapy based on the parameters.

In one embodiment of the method or system of the present invention, the thermotherapy include immersing the patient in a warm water bath.

In one embodiment of the method or system of the present invention, said redox electric potential is determined by measuring the redox electric potential or a pH value (particularly of blood, specifically a peripheral blood).

In a preferred embodiment of the method or system of the present invention, said body temperature is observed by a rectal temperature.

In another embodiment of the method or system of the present invention, said parameters of the thermotherapy are decided considering at least one factor selected from gas analysis, hemocyte fractionation biochemistry, disease marker, SpO₂, hart rate, and a blood flow rate.

In another embodiment of the method or system of the present invention, said parameters of the thermotherapy include a heating temperature and a heating period. The heating temperature is usually 39° C. to 45° C., the temperature from 4 to 5° C. higher than the rectal temperature may be used.

In another embodiment of the method or system of the present invention, a step or means for obtaining the Redox electric potential and further controlling the control of the body temperature is included.

In another embodiment of the method or system of the present invention, a step or means for obtaining the Redox electric potential and further controlling the control of the body temperature is carried out at least one point in time when the body temperature of the patient is increased to 0.1° C., arrives at 39° C., and arrives at the maximum temperature. Preference is give to use these three steps or means.

In one embodiment of the method or system of the present invention, said further controlling is carried out considering at least one factor selected from gas analysis, hemocyte fractionation biochemistry, disease marker, SpO₂, hart rate, and a blood flow

In another embodiment of the method or system of the present invention, a step or means for further measuring the Redox electric potential after controlling of the body temperature of the patient is include. The further controlling may be carried out by considering at one factor selected from gas analysis, hemocyte fractionation biochemistry, disease marker, SpO₂, hart rate, and a blood flow rate.

In one embodiment, the decision of the parameters is carried out based on the treatment of the patient within a warm bath at a temperature 3 to 5° C. higher than the rectal temperature.

In another embodiment, a parameter for the disease, if present, is considered.

In one embodiment, the redox electric potential may be decided by the measurement of the redox electric potential from the blood of the patient.

In one embodiment, the disease aiming at the present invention includes a disease related to symptoms of immune.

In a preferred embodiment, the disease aiming at the present invention is selected from the group consisting of cancers, virus-infected diseases, metabolic diseases, circulatory organ system diseases, alimentary system, inflammatory diseases, central nerve system disease, immunological diseases, infections, and lifestyle related diseases.

In a more preferred embodiment, virus-infected disease aiming at the present invention is selected from the group consisting of hepatitis B, hepatitis Candy acquired immune deficiency (AIDS).

In another preferred embodiment, metabolic disease aiming at the present invention is selected from the group consisting of diabetes mellitus, complication of diabetes mellitus, benign prostatic hyperplasia, gout and hepatitis.

In another preferred embodiment, the immunological disease aiming at the present invention is selected from the group consisting of autoimmune disease, and acquired immune deficiency syndrome.

In another preferred embodiment, the cancer aiming at the present invention is selected from the group consisting of malignant lymphoma, pancreas cancer, uterine cervix cancer, oral cavity fundus cancer, and kidney cancer.

In another embodiment, the circulatory organ system disease aiming at the present invention includes hypertension.

In another embodiment, the circulatory organ system disease aiming at the present invention includes ulcerative colitis.

In another embodiment, the immunological disease aiming at the present invention is selected from the group consisting of immune deficiency (e.g., AIDS), malignant lymphoma, chronic rheumatoid arthritis, chronic granulomatosis, inflammatory enteropathy, and neutropenia.

In still another embodiment, the disease is accompanied by decreasing of the number of the lymphocytes.

In one embodiment of the method or system treating or preventing a diseases or disorder of a patient of the present invention, a step or means for measuring the redox electric potential of the patient, and then modifying the parameter based on the measured redox electric potential is included.

In one embodiment of the method or system treating or preventing a diseases or disorder of a patient of the present invention, the thermotherapy is continued until the redox electric potential is recovered. The repeating interval may be voluntarily decided for example, daily, every second day, 1 to 7 per week, 1 to 31 days per month.

In one embodiment of the method or system treating or preventing a diseases or disorder of a patient of the present invention, the thermotherapy is continued until the pH value of the patient becomes at least 0.05 higher than that before the treatment. By increasing the pH value to allow the pH value of the living body for returning to the normal level, the living body is returned to the healthy state. As for standard of the absolute value, pH value from 7.35 to 7.45 is preferable, but the pH level is varied depending on the situation. More preferably, the pH level is from 7.40 to 7.45, but not being restricted thereto.

In one embodiment of the method or system treating or preventing a diseases or disorder of a patient of the present invention, the thermotherapy is continued until the pH value of the patient becomes at least 0.1 higher than that before the treatment. It is not possible for the conventional method to vary the pH 0.1, i.e., usually variation within plus minus 0.05 (e.g., pH level can be varied with the range of from 7.35 to 7.45 in the case where homeostatic pH is 7.40. Consequently, in the present invention, therapy exceeding the prior art pH variation has been shown to be realized. Such a variation of pH exceeding 0.1 makes it possible to treat a disease which has not conventionally been cured.

In the therapy up to now, there is no consideration of the redox electric potential. For this reason, no effective, sure therapy has yet been provided. In the present invention, since it has been indicated that the therapeutic effects and redox electric potential of the living body are directly related, sure therapy can be provided. Particularly, in the conventional therapy, there is a case that a disease is cure or not cured, and a case where a disease such as AIDS cannot be cured. In the present invention, since the immune situations can be surely recovered (for example, increasing of lymphocytes by conducting the therapy based on the redox electric potential in the living body, the cure of the diseases which are uncertainly curable or not curable, can be cured at a high probability.

In one embodiment of the method or system treating or preventing a diseases or disorder of a patient of the present invention, the thermotherapy is continued until the redox electric potential of the patient becomes at least 5 MV at an absolute value higher than the pH value before the treatment.

In one embodiment of the method or system treating or preventing a diseases or disorder of a patient of the present invention, the thermotherapy is continued until the redox electric potential of the patient becomes between −75 mV and −80 mV.

In one embodiment of the method or system treating or preventing a diseases or disorder of a patient of the present invention, a step or means for increasing the rectal temperature of the patient to at least 39° C. is included.

In one embodiment of the method or system treating or preventing a diseases or disorder of a patient of the present invention, a step or means for maintaining the rectal temperature of the patient to at least 39° C. for at least 10 minutes is included.

In one embodiment of the method or system treating or preventing a diseases or disorder of a patient of the present invention, wherein the temperature difference between the rectal temperature before the treatment and the temperature of the warming bath is within 0.5° C.

In another aspect, the present invention provides a thermo therapeutic apparatus. This apparatus is a system for treating or preventing a diseases or disorder of a patient, which comprises;

A) means for specifying a therapeutic temperature for exhibiting the thermo therapeutic effect against the patient based on a Redox electric potential or pH value of the patient;

B) thermo therapeutic means;

C) temperature detecting means for detecting the body temperature of the patient; and

D) a control device which calculates a command to direct to control the body temperature of the patient from the temperature information to said thermo therapeutic means from the temperature information based on the body temperature information from the temperature detecting means,

wherein said control device is connected to said means for specifying a therapeutic temperature so as to receive information for the body temperature and information for the therapeutic temperature, respectively, and calculates orders to the thermotherapeutic means.

In one embodiment, in addition to the redox electric potential, said means (A) for specifying a therapeutic temperature specifies the therapeutic temperature further based on the change in the living body selected from the group consisting of: a) an amount and a function of hsp 72 in the blood of the patient; b) a change in blood pressure pg the patient; c) a hart rate of the patient; d) a blood flow of the patient; e) a pH of the blood of the patient; f) an amount of expressing HLA in the blood of the patient; and a number of lymphocytes in the blood of the patient.

In one embodiment, the means (A) for specifying a therapeutic temperature specifies the therapeutic temperature utilizing as an index hsp 72 or HLA varied (for example, produced) by varying the temperature of the peripheral blood collected from the patient in vitro.

In one embodiment, said thermo therapeutic means has a heating tank.

In on embodiment, said thermo therapeutic means heat the temperature through a liquid.

In one embodiment, the thermo therapeutic means has a safety device so that the temperature is not increasing to be a prescribed level.

In one embodiment, the thermo therapeutic means comprises a bathing apparatus.

In one embodiment, the thermo therapeutic means has a temperature maintaining device.

In one embodiment, the thermo therapeutic means has a warm water supply device or a heating device, temperature controlling means, and cooling means.

In one embodiment, the temperature detecting means is a clinical thermometer for measuring a body temperature selected from the group consisting of an axillary thermometer, a sublingual thermometer, a rectal thermometer, a deep subcutaneous thermometer, a drum membrane thermometer, and an esophagus thermometer.

In one embodiment, the temperature detecting means is a sublingual thermometer, or a rectal thermometer.

In one embodiment, the system further comprises means for storing a normal temperature of the patient.

In one embodiment, the system further comprises means for recording a body temperature of the patient.

In one embodiment, the system further comprises:

two temperature control means of first temperature control means and second temperature control means having a specific heat or a performance for varying the temperature lower than that of the first temperature means; and

wherein said control device orders to actuate the first temperature control means when the subjective to be thermally controlled has a temperature deviating from a prescribed range, and orders so that the first temperature control means is stopped and the second temperature control means is actuated when the subjective to be thermally controlled has a temperature within the prescribed range; or wherein said control device orders so that the first temperature control means is actuated and the second temperature control means is placed so as to be thermally insulated from the subject when the subjective to be thermally controlled has a temperature deviating from a prescribed range, and the first temperature control means is stopped and is placed so as to be thermally insulated from the subject and the second is actuated when the subjective to be thermally controlled has a temperature within the prescribed range.

In one embodiment, the control device calculates an order that the thermo therapeutic means is heated to a temperature lower than the temperature 5° C. higher than the body temperature.

In one embodiment, the control device calculates an order that temperature is maintained at a temperature lower than the temperature 5° C. higher than the body temperature.

In one embodiment, the control device calculates an order that the thermo therapeutic means is heated until the measured body temperature becomes the therapeutic temperature.

In one embodiment, the disease or disorder is selected from the group consisting of cancers, infections, chronic diseases, lifestyle related diseases, paracite related disease, immune facilitation, immune dificiency, and drug poisoning.

In one embodiment, the disease or disorder includes a disorder curable by an immune system.

In one embodiment, the disease or disorder includes a cancer.

A system for regulating a body temperature of a patient according to the present invention comprises A) means for specifying a therapeutic temperature for exhibiting the thermo therapeutic effect against the patient based on a Redox electric potential or pH value of the patient; B) thermo therapeutic means; C) temperature detecting means for detecting the body temperature of the patient; and D) a control device which calculates a command to direct to control the body temperature of the patient from the temperature information to said thermo therapeutic means from the temperature information based on the body temperature information from the temperature detecting means, wherein said control device is connected to said means for specifying a therapeutic temperature so as to receive information for the body temperature and information for the therapeutic temperature, respectively, and calculates orders to the thermotherapeutic means.

A system for regulating an expression and function of hsp 72 of a patient according to the present invention comprises; A) means for specifying a therapeutic temperature for regulating an expression and function of hsp 72 of the patient based on a Redox electric potential or pH value of the patient; B) thermo therapeutic means; C) temperature detecting means for detecting the body temperature of the patient; and D) a control device which calculates a command to direct to control the body temperature of the patient from the temperature information to said thermo therapeutic means from the temperature information based on the body temperature information from the temperature detecting means, wherein said control device is connected to said means for specifying a therapeutic temperature so as to receive information for the body temperature and information for the therapeutic temperature, respectively, and calculates orders to the thermo therapeutic means.

In one embodiment, the system activates immune system by the regulation of expression and function of hsp 72

A system for regulating an expression and function of HLA of a patient according to the present invention comprises A) means for specifying a therapeutic temperature for regulating an expression and function of HLA of the patient based on a Redox electric potential or pH value of the patient; B) thermo therapeutic means; C) temperature detecting means for detecting the body temperature of the patient; and D) a control device which calculates a command to direct to control the body temperature of the patient from the temperature information to said thermo therapeutic means from the temperature information based on the body temperature information from the temperature detecting means,

wherein said control device is connected to said means for specifying a therapeutic temperature so as to receive information for the body temperature and information for the therapeutic temperature, respectively, and calculates orders to the thermotherapeutic means.

In one embodiment, the system activates immune system by the regulation of expression and function of HLA

A system for treating or preventing a diseases or disorder of a patient of the present invention comprises A) thermo therapeutic means; B) means for acquiring a sample from the patient; C) means for measuring a heat schlock protein (hsp) within said sample; and D) means for regulating the thermo therapeutic means based on an expression pattern of hsp.

In one embodiment, the expression pattern of hsp includes an expression pattern of hsp 72.

In one embodiment, the regulation includes an expression of hsp.

A system for treating or preventing a diseases or disorder of a patient according to the present invention comprises A) thermo therapeutic means; B) means for acquiring a sample from the patient; C) means for measuring HLA within said sample; and D) means for regulating the thermo therapeutic means based on an expression pattern of HLA.

In one embodiment, the expression pattern of HLA includes an expression pattern of HLA-DR.

In one embodiment, the regulation includes such a regulation as to enhance an expression of HLA.

A method for treating or preventing a diseases or disorder of a patient according to the present invention comprises A) a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature

In one embodiment, said information of normal body temperature of the patient is obtained by temperature detecting means.

In one embodiment, the method further comprises: D) a step for specifying a therapeutic temperature for exhibiting the thermo therapeutic effect against the patient based on a Redox electric potential or pH value of the patient at the maximum.

In one embodiment, the body temperature of the patient is increased to and maintained at a temperature of the therapeutic temperature specified in step D) plus minus 1.0° C.

In one embodiment, the body temperature of the patient is increased to and maintained at a temperature of the therapeutic temperature specified in step D) plus minus 0.3° C.

In one embodiment, the step D) is based on the change in the living body selected from the group consisting of: a) an amount and a function of hsp 72 in the blood of the patient; b) a change in blood pressure pg the patient; c) a hart rate of the patient; d) a blood flow of the patient; e) a pH of the blood of the patient; f) an amount of expressing HLA in the blood of the patient; and g) a number of lymphocytes in the blood of the patient.

In one embodiment, the step D) is carried out by utilizing as index hsp 72 or HLA varied by varying the temperature of the peripheral blood collected from the patient in vitro.

In one embodiment, said disease or disorder is selected from the group consisting of cancers, infections, chronic diseases, lifestyle related diseases, paracite related disease, immune facilitation, immune dificiency, and drug poisoning.

In one embodiment, said disease or disorder includes a disorder curable by an immune system.

In one embodiment, said disease or disorder includes a cancer.

In program for executing a method for treating or preventing a diseases or disorder of a patient according to the present invention, the method comprises A) a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature

In one embodiment, the method further comprises: D) a step for specifying a therapeutic temperature for exhibiting the thermo therapeutic effect against the patient based on a Redox electric potential or pH value of the patient at the maximum.

In one embodiment, the program calculates an order that the thermo therapeutic means is heated to a temperature lower than the temperature 5° C. higher than the body temperature.

In one embodiment, the program calculates an order that temperature is maintained at a temperature lower than the temperature 5° C. higher than the body temperature.

In one embodiment, the program calculates an order that the thermo therapeutic means is heated until the measured body temperature becomes the therapeutic temperature.

A method for regulating an expression and function of hsp 72 in the patient according to the present invention comprises: a step for acquiring information of normal body temperature of the patient B) a step for increasing the body temperature of the patient to a therapeutic temperature higher than the normal body temperature by means of a thermo therapeutic means; and C) maintaining the body temperature of the patient at the therapeutic temperature

In one embodiment, the method further comprises: D) a step for specifying a therapeutic temperature for expressing hsp 72 of the patient based on a Redox electric potential or pH value of the patient at the maximum.

In one embodiment, the information of normal body temperature of the patient is obtained by temperature detecting means.

In one embodiment, the body temperature of the patient is increased to and maintained at a temperature of the therapeutic temperature specified in step D) plus minus 1.0° C.

In one embodiment, the body temperature of the patient is increased to and maintained at a temperature of the therapeutic temperature specified in step D) plus minus 0.3° C.

In one embodiment, the step D) is based on the change in the living body selected from the group consisting of: a) an amount and a function of hsp 72 in the blood of the patient; b) a change in blood pressure pg the patient; c) a hart rate of the patient; d) a blood flow of the patient; e) a pH of the blood of the patient; f) an amount of expressing HLA in the blood of the patient; and g) a number of lymphocytes in the blood of the patient.

In one embodiment, the step D) is carried out by utilizing as index hsp 72 or HLA varied by varying the temperature of the peripheral blood collected from the patient in vitro.

In one embodiment, the method regulates an expression and function of hsp 72 without modification, necrosis or destroy of granulocytes.

In a program for executing a method for regulating an expression and function of hsp 72 in the patient according to the present invention, the method comprises: A) a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature

In one embodiment, the method further comprises: D) a step for specifying a therapeutic temperature for expressing hsp 72 of the patient based on a Redox electric potential or pH value of the patient at the maximum.

A method for using a thermo therapy for treating or preventing a diseases or disorder of a patient according to the present invention comprises A) a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature, over a period until an expression of hsp 72 is varied.

In one embodiment, the method further comprises; D) a step for specifying a therapeutic temperature for exhibiting the thermo therapeutic effect against the patient based on a Redox electric potential or pH value of the patient at the maximum.

In one embodiment, an expression and function of hsp 72 is regulated so that no modification, necrosis or destroy of granulocytes can be seen.

In a program for executing a thermo therapeutic method for treating or preventing a diseases or disorder of a patient according to the present invention, the method comprises A) a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature, over a period until an expression of hsp 72 is varied.

In one embodiment, the method further comprises D) a step for specifying a therapeutic temperature for exhibiting the thermo therapeutic effect against the patient based on a Redox electric potential or pH value of the patient at the maximum.

A method for increasing an expression of HLA in a patient according to the present invention comprises A) a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature.

In one embodiment, the method further comprises: D) a step for specifying a therapeutic temperature for expressing HLA of the patient based on a Redox electric potential or pH value of the patient at the maximum.

In one embodiment, the information of normal body temperature of the patient is obtained by temperature detecting means.

In one embodiment, the body temperature of the patient is increased to and maintained at a temperature of the therapeutic temperature specified in step D) plus minus 1.0° C.

In one embodiment, the body temperature of the patient is increased to and maintained at a temperature of the therapeutic temperature specified in step D) plus minus 0.3° C.

In one embodiment, an expression of HLA is regulated such that no modification, necrosis or destroy of granulocytes can be confirmed.

In a program for executing a method for increasing an expression of HLA in a patient, the method comprises A)

a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature

In one embodiment, the method further comprises: D) a step for specifying a therapeutic temperature for expressing HLA of the patient based on a Redox electric potential or pH value of the patient at the maximum.

A method for using a thermo therapy for treating or preventing a diseases or disorder of a patient according to the present invention comprises A) a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature, over a period until an expression of HLA is confirmed to be increased.

In one embodiment, the method further comprises; D) a step for specifying a therapeutic temperature for exhibiting the thermo therapeutic effect against the patient based on a Redox electric potential or pH value of the patient at the maximum.

In one embodiment, the constant period is a period for which no modification, necrosis nor destroy of granulocytes can be confirmed.

In a program for executing a method for using a thermo therapy for treating or preventing a diseases or disorder of a patient, the method comprises: A) a step for acquiring information of normal body temperature of the patient; B) a step for increasing the body temperature of the patient to a therapeutic temperature higher than the normal body temperature by means of a thermo therapeutic means; and C) maintaining the body temperature of the patient at the therapeutic temperature, over a period until an expression of HLA is confirmed to be increased.

In one embodiment, the method further comprises; D) a step for specifying a therapeutic temperature for exhibiting the thermo therapeutic effect against the patient based on a Redox electric potential or pH value of the patient at the maximum.

A temperature control system according to the present invention has at least two kinds of temperature control means; said temperature control means each having different specific heat or difference performance for varying the temperature.

In one embodiment, at least two kinds of temperature control means comprise first temperature control means and second temperature control means, and the system further comprises means which orders to actuate the first temperature control means when the subjective to be thermally controlled has a temperature deviating from a prescribed range, and orders so that the first temperature control means is stopped and the second temperature control means is actuated when the subjective to be thermally controlled has a temperature within the prescribed range.

In another embodiment, the at least two kinds of temperature control means comprise first temperature control means and second temperature control means, and the system further comprises means which orders so that the first temperature control means is actuated and the second temperature control means is placed so as to be thermally insulated from the subject when the subjective to be thermally controlled has a temperature deviating from a prescribed range, and the first temperature control means is stopped and is placed so as to be thermally insulated from the subject and the second is actuated when the subjective to be thermally controlled has a temperature within the prescribed range.

A method for regulating a temperature of a subjective to a therapeutic temperature according to the present invention comprises A) a step for actuating first temperature control means when the subjective to be thermally controlled has a temperature deviating from a prescribed range, and B) a step for stopping the first temperature control means and actuating the second temperature control means having a specific heat or a performance for varying the temperature lower than that of the first temperature means when the subjective to be thermally controlled has a temperature within the prescribed range.

In one embodiment, the method further comprises C) a step for stopping the first temperature control means when the temperature of the subjective is arriving at the therapeutic temperature.

A system for specifying a therapeutic temperature of a patient for exhibiting the thermo therapeutic effect against the patient at the maximum according to the present invention comprises an assay system for detecting the therapeutic temperature based on redox electric potential or a pH value of the patient.

In one embodiment, the therapeutic temperature of the patient is determined further based on the change in the living body selected from the group consisting of: a) an amount and a function of hsp 72 in the blood of the patient; b) a change in blood pressure pg the patient; c) a hart rate of the patient; d) a blood flow of the patient; e) a pH of the blood of the patient; f) an amount of expressing HLA in the blood of the patient; and g) a number of lymphocytes in the blood of the patient.

In one embodiment, the system further comprises means for extracting a sample of living body from the patient.

### ADVANTAGE OF THE INVENTION

Since the present invention can undergoes a thermotherapy of a patient under the optimal conditions for the patient (for example, temperature and period), the maximum thermotherapeutic effects can be obtained while suppressing consumption of the physical strength of the patient and can avoid any unexpected side effects.

These and other objects features and merits of the present invention described above will be much more clarified by the following embodiments and examples referring to the attached drawings.

### BRIEF DESCRIPTION OF THE DRAWINGS

FIG. 1 shows a configuration of a thermo-therapeutic apparatus according to one embodiment of the present invention.

FIG. 2 is a front view illustrating a body mechanism of the thermo therapeutic apparatus according to one embodiment of the present invention.

FIG. 3 is a side view of this body mechanism.

FIG. 4 shows an outer lid of the thermotherapeutic apparatus according to one embodiment of the present invention.

FIG. 5 shows an example of the temperature control algorism of the thermotherapeutic apparatus according to one embodiment of the present invention.

FIG. 6 shows an outlook of the device for controlling the living body in the thermotherapeutic apparatus according to one embodiment of the present invention.

FIG. 7 shows the configuration of a one-tank type thermo therapeutic system according to another embodiment of the present invention.

FIG. 8 shows a therapeutic control flow of the thermotherapeutic apparatus according to the present invention by the control device.

FIG. 9 shows a processing flow of the temperature increasing treatment (S400) according to the first example.

FIG. 10 shows a processing flow of the temperature increasing treatment (S400) according to the second example.

FIG. 11 shows a processing flow of the temperature increasing treatment (S400) according to the third example.

FIG. 12 shows the treatment flow of an example of the temperature maintaining treatment (S500).

FIG. 13 shows the follow flow for temperature decreasing treatment (S600) according to the first example.

FIG. 14 shows the follow flow for temperature decreasing treatment (S600) according to the first example.

FIG. 15 is a drawing showing a change of the liquid temperature and the depth body temperature with the time elapse when the therapy of the present invention is carried out.

FIG. 16 is an explanatory drawing specifying the therapeutic temperature in the present invention.

### EXPLANATION OF SYMBOLS

10 Therapeutic Tank
12 Heating Thank
14 Heater
16 Cooling Fan
20 Circulation Line
22, 26 Circulation Pump
24, 28 Stirring Nozzle
32 Communication Pipe
34 UV Lamp
40 Water Supply Line
50 Discharge Line
60 Thermosensor with Therapeutic Tank
62 Rectal Temperature Sensor
64 Thermosensor within Heating Tank
80 Controller
82 Computer
90 Outer Rid of Bathtub
92 Inner Rid of Bathtub
94 Heat Retention Flexible Cover
100 Bed having Posture Control Mechanism
102-108 Bed Lifting Mechanism
110-114 Bed Transferring Mechanism
120 Bed Transferring Cart
130 Head Cooler
200 Bio-monitor
210 Anesthesia Device
220 Respirator

### BEST MODES FOR CARRYING OUT THE INVENTION

The present invention will now be described. The expression singular throughout the description should encompass the plural form thereof as long as not specifically referred. Consequently, an article of singular form (for example, “a” “an”, “the” etc. in English) includes the conception of the plural form thereof. As long as not specifically referred, the term used herein should have the meaning usually utilized in this technical field. Consequently, as long as otherwise defined, all technical terms and scientific terms have the same meaning as those generally understood by those skilled in the art belonging to this technical field. If there is contradiction, the meanings (including definition) of the present invention should have a priority.

Definition of the terms specially utilized herein and basic techniques will now be listed and described below.

The term “thermotherapy” or “hyperthermia” used herein means a process or a system for carrying out a treatment of a patient or a subject by keeping the body temperature of the patient or the subject at a temperature higher than the temperature of the living body for a constant period. Such a thermotherapy includes therapy which warms up the body utilizing conductive heat (such as hot pack), radiation heat (such as infrared ray) and high frequency (such as ultrashort wave), and warm water (thermal bathing). Thermal bathing is proven to be preferable, because it can easily make the pH of living body change to be approximately 0.1 or more (approximately 6 mV or greater as electric potential).

“Redox electric potential” used herein means an electric potential generated during the course of exchanging electron in a given system. In this description, particularly, the electric potential of the body fluid of the living body (for example, blood such as peripheral blood) can be used as a subject to be monitored. The in vivo redox electric potential is also referred to herein as “in vivo electric potential, and these terms are used in exchangeable manner. This is also a measure for quantitatively evaluating the degree of discharging or acquiring an electron. The unit used is voltage (V). In the present invention, redox electric potential within living body (cell, particularly on the surface of a cell and cytomembrane) is important, which can be determined by measuring the redox electric potential or pH value of peripheral blood.

The measurement can be realized by using a commercially available device such as iSTAT (Fuso Chemical Industries Co., Ltd.).

Herein, since redox electric potential and pH value are corresponding to each other at 1:1, they can be exchangeably used. For example, approximately −70 mV of redox electric potential corresponds to pH 7.35, and difference of pH in 0.1 corresponds to the difference of redox electric potential in approximately 5.94 mV (about 6 mV). Consequently, the present invention can be performed by using any value of them (for example, pH 7.35 corresponds to approximately 64 mV and pH 7.35 corresponds to approximately −76 mv).

In the present invention, first the redox electric potential of subjective living body is understood. In the case where the pH value is less than 7.40, it is determined to be pathologic situation. In this case, standard thermotherapy is applied (for example, thermotherapy of increasing temperature to +4° C., e.g. for 60 minutes). As a result, if the redox electric potential is increased to 0.1 as pH value in comparison with pH value before treatment, the thermotherapy under these conditions are continued. If the increasing of pH value is small, the examination is made to increase the temperature or to elongate therapeutic period. When the standard thermotherapy is continued and when the pH value is increased approximately 0.1 or more, these conditions may be utilized. Alternatively, the rectal temperature is measured at approximately 0.5° C., and pH value at each time is measured to use the temperature which can give the maximum therapeutic effect is used. In the conventional method, only the pH value is changed within the range of from −0.05 to +0.05 and, thus, the effect of the present invention is very large.

The fact that the electric potential is very important for the thermotherapy is a theory discovered for the first time in the present invention. The theory will now be described in brief.

The genome and cells of the living body can be referred to a system for creating electric potential. Genome (DNA) exchanges the difference in the electric potential into energy to create proteins. In this case, the energy is migrated from a high electric potential to a low electric potential.

The human living body is composed of approximately 60 thousand billions of cells. Once cell has one genome and, approximately 60 thousand billions of cells have 60 thousand billions of genomes. Even if 60 thousand billions of cells exist, the kind of the genome is only one.

When a human contracts an illness, a protein (gene product) for curing the disease is required. Only a gene can create a protein. When a human contracts an illness, the disease can only be cured by a protein created by the gene of the human (protein for curing the disease).

As for mechanism of the gene for producing the protein for curing the disease, the understanding of the mechanism of the gene for producing a protein leads to curing the disease.

The disease can be defined the body abnormal caused by abnormality that abnormality of the protein produced by the gene is caused by any stress. In other words, the disease is caused by abnormality of producing a protein created by the gene.

Why the gene creates a protein causing the disease can be considered as follows: Energy is required for producing a protein by the gene. In the present invention, this energy is referred to as “protein-producing energy”. If an energy amount of the gene is low, a protein produced by a gene having a low electric potential. This protein is so-called disease protein.

In the present invention, as a result of serious studies, it has been discovered that there are a protein produced by a gene having a homeostasis electric potential (homeostasis electric potential=approximately −75 mV) and a protein produced by a gene having a high electric potential (a protein required for curing a disease=approximately −80 mV). Here, as for the redox electric potential of the living body, a standard cell membrane electric potential is approximately −70 mV, and a standard cytoplasm electric potential is approximately −75 mV. Here the low and high of the electric potential mean the degree of the absolute value.

A disease cell has a low pH (or electric potential), becomes acidic and is in a low energy state due to the decreasing of the electric potential.

A healthy cell has a high pH (or electric potential) l and is in a high energy state due to the decreasing of the electric potential.

The states of the electric potential are classified as follows:

Homeostasis electric potential=approximately −75 mV

Curing electric potential=approximately −75 mV to −90 mV (as the absolute value becomes higher a curing effect may be considered to be higher).

Cytoplasm electric potential is approximately −75 mV.

The electric potential is decreased by aging.

In the present invention, focusing on the relation between of cell membrane electric potential of a sick person and the protein thereof, it has been successful in carrying out effective therapy. We have discovered that all of the diseases can only be cured by the protein produced by the gene of the sick person.

A disease is caused due abnormality of a protein produced by a gene. Such a mechanism can be explained by the degree of the electric potential. Production energy is required for producing a protein, and if the electric potential is low, the cell membrane electric potential becomes approximately −70 mV, and the cytoplasm electric potential becomes approximately −75 mV.

Here, AIDS (HIV patient) actually cured by the present invention will now be exemplified. Here, the theory is referred to as theory of HIV transcriptase response.

With regard to HIV transcriptase response electric potential, it has been clarified that under the conditions where the electric potential within the infected cell (CD4: macrophage) is from −70 mV to approximately −74 mV HIV transcription of HIV is suppressed.

When the rectal temperature is 37° C., the peripheral blood has a pH value of 7.35, the cell membrane electric potential is approximately 70 mV, and cytoplasm electric potential is approximately −75 mV. The potential difference is approximately −5 mV. When the rectal temperature is increased to 39° C. by thermotherapy at which the pH value of peripheral blood becomes approximately 7.6, the cell membrane electric potential is approximately −84.75 mV, because the variation of pH in approximately 0.25 corresponds to approximately −14.75 mV. At this time, the electric potential within the cell is kept at approximately −75 mV. So, the potential difference becomes approximately 9.75 mV (outer side has a higher absolute value of minus). When the rectal temperature becomes approximately 39.4° C. and the pH value of the peripheral blood becomes approximately 7.55, the cell membrane electric potential is approximately −81.8 mV and the electric potential within the cell is approximately −75 as similarly calculated. Meanwhile, the difference is approximately 6.8 mV. By application of energy as described above, the production of homeostasis protein is derived to return the immune state into the original state. As a result, there is an instance that CD4 value is recovered from 400 (pathologic state) to 800.

In the present invention, the thermotherapy can be applied by referring to such data. In the present invention, the fact that the electric potential is returned to the range within the homeostasis electric potential is kept in mind. Since the therapeutic electric potential (electric potential within the cell) is −75 mV, the cure of the disease can be conducted by the application of the electric potential from −75 mV to −90 mV, which is a higher absolute value).

In such a case, while the difference in the redox electric potential which can give energy in the case of the rectal temperature of 39° C. becomes approximately 9.75 mV, in the case of the rectal temperature of 39.4° C., the difference is only approximately 6.8 mV. This means the thermotherapy at 39° C. is better for the patient. In this case, conditions of the thermotherapy (whole body bathing/half body bathing; period (1 hour) except for the rectal temperature are the same. So, the optimal electric potential can be determined in a similar manner.

The reason why the difference between the cell membrane electric potential and the electric potential within the cell is important is that mitochondria which is a resource for generating electric potential is existing within the cell.

An amount of the protein produced by the gene in the genome and the function thereof are determined in proportional to an amount of the energy produced by potential difference between the electric potential of the nuclear and the electric potential within the cell. At this time, for example, in a cell having a gene for acquired immune deficiency, there is a state that the expression potential expressed by this gene.

Summarizing the relation between the body temperature and the electric potential (pH), the amount of the genome production protein is not changed in proportional to the temperature, but is changed in proportional to the electric potential (pH). Consequently, it has been clarified that the what is directly connected is the electric potential (pH). In order to change the pH value, pO₂/pCO₂ is also has an important role, and it has been clarified that lymphocyte is related to pO₂, and the granulocyte is related to pCO₂. As described above, it can be understood that the protein produced by the gene is produced by energy generated doe to the potential difference.

In the actual therapy, it is preferable to search such conditions that pH value after therapy is approximately 0.1 higher than that before therapy (usually approximately from 0.1 to approximately 0.3, it is rare case to increase the pH value approximately 0.5, which is the more preferable case), and than to conduct the therapy under such conditions. In the case of measuring electric potential, the value can be calculated considering that the pH value of approximately 7.35 is equivalent to approximately −70 mV, and the change of pH value in 0.1 is equal to change of the electric potential in approximately 5.94 mV.

In the method for adjusting parameters of the thermotherapy according to the present invention, gas analysis, hemocyte fractionation biochemistry, disease marker, SpO₂, hart rate, blood flow rate and others can be considered.

The term “gas analysis” intended herein is to measure an existing amount of a subjective gas in the body fluid (for example, oxygen and carbon dioxide).

In the hemocyte fractionation biochemistry in the present invention, lymphocyte (for example, T lymphocyte and B lymphocyte), platelet, erythrocyte and the like can be measured.

The disease marker, which can be used herein, may be any of voluntary disease markers known in the art (for example, cancer marker).

The term “SpO₂” or “arterial oxygen saturation” intended herein means partial pressure in the arterial blood, which is used for observing the situation of sick person.

The diseases intended herein may of any of diseases and may be diseases or disorders directly or indirectly related to immune situation or homeostasis of the body. Examples thereof include, but are not restricted to, cancers, infective diseases due to virus or microorganisms, allergy, hypertension, hyperlipidemia, diabetes mellitus, cardiac disease, cerebral infarction, dementia, obesity, arteriosclerosis, infecundity, neurologic manifestation, cataract, prospermia, and UV/radio hypersensitivity.

The disorders intended herein may be any voluntary disorders related to abnormality in body.

According to one embodiment, the diseases or disorders may be circulatory organ system diseases or disorders (such as hemocyte cells). Examples of such diseases or disorders include, but are not restricted to:

anemia (for example, aplastic anemia (particularly heavy aplastic anemia, renal anemia, cancerous anemia, secondary anemia, refractoriness anemia), cancer or tumor (for example, leukemia) and hematopoiesis difficiency after chemical therapeutic treatment thereof, platelet-penia, acute myeloid leukemia (particularly, first honeymoon stage (High risk group), honeymoon stages after second honeymoon stage), acute lymphatic leukemia (particularly, first honeymoon stage (High risk group), honeymoon stages after second honeymoon stage), chronic myeloid leukemia (particularly chronic stage, migration stage), malignant lymphoma (particularly, first honeymoon stage (High risk group), honeymoon stages after second honeymoon stage), and multiple myeloma (particularly early stage after onset).

In another embodiment, the disease or the disorder may be those originated from nervous system. Examples include, but not restricted to, dementia, cerebral apoplexy, and aftereffect thereof, brain tumor, and spinal cord injury.

In another embodiment, the disease or the disorder may be those originated from immune system. Examples include, but not restricted to, T cell deficiency and leukemia.

In another embodiment, the disease or the disorder may be those originated from locomotorium and skeleton system. Examples include, but not restricted to, fracture, osteoporosis, dislocation or subluxation of articulation, distortion, ligament injury, osteoarthrosis, osteosarcoma, Ewing sarcoma, dysostosis, and osteochondrodysplasia.

In another embodiment, the disease or the disorder may be those originated from dermal system. Examples include, but not restricted to, atrichous, melanoma, skin malignant lymphoma, angiosarcoma, histiocytosis, blister, pustule, dermatitis, and eczema.

In another embodiment, the disease or the disorder may be those originated from endocrine system. Examples include, but not restricted to, disorders of hypothalamus, pituitary gland and thyroid, parathyroid gland (epithelial body) disorder, disorders of adrenal cortex and medulla, abnormal glucose metabolism, lipidosis, abnormal protein metabolism, abnormal nucleic acid metabolism, congenital abnormal metabolism (phenylketon-uria, galactoseuria, homocystinuria, maple syrup-uria), hypoalbuminemia, absence of synthesizing ascorbic acid, hyperbilirubinemia, hyperbilirubineuria, kallikrein defect, mast cell defect, diabetes insipidus, abnormal vasopressin secretion, microsomia, Wolman diseases (acid lipase deficiency), and mucopolysaccharidosis VI type.

In another embodiment, the disease or the disorder may be those originated from respiration system. Examples include, but not restricted to, lung diseases (for example, pneumonia and lung cancer), bronchus diseases.

In another embodiment, the disease or the disorder may be those originated from alimentary system. Examples include, but not restricted to, esophagus diseases (for example, esophagus cancer), stomach and duodenum diseases (for example, stomach cancer, and duodenum cancer), small intestine and colon diseases (for example, colon polyp, sigmoid colon cancer, rectum and cancer), bile duct and liver diseases (for example, liver cirrhosis, hepatitis (A, B, C, D, and E), fulminant hepatic failure, chronic hepatitis, primary hepatitis, alcoholic hepatitis, drug induced hepatitis, pancreas diseases (for example, acute pancreatitis, chronic pancreatitis, pancreas cancer, cystic pancreas diseases, peritoneum, abdominal wall, and diaphragm diseases (for example, hernia) and Hirschsprung's disease.

In another embodiment, the disease or the disorder may be those originated from urinary organ system. Examples include, but not restricted to, renal diseases (renal failure, primary glomerulonephritis, renovascular failure, renal tubule dysfunction, interstitial renal disease, renal disease due to systemic diseases, and renal cancer), bladder diseases (for example, cystitis and bladder cancer).

In another embodiment, the disease or the disorder may be those originated from genital organ urinary organ system. Examples include, but not restricted to, male genital organ diseases (for example, male infertility, benign prostatic hyperplasia, prostate gland cancer, and testis cancer), female genital organ diseases (for example, female infertility, ovary dysfunction, uterus myoma, uterus adenomyosis, endometriosis, ovarian cancer, and chorionic disease).

In another embodiment, the disease or the disorder may be those originated from circulatory organ urinary organ system. Examples include, but not restricted to, cardiac failure, angina pectoris, cardiac infarction, arrhythmia, valvular disease, cardiac muscle and pericardium diseases, congenital heart disease (for example, atriumtunica media defect, ventricle tunica media defect, arterial duct patency, and tetralogy of Fallot), artery diseases (for example, arteriosclerosis, and aneurysm), vein diseases (for example, varix), and lymph duct diseases (for example, lymphedema)

Examples of the disease or the disorder curable by immune system include, but not restricted to, atopic dermatitis, and chronic rheumatoid arthritis.

The cancers which can be treated or improved by the present invention include, but are not restricted to, brain tumor, leukemia, stomach cancer, lung cancer, hepatocellular carcinoma, metastatic cancer, primary breast cancer, relapsed breast cancer, primary liver cancer, biliary tract cancer, pancreatic cancer, renal cancer, prostate gland cancer, testis cancer, uterine body cancer, ovarian cancer, lung parvicellular cancer, leukemia, biliary tract cancer, digestive organ cancer, colon cancer, liver cancer, metastatic liver cancer, uterine cervix cancer, colon cancer, rectal cancer, thyroid cancer, breast cancer, urinary cancer, uterine cancer, esophagus cancer, hydatidiform mole cancer, chorioma, gastric HGC production tumor, gallbladder cancer, bile duct cancer, neuroblastoma, maxillary cancer, oral cavity cancer, oral cavity fundus cancer, urinary tract cancer, thyroid cancer, malignant lymphoma (Hodgkin or Non-Hodgkin), bladder cancer, hematopoietic tumor, prostate gland accompanied by bone metastasis, terminal stage cancer, neuroblastoma, lung small cell cancer, pheochromocytoma, gastrinoma, insulinoma, carcinoid, malignant tumor accompanied by hypercalcemia, adult T cell leukemia, external genital cancer, skin cancer, upper respiratory cancer, cephalic/cervix cancer, teratocarcinoma, bladder cancer, B cell leukemia, testis tumor, digestive organ cancer, acute myeloid meningeal leukemia, acute, acute lymphoblastic leukemia, malignant tumor, malignant melanoma, lymphoma, and lung squamous carcinoma.

The infections which can be treated or improved by the present invention include, but are not restricted to, HBV infection, HCV infection, various bacterio-infections, fungus infections, virus infections, HIV-1 infection, HIV-2 infection, herpesvirus (including but being not restricted to HSV-1, HSV-2, CMV, VZV, HHV-6, and HHV-7) infections, adenovirus infection, poxvirus infection, human papillomavirus infection, hepatitis virus infection, (for example, including but being not restricted to HAV, HBV, HCV), Helicoactor pylori infection, parasite infections, and HTLV-1 infection.

The lifestyle-related diseases which can be treated or improved by the present invention include, but are not restricted to, diabetes mellitus, arteriosclerosis (including but being not restricted to cerebral infarction, angina pectoris, and cardiac infarction), hypertension, malignant tumor, emphysema, and degenerative change in bone.

The diseases due to parasites which can be treated or improved by the present invention include, but are not restricted to, amebiasis, babesiosis, coccidiosis, cryptosporidiosis, binuclear-amebiasis, external parasite infections, Giardia intestinalis, trombiculiasis, Leishmaniosis, schistosomiasis, Theileriosis, toxoplasmosis. Trypanosomosis, and trichomoniasis as well as injection with poridiosis (for example, Plasmodium virax, Plasmodium faliparium, Plasmodium malariae and Plasmodium ovale), mange, Scrub typhus, eye infections, intestine infections (for example, dysentery, and diphtheria), liver diseases, lung disease, opportunistic infection (for example, AIDS relation), and malaria.

The immune facilitation which can be treated or improved by the present invention include, but are not restricted to, allergic dermatitis, and psoriasis.

The immune deficiency, which can be treated or improved by the present invention include, but are not restricted to, pyoderma, oral cavity candidiasis, and virus infections.

The drug poisoning, which can be treated or improved by the present invention include, but are not restricted to, alcoholism, nicotinism, and heroinism.

The term “lifestyle related diseases” inteded herein means any of diseases which are gragually progressing during the course of repeatedly continuing everyday life and not preferred habit, and show symptom thereof at the time of arriving at a given age, and examples include diabetes mellitus, hypertension, hyperlipidemia, gout (hyperuricemia), obesity, arteriosclerosis, cardiac infarction, pancreatitis, respiratory diseases, stomach/duodenal ulcer, liver function disorders, osteoporosis, cancers, and periodontal disease. In the present invention, as the treatment of lifestyle related diseases, the therapy is classified to be a therapy heavily considering the factor rather than the affected portion. In the method according to the present invention, focussing on the fact that the redox electric potential is decreased in any of lifestyle related diseases, it has been proven that the potential is increased whereby treating the diseases. Consequently, the aiming of the redox electric potential should be closely related to the lifestyle related diseases.

According to the present invention, all of the problems associated with the conventional pharmacotherapy. Since the thermotherapy is optimized in the present invention, the curing of dieases such as immune deficiency, which cannot conventionally be cured. This is an outstanding advantage of the present invention over the conventional technique.

In one embodiment of the present invention, the present invention may be effectively applied to treatments of central nerve system dieases (for example, cerebral apoplexy, after effect of cerebral apoplexy, late-onset neurone necrosis, Alzheimer's disease, dementia, feeding disorder, parkinsonism, multiple sclerosis, and Creutzfeldt-Jacob disease), inflammatory diseases (for example, allergy, asthma, and rheumatism), circulatory organ system dieases (for example, ischemic disorder, reperfusion disorder, hypertension, cardiomegaly, angina pectoris, and arteriosclerosis), cancer (for example, non-parvocellular lung cancer, ovarian cancer, prostate gland cancer, stomach cancer, bladder cancer, breast cancer, uterine cervix cancer, colon cancer, and rectal cancer), metabolic diseases (for example, diabetes mellitus, complication of diabetes mellitus, obesity, arteriosclerosis, gout, cataract, hepatitis, amyloidosis, and Wilson's disease), immunological diseases (for example, autoimmunity), alimentary system diseases (for example, stress ulcer, acute pancreatitis, inflammatory bowel disease, ulcerative colitis, gastric ulcer, duodenal ulcer, gastritis, and regurgitant esophagitis, autoimmunity (for example, chronic rheumatoid arthritis, multiple sclerosis, and systemic lupus erythematosus), degenerative disease (amyloidosis, hemosiderosis, and Willson's disease), ischemic central nerve system dieases (for example, cerebral apoplexy, aftereffect of cerebral apoplexy, and late-onset neurone necrosis), ischemia reperfusion disorder, cystic fibrosis, malignant tumor, infections (multiple organ failure due to septicemia, and acute respiration distress syndrome), hepatic insufficiency, renal failure, drug poisoning, heavy metal poisoning, radiation disorder, ultraviolet disorder (disorders of skin, lens of eyes or retina through UV ray), other living body damages (disorder of skin or texture due to heat or acid), virus derived diseases (for example, hepatitis B, hepatitis C, hepatitis D, hepatitis E, and acquired immune dificiency, adult leukemia, or prevention, improvement therapy of aging.

It has been actually confirmed herein to cure hepatitis B, hepatitis C, acquired immune dificiency (AIDS), diabetes mellitus, complication of diabetes mellitus, benign prostatic hyperplasia, gout, hepatitis, autoimmune disease, malignant lymphoma, pancreas cancer, uterine cervix cancer, oral cavity fundus cancer, renal cancer, hypertension, ulcerative colitis, rheumatoid arthritis, chronic granuloma, inflammatory bowel disease, neutropenic, neutrophilia, and the like, and it has been under confirmation concerning the therapeutic effect against other diseases. Substantially, cancers, virus-infected diseases, metabolic dieases, circulatory organ system dieases, alimentary system, inflammatory diseases, central nerve system disease, immunological diseases, infections, and lifestyle related diseases are cured.

The term “in vivo” means within the living body. In a specific context, “in vivo” means a position where the aiming texture or organ should be positioned.

The term “subjective” is a living body applied to the therapy and is also referred to “patient”. The patient or subjective is preferably “human”.

In another embodiment, the present invention is intended to jointly use agents (for example, an anti-cancer agent). Such agents may be any pharmaceutical agents known in the art. Such agent may be known pharmaceutical agents (for example, an anti-cancer agent, an antibiotic). Such agent may, of course, be used in a mixture of two or more agents. Preferably, it can be administrated at the same time as or different time from the thermotherapy. Examples thereof include those which are listed in the latest Pharmacopeia of Japan, the latest Pharmacopoeia of USA, and the latest Pharmacopeia of other countries, and specific examples include, but are not restricted to:

Drugs for central nervous system (for example, general anesthetics, sedative hypnotics, antianxiety drugs, antiepileptic drug, antipyretic analgesics, antiphlogistics, stimulation drugs, psychostimulants, anti-parkinsonism, major tranquilizers, total cold remedies, and others);

Drugs for peripheral nerve (for example, local anesthetics, skeletal muscle relaxants, drugs for autonomic nerve, antispastics, and others);

Drugs for sense organ system (for example, opthalmologic drugs, otolaryngologic drugs, Drugs to prevent motion sickness, and others);

Drugs for circulatory organ system (for example, cardiotonics, drugs for arrhythmia, diuretics, hypotensive drugs, vasoconstrictors, vasodilators, drugs for hyperlipidemia, and others);

Drugs for respiratory organ system (respiration accelerating agents, expectorants, antiitussive agents, bronchodilatation agents, gargles and others)

Drugs for alimentary system (for example, antidiarrheal drugs, medicine for intestinal disorders, drugs for peptic ulcer, stomachics, digestive drugs, antacids, cathartics, cholagogues and others);

Hormone drugs (for example, pituitary gland hormone drugs, saliva hormone drugs, male hormone drugs, estrogen drugs, progestogen hormone drugs, mixed hormone drugs, and others)

Drugs for urinary organ, genital organ, and for anus (for example, drugs for urinary organ, drugs for genital organ, uterine contraction drugs, drugs for anal fistula, and others);

External medicines (for example, external disinfectants, total ointments, drugs for pyogenic injury, analgesic, antipruritic, astringent, antiinflammatory agents, agents for parasitic dermatosis, skin softening agents, agents for hair and others)

Dental oral drugs;

Other Drugs for individual organs;

Vitamin compounds (vitamin A compounds, vitamin B compounds, vitamin C compounds, vitamin E compounds, vitamin K compounds, multiple vitamin compounds and others);

Analeptics (for example, calcium agents, inorganic preparations, saccharine preparations, protein and amino acid preparations, organ preparations, drugs for infants, and others);

Drugs for blood and other body fluids (for example, blood substitutions, hemostatic drugs, anti-blood coagulating drugs, and others)

Drugs for dialysis (for example, drugs for kidney dialysis, drugs for peritoneum dialysis, and others);

Other metabolic medicines (for example, drugs for organ diseases, antidotes, agents for habituation intoxication, drugs for gout, oxygen preparations, drugs for diabetes mellitus, metabolic drugs, which are not classified into other groups, and others);

Cell activating agents (for example, chlorophyll preparations, pigment preparations, and others);

Drugs for tumor (for example, alkylating agents, antimetabolites, antitumor antibiotics, antitumor plant component preparations, and others);

Drugs for allergy (for example, antihistamines, drugs for stimulation therapy, non-specific immunogen preparations, and other drugs for allergy, medicines based on herbal medicine and Chinese medicines herbal medicines, Chinese medicine preparations, and others);

Antibiotic preparations (for example, those acting upon gram positive bacteria, upon gram negative bacteria, upon both gram positive bacteria and gram negative bacteria, upon gram positive mycoplasma, upon gram positive and gram negative rickettsia, upon acid fast bacterium, and upon mold, and others);

Drugs for chemical therapy (for example, sulfur agents, antituberculous, synthetic antioxidant, antiviral agents, and others);

Biological preparations (for examples, vaccines, toxins, toxoids, anti-poisoning agents, anti-eptospirosis sera, blood preparations, preparations for biological study, other biological preparations, anti-protozoan agents, eliminators, and others);

Preparative Drugs (for example, activating agents, ointment base, dissolving agents, seasonings, flavoring agents, and others);

Diagnostic Drugs (for example, X ray contrast media, agents for functional inspection, and others);

Sanitary drugs (for example, antiseptic agents);

Medicines for extracorporeal diagnosis (for example, agents for determining bacteria, and others);

Non Classified Drugs whose main purpose is therapy; and

Narcotics (for example, opium alkaloid narcotics, coca alkaloid narcotics, synthetic narcotics, and others).

### Embodiment of Therapeutic Apparatus

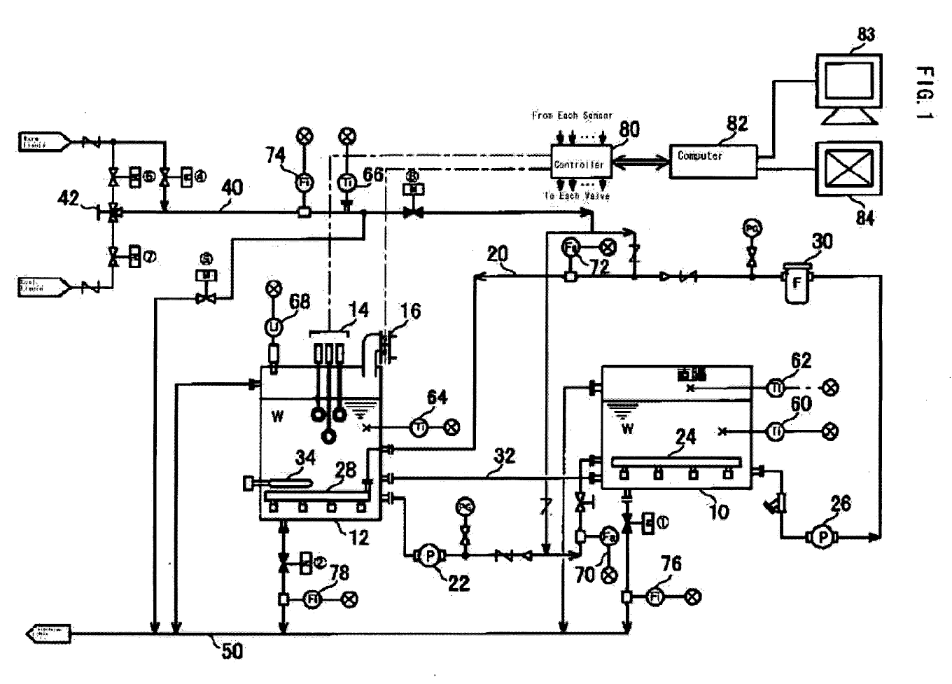

FIG. 1 shows a configuration of a thermo-therapeutic apparatus according to one embodiment of the present invention. In this embodiment, two tank type having a therapeutic tank 10 for immersing the whole body of the patient except for a head portion in a liquid W and a separately provided heating tank 12 for heating the liquid W provided is used as thermo-therapeutic means B. The therapeutic tank 10 has a thermo-sensor 60 for measuring the temperature of liquid W and a rectal temperature sensor 62 for measuring the body temperature of the patient (for example, rectal temperature) as temperature detecting means (C) provided thereon. The heating tank 12 has a heater 14 for heating the liquid W, a cooling fan 16 for cooling the liquid Q in a small extent, a thermo-sensor 64 and a water gauge 68. If required, means for measuring redox electric potential or a pH value (e.g., iSTAT) may be provided. Also, if required, means for measuring other parameters (for example, gas analysis, hemocyte fractionation biochemistry, disease marker, SpO₂, hart rate, and blood flow rate) may be provided. Here, it is preferable to maintain the SpO₂ value at 95 or more. If it becomes lower than 95, it is preferable to apply an oxygen mask or such not so as to be oxygen shortage. The hart rate is generally within the range of from approximately 120 to 130. If it exceeds 150, treatment utilizing an oxygen musk is preferably carried out or the therapy is preferably stopped.

The therapeutic tank 10 and the heating tank 12 are connected with a circulation line 20, and a pump 22 which forcibly circulates the liquid W from the therapeutic tank 10 to the heating tank 12, flow sensors 70, and 72, which measure a circulation amount within the circulation line. A plurality of stirring nozzles 24 each having multiple pores are provided on the therapeutic tank 10 in a dispersed manner so that the liquid W circulated by the pump 22 is dispersively sprayed within the tank 10. Similarly, a plurality of stirring nozzles 28 each having multiple pores are provided on the heating tank 12 so that the liquid W circulated by the pump 22 is dispersively sprayed within the tank 12.

As described above, through the circulation line 20, the liquid Q is forcibly circulated between the therapeutic tank 10 and the heating tank 10, and dispersively injected by the stirring nozzles 24 and 26, whereby the temperature deviation of the liquid A within the therapeutic tank 10 is small, making it possible to warm up the depth body temperature of the patient to a set therapeutic temperature with goof accuracy. A filter 30 is provided on the circulation line 20 to remove impurities existing in the liquid W, and a sterilizing UV lamp 34 is provided on the heating tank 12 which prevent growing of saprophyte which would generate within the liquid W through the therapy.

The therapeutic tank 10 and the heating tank 12 are connected via a communication pipe 32 so that even if the flow amount of the liquid W from the therapeutic tank 10 to the heating tank 12 and that from the heating tank 12 to the therapeutic tank 10 are unbalanced, the water level of the therapeutic tank 10 can be kept at a constant.

A water supply line 40 for supplying the liquid W is connected to the circulation line 20, and is used for supplying first warm liquid to the therapeutic tank 10 and the heating tank 12 and for cooling the liquid W by means of supplying a cold liquid at the time of therapy. The temperature of the warm liquid to be supplied is considered to be approximately 40° C. and, the temperature of the cold liquid is considered to be approximately from 5 to 20° C. The first water supply is conducted by directly supplying the warm liquid by means of electric valves (4) and (8), while the cooling of the liquid W at the time of therapy is conducted by mixing the warm liquid with the cold liquid by a thermo control valve by means of electric valves (6) and (7) to be an appropriate temperature, and then supplying the mixed liquid having an appropriate temperature via an electric valve (8).

The temperature of supply water is measured by the thermo sensor 66, and the amount thereof is measured by the flow sensor 74.

The therapeutic tank 10 and the heating tank 12 have a discharge line 50 which discharges the liquid W from the water supply line 20, the liquid W is discharged from the therapeutic tank 10 via an electric valve (1), from the heating tank 12 via an electric valve (2), and from the water supply line via an electric valve (5), respectively.

The water discharge amount from the therapeutic tank 10 is measured by a flow sensor 76, and that from the heating tank 12 is measured by a flow sensor 78.

The liquid W used is a aqueous saline solution having a saline concentration of from 0.85% to 0.95% near the human body fluid in order to suppress disadvantages such as puckering the skin of the patient due to long term immersion. For this reason, special tanks may be provided on the supply lines of the warm liquid and cold liquid at which the concentration and the temperature are controlled to supply the liquid W to the water supply line 40. Also, physiological saline or physiological salt may be used.

The control device (D) has a controller 80, which incorporates signals from the sensors to actuate the heater 14 and the cooling fan 16, as well as respective electric valves, and a computer 82 which sends control commands to the controller 80. The controller 80 has a function that the heater 14 and the cooling fan 16 are actuated based on the signals from the thermo sensors 60 and 64 to control the liquid W to be set temperature specified by the computer 82. Also, the controller 80 has a function that the electric valves (1), (2), (4), (6), (7), and (8) are actuated based on the signals from the water gauge 16, and the flow sensors 74, 76, and 78 to supply the warm liquid to the therapeutic tank 10 and the heating tank 12 at a prescribed water level and a function that the liquid W is substituted with the cooling water in a prescribed amount to cool down the liquid W to the set temperature specified by the computer 82.

The computer 82 having a display device 83 and an input device 84 displays information of various sensors received from the controller 80 to give the information to a doctor or such, and supply control command to the controller 80 based on the therapeutic conditions inputted by from the input device 84 to perform a serious of therapeutic treatments. As for various parameters including a redox electric potential or a pH value and/or other parameters, the therapeutic parameters (for example, warming conditions, situations, period etc.) may be suitably altered or modified by the measurement before, during the course of, and after the therapy.

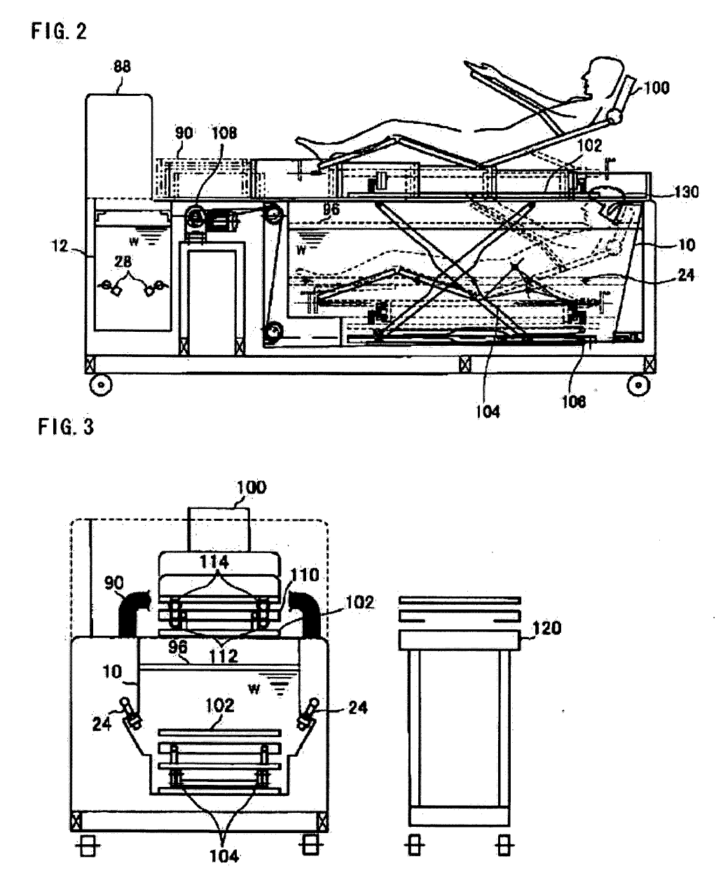

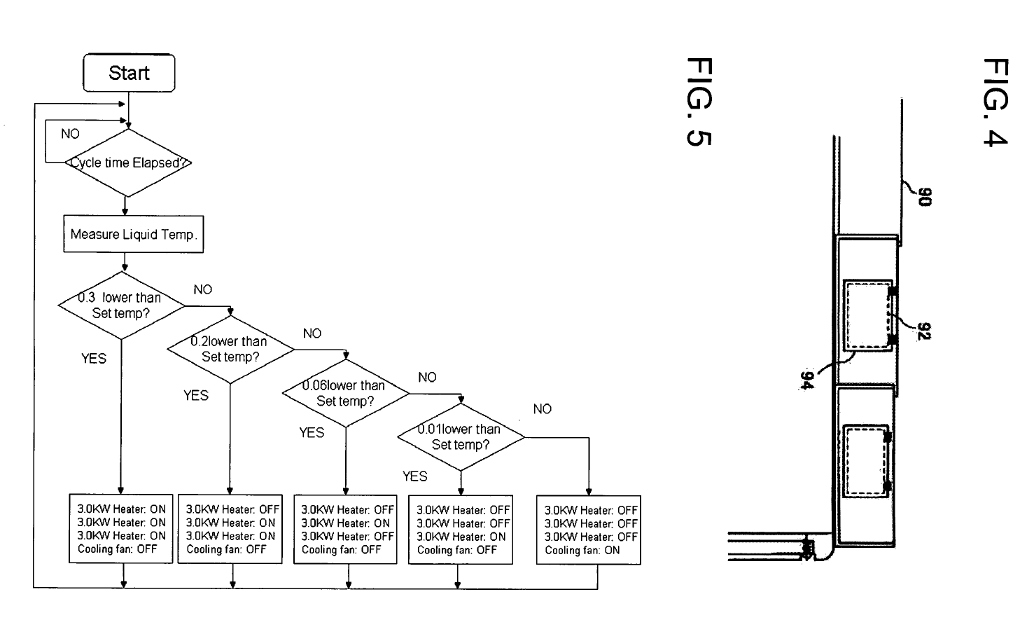

FIG. 2 is a front view illustrating a body mechanism of the thermo therapeutic apparatus according to one embodiment of the present invention and FIG. 3 is a side view of this body mechanism.

The therapeutic tank 10 has a bed 100 for placing the patient, a lifting mechanism which descends or ascends the bed 100 within the therapeutic tank 10 so as to immerse the patient in the liquid and escape the patient therefrom composed a lifting base 102, a lifting arm 104, a roller 106, and a motor 108 for lifting, and a moving mechanism, which horizontally moves the bed 100 between a transferring cart 120 and the therapeutic tank 10, composed of a slide rail 110, a lower wheel 112, and an upper wheel 114. The bed 100 has a mechanism for controlling a posture which can adjust the angle of waist, feet, and neck so as to have the most comfortable posture, because, the patient is immersed in the liquid over a long period of time.

In order to carry out drip infusion or such, the bed 100 has a stand for placing an arm.

The therapeutic tank 10 has an outer lid 90 which cover the whole of the therapeutic tank 10, and an inner lid 96, which covers the liquid surface of the liquid W. As shown in FIG. 4, the outer lid 90 is in a sliding type which can be opened and closed, and while the patient is immersed in the liquid W, the outer lid 90 covers the whole of the therapeutic tank 10 to suppress the diffusion of heat of the patient from a portion exposed from the liquid W, shortening the heating period of the depth body temperature and stabilizing the depth body temperature during the course therapy. The outer lid 90 is made of a transparent resin so as to observe the patient during the therapy, and has a window 92 so that a doctor or such can perform maneuver. The window 92 is covered with a heat retention flexible cover 94, thus, by performing maneuver while covering with the heat retention flexible cover 94, the heat diffusion can be reduced at the fullest extent.

The inner rid 96 is a floating type thermal insulating material and is set so as to cover the surface of the liquid W when the patient is immersed in the liquid W. This enhances the heat-retention property of the liquid W, shortening the heating period of the depth body temperature and stabilizing the depth body temperature during the course therapy.

In this figure, numerical 88 is a control board having a control device accommodated therein and accommodates the controller 80, the commuter 82, the display device 83, and the input device 84. Also, the control board 88 has driving board for driving the heater, the pump and the like, an electric circuit board which conducts signal processing of various sensors, an indicator for various controllers, and an alert lamp etc.

After the patient has been immersed in the liquid W, a head cooler 130 is set on the head portion of the patient. This is for cooling the head portion in order to protect the patient in the case where the temperature at the head portion becomes too high during the course of the therapy. In this embodiment, the head cooler is set to be actuated when the temperature at the head portion is higher than 39° C. and is increased to a given temperature at an interval of 0.1° C.

The head cooler 130 covers the head portion of the patient by means of a helmet form material into which cooling water is flowing whereby a required cooling effect can be obtained. The temperature of the head portion may be measured by directly fitting a depth temperature sensor to the head portion or by fitting depth temperature sensors to the carotid artery portion and jugular vein of the patient to measure the temperature of the blood flowing in the head portion and the temperature of the blood flowing out of the head portion and use the average of them. Also, the head cooler 130 may control the temperature or the flow amount of the cooling water so that the temperature of the head portion measured as described above becomes a constant temperature. This makes it possible to conduct the thermotherapy of the whole body without soiling the therapeutic effect against cancer cells or virus metastasis of the head portion.

When the patient is immersed in the liquid W, a partial heating device (not shown) which further warms a specific affected may be fit. This makes it possible to effectively kill a cancer or microorganisms at a specific affected area, while non-invasively treating cancer metastasizing to the whole body or difficult to cure infective disease by warming up the depth temperature of the specific affected area to the therapeutic temperature plus a given temperature increased within a non-invasive range at an interval of 0.1° C. wile while keeping the depth temperature at the therapeutic temperature. Furthermore, by warming up the specific affected area to a temperature higher than the temperature of the whole body, it is possible to shorten the therapeutic period of the whole body, and to conduct the therapy at a lower temperature of whole body, this making it possible to realize the whole body thermotherapy with lower load for the patient.

The partial heating device is realized by fixing a pad composed of thermal insulating material onto the affected portion, and allowing the warm liquid to flow to the side of the body surface at the central portion. This is applied to the fact that by shielding heat current by the thermal insulating material the depth body temperature is closely near the temperature of the body surface temperature, and a thermo sensor is provided at the center of the pad, which controls the temperature of the warm water, whereby the specific affected area can be warmed up to a required therapeutic temperature.

### (Means for Exhibiting Effect of Thermotherapy at the Fullest Extent)

The therapeutic temperature as used herein is determined by the redox electric potential or pH value of the living body as described above and, it can also be determined by considering a) an amount of expressing hsp 72 in the blood of the patient, b) change in the blood of the patient, c) the hart rate of the patient, d) the blood flow amount of the patient, e) pH of the blood of the patient, f) the expression amount of HLA of the patient, g) the number of the lymphocyte of the patient and the like. The therapeutic temperature is preferably set so as to be 4-5° C., more preferably 4.5° C., higher than the rectal temperature. Generally, it is 39° C. plus minus 1.0° C., depending on the individuals and the health situations of the individuals. The body temperature of the patient can be determined, for example, at the armpit, hypoglottis, rectum, depth subcutaneous portion, intraarterial portion, drum membrane and esophagus. The body temperature of the patient is preferably measured at the hypoglottis or rectum, and most preferably, at the rectum.

When the patient is gradually heated, the following changes occur before and after therapy.

The amount of expressing hsp 72 is gradually increased up to the body temperature to be the therapeutic temperature, and is decreased when the body temperature exceeds the therapeutic temperature. The blood pressure is gradually increased up to the body temperature to be the therapeutic temperature, and is decreased when the body temperature exceeds the therapeutic temperature. The hart rate is gradually increased up to the body temperature to be the therapeutic temperature, and is decreased when the body temperature exceeds the therapeutic temperature.

The blood flow amount is gradually increased up to the body temperature to be the therapeutic temperature, and is decreased when the body temperature exceeds the therapeutic temperature.

The pH value of the blood is increased when the body temperature exceeds the therapeutic temperature in the case where the body temperature is decreased to the therapeutic temperature; while the pH value of the blood is decreased when the body temperature exceeds the therapeutic temperature in the case where the body temperature is increased to the therapeutic temperature. The pH value is corresponding to the redox electric potential at 1:1, making it clear to be an important factor for determining the therapeutic parameter.

The amount of expressing HLA is gradually increased up to the body temperature to be the therapeutic temperature, and then reaching a plateau.

Unexpectedly, it has been understood that the temperature in which the parameter is changed in vitro is substantially harmonized with the temperature in which the parameter is changed in vivo. Consequently, it is not required on purpose to observe the change in parameter in vivo. Specification of the therapeutic temperature of the patient is carried out by using as an index hsp 72 or HLA, size of the cell, cell density produced by changing the temperature of the peripheral blood leukocyte in vitro.

As used herein, the term “hsp” indicates a heat shock protein. Hsp is a general term of a protein group in which synthesis is derived at the time which a cell or individual undergoes a temperature change higher than the usual temperature. Examples of typical hsp include, but are not restricted to, hsp 72, hsp 70, hsp 90, hsp 10, hsp 27, hsp 40, hsp 47, hsp 60, hsp 73, hsp 110, ubiquitin, and hsp 26.

As used herein, “HLA” indicates human leukocyte antigen. HLA antigen is roughly classified into Class I antigen and Class II antigen. Examples of Class I antigens include HLA-A, HLA-B, HLA-C, HLA-E, HLA-F, and HLA-G. Almost all of Class I antigens are expressed on nucleated cells. The Class I antigen forms together with a peptide produced within a cell, and presents the complex in an antigen specific T cell receptor of CD8 positive cell lesional T cell. Examples of Class II antigens, which can be listed, are HLA-DR, HLA-DQ, and HLA-DF. The Class II antigen is only expressed on a cell such as a macrophage, B cell, activated T cell, dendritic cell, and thymic epithelial cell, and presents exogenous antigen originated peptide to a CD4 positive helper T cell. In addition to antigen presentation, Class II antigen has been known to precipitate in the selection of positive and negative T cell in thymus.

### (Assay for Detecting and Quantitatively Determining hsp 72 and HLA in Peripheral Leukocyte)

It is possible to detect and quantitatively determine the expression of hsp 72 in peripheral leukocyte by using the conventional Western blotting, ELISA, a real time RT-PCR method, Northern blotting and the like. The number of peripheral leukocyte required can easily be decided by the artisan, and is preferably from 8×10⁵ to 10×10⁵ cells. It is possible to detect and quantitatively determine the expression of HLA in peripheral leukocyte cell membrane by utilizing the conventional FACS analysis and fluorescence microscope. The number of peripheral leukocyte required can easily be decided by the artisan, and is preferably from 5×10 to 10×10⁵ cells.

The means (A) for specifying the therapeutic temperature of the patient may be directly connected to the control device (D) to input a signal of the therapeutic temperature of the patient at real time. Alternatively, the control device may be separated from the means (A) or the signal of the therapeutic temperature may be indirectly inputted to the control device.

The temperature increasing program for specifying the therapeutic temperature of the patient is prepared paying the following attention.

If the difference between the chamber (temperature of the warm water) and the body temperature is large, the rate of increasing the temperature should be set to be fast, and if the difference between the chamber (temperature of the warm water) and the body temperature is small, the rate of increasing the temperature should be set to be slow.

At a point where the increasing of the rectal temperature is drastically fast (a point where the invasion temperature from the surface of the body is in agreement with the temperature increasing due to blood circulation), a temperature control is switched to be low specific heat.

A temperature just lower than the aiming temperature is maintained (for example, if the aiming rectal temperature is 42.0° C., the temperature of warm water is 41.8° C.), because of utilization of heat resistance (residual heat). Although the temperature of warm water is 41.8° C., the rectal temperature becomes 42.0° C.

The retention time is decided considering the balance between (1) heat radiation rate due to the temperature difference between the body surface temperature and the temperature of the warm water and (2) increasing rate of the rectal temperature. When the rate (2) is higher than the rate (1), the temperature of the warm water is set to be low. With the elapse of time, the balance between the rate (1) and the rate (2) is changed from equilibrium to reverse. In this case, the warm water may be heated to suppress the rate (1) or the rate (2) may be set to be high not so as to be reversed.

As described above, based on the difference between the chamber (temperature of warm water) and the body temperature, the balance between rate (1) and the rate (2) is regulated by the calculation to control the temperature.

The series of the operation of the body mechanism from starting the therapy to the completing the therapy is as follows:

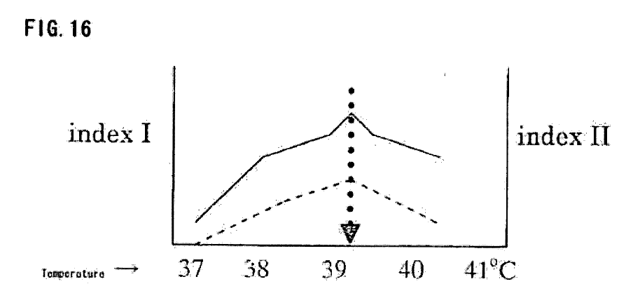

First, the therapeutic temperature of the patient is specified in order to exhibit the therapeutic effect imparted to the patient at the fullest extent. It is preferable that the means (A) for specifying the therapeutic temperature of the patient specifies the therapeutic temperature of the patient by using as an index hsp 72, hsp 70, 90, 10, 27, 40, 47, 60, 73, 110, and 26 and HLA produced by changing the temperature of the peripheral leukocyte collected from the patient in vitro. In this case, specifically, the blood is collected from the patient (2 to 3 ml), and a point drastically changing the production amount of hsp 72 by varying the temperature as shown in FIG. 16 is set at the therapeutic temperature of the patient (referred to as set point). The best heating conditions of the individual patient is determined (e.g., preparation of in vivo therapeutic program), and based on the simulation of the heating effect, the control device is controlled.

### (Evaluation of Effect of Thermotherapy)

The effect of the thermotherapy against various diseases according to the thermotherapy of the present invention can be evaluated by observation through necked eyes or endoscope, an image of CT-MRI, X ray etc., and immunohistochemical analysis. In some cases, the monitoring of an expression amount of known tumor marker may also totally used.

### (Thermotherapy of Patient)

At the time of starting therapy, if occasion may demand, anesthesia is applied to the patient on the bed 100 for placing the patient. After the situation where the body temperature may be increased, the outer rid 90 is opened, and the bed 100 placing the patient thereon is transferred to the lifting base 102 by the slide rail 110. Subsequently, sensors for monitoring the living body such as rectal temperature sensor 62 are set on the patient, and if necessary a respirator and drip infusion device etc., and partial heating device are fitted to the patient, the bed 100 is descending by means of the lifting motor 104 to immerse the patient into the liquid W. Finally, the head cooler 130 is set on the patient, the inner rid 96 is set, and the outer rid 90 is closed.

At the time of completing the therapy, first the outer rid 90 is opened, and the inner rid 96 is removed.

Subsequently, the lifting arm 104 is extended by the lifting motor 100 to ascend the bed 100 to escape the patient from the liquid W. Finally, the base 100 on which the patient is placed is transferred to the transferring cart 120 by means of the slide rail 110.

Subsequently, the temperature control by the control 80 will be described.

In this embodiment, a plurality of line heaters each having a different capacity are provided on the heating tank 102 as the heater 14, and a precise temperature control of the liquid W is carried out by these line heaters and the cooling fan 16.

FIG. 5 shows an example of the temperature control algorism of the thermotherapeutic apparatus according to one embodiment of the present invention. This is one which has been used for a thermotherapeutic apparatus for clinical test of a small animal. In this case, the capacity of bathtub is 200 liters, the capacity of the heating tank is 216 liters, and three types of heaters having 3.0 KW, 1.0 KW, and 0.5 KW capacities respectively, and a cooling fan are used.

As shown in this figure, waiting for an elapse of a constant cycle time, the liquid temperature is measured, and if the liquid temperature is at least 0.3° C. lower than the set temperature, all heaters are turned ON, and the cooling heater is turned OFF.

If the liquid temperature is at least 0.2° C. lower than the set temperature, 3.0 W heater is turned OFF, and 1.0 KW heater and 0.5 KW heater are turned ON, and the cooling heater is turned OFF. If the liquid temperature is at least 0.05° C. lower than the set temperature, 3.0 W heater and 1.0 KW heater are turned OFF, and 0.5 KW heater are turned ON, and the cooling heater is turned OFF. In other case, all heaters are turned OFF and the cooling fan is turned ON.

As described above, by changing the capacity of heaters to be turned on electricity, the liquid temperature can be heated 5° C. for about 30 minutes depending on the different between the present temperature and the set temperature (aiming temperature), and it has been conformed that the temperature can be maintained at the accuracy within 0.5° C. relative to the set temperature.

In the case of human thermotherapeutic apparatus, the capacity of the bathtub is about 800 liters, and that of the heating tank is about 300 liters. In this case, the capacities of these heaters having three times those of the apparatus for a small animal can be considered to have an equivalent temperature control.

In this embodiment, while a plurality of heaters having different capacities are used and depending on the temperature difference, the heater or heaters to be turned on are switched, the present invention is not restricted thereto. For example, a single heater is used, for example, plus electricity is turned on, and varying the duty thereof to substantially switch the capacity. In this case, a similar effect can be exhibited.

As shown in FIG. 2 and FIG. 3, total 12 stirring nozzles for dispersing the circulation flow within the therapeutic tank 10 are provided on such a manner that each six nozzles are placed on both side of substantially central portions of liquid surface, and they spray a circulation flow downwardly, which is reflected at the bottom to cause the convention. This makes it possible to reduce the temperature deviation as low as possible and since circulation flow is not directly in contact with the patient, the patient does not feel uncomfortable. Similar to the temperature control, the apparatus produced for clinical testing an small animal is used to measure the temperature deviation within the therapeutic tank. As a result, when the circulation flow amount is 40 liter/minute or more, it has been confirmed that the maximum temperature deviation at the temperature of 42 to 44° C. is not more than 0.05° C.

When the circulation flow amount is 50 liter/minute or more, ripples occur on the surface of the liquid and, thus, in order not to feel the patient incongruous, the flow amount is set to be not more than this level. Since the capacity of the therapeutic tank is 200 liters, the optimal range of the circulation flow amount per minute may be considered to be from 20 to 25% of the capacity of the therapeutic tank.

By setting the circulation flow amount per minute to be from 20 to 25% of the capacity of the therapeutic tank as described above, the temperature deviation can be reduced to be 0.05° C. without feeling the patient incongruous. Consequently, since the liquid temperature within the therapeutic tank can be kept at an accuracy of 0.1° C. together with the accuracy of the temperature control, thermotherapy where the depth body temperature of the patient can be uniformly heated at the accuracy of 0.1° C. can be realized.

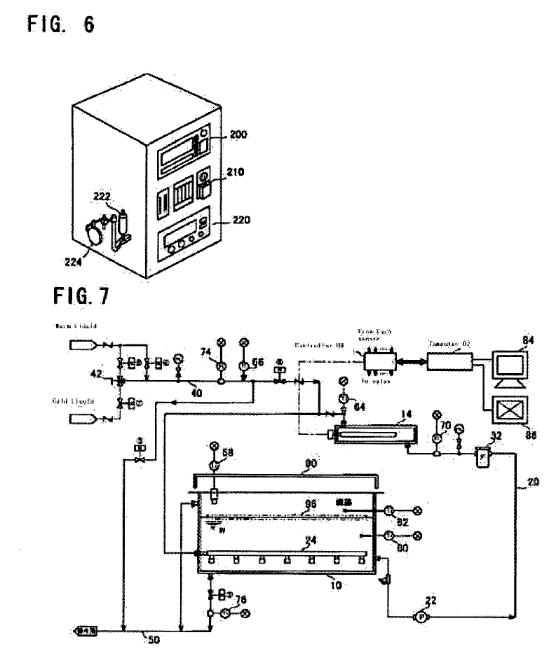

FIG. 6 shows an outlook of the device for controlling the living body in the thermotherapeutic apparatus according to one embodiment of the present invention.

Since the body temperature is increased in the whole body thermotherapy, as occasion may demand, anesthesia is applied to the patient and a respirator for securing the respiration of the patient is fitted. For this reason, the device for controlling the living body have a bio-monitor 200 which monitors a hart rate, a respiratory rate, a blood pressure and the like, an anesthesia device 201 for applying, anesthesia to the patient, and a respirator 202 for securing the respiration of the patient during the course of anesthesia.

The information from the bio-monitor is incorporated into the computer 82, displayed on the display device 83, and may be used for modification of the therapeutic conditions based on the information. For example, if the hart rate exceeds a prescribed value, the rate for increasing the temperature described later on or may be decreased or the increasing of the temperature may be stopped depending on the situations. At emergency, the body temperature may be automatically decreased to a constant body temperature.

In the above embodiment, while line heaters are used as the means for heating the liquid, the present invention is not restricted thereto. For example, a rubber heater or such may be used and a gas boiler may also be used. Alternatively, a method in which a heat exchanger is provided on a heating tank 12 or the circulation line 20 to conduct heat exchange through the warm liquid, or a method for directly substituting the liquid with the warm liquid or any other heating means may be used. They can exhibit similar effects.

While the injecting the cooling liquid in to circulation line as the cooling means for cooling the liquid in the above embodiment, the present invention is not restricted thereto. It is possible to directly inject the cooling liquid in the heating tank 20 or the therapeutic tank 10 while thoroughly circulating the liquid W. In addition, a method in which a heat exchanger is provided on the heating tank 20 or the circulation line 20 to exchange the heat with the cooling liquid, a method for using a refrigerator with a compressed cold medium, a method for utilizing an electric cooling device with a Peltier element, or any other cooling means may be applied. They can exhibit similar effects.

While the depth body temperature of the patient is measured by the rectal temperature sensor 62 in the above embodiment, the present invention is not restricted thereto. A drum membrane thermo sensor may be used, or a bladder temperature may be used by placing an etrusor container. They may be jointly used. They can exhibit similar effects.

While two tank type having a heating tank 12 for heating the liquid provided separately from the thermotherapeutic tank 10 is described, the present invention is not restricted thereto. For example, the heating tank 12 is not provided to be a one-tank type in which a heater for heating the liquid may be provided on the circulation line.

FIG. 7 shows the configuration of a one-tank type thermo therapeutic system according to another embodiment of the present invention. Amongst the constituents, those having the same number as those of the above embodiments are equivalent to those of the above embodiment. Even if the one-tank type thermo therapeutic system as depicted on this figure, a plurality of stirring nozzles 24 are provided on the therapeutic tank 10, a prescribed flow amount is circulated through the circulation line 20, and the heat control is conducted as described above, whereby the liquid temperature within the therapeutic tank 10 has been confirmed to uniformly maintained at an accuracy of 0.1° C.

It is needless to say that posture control mechanism, the lifting mechanism and the transferring mechanism described in the above embodiments are described as one embodiment, they may be any mechanisms as long as the patient may transferred from the therapeutic tank and transferring cart. In this case, a similar effect will be obtained.

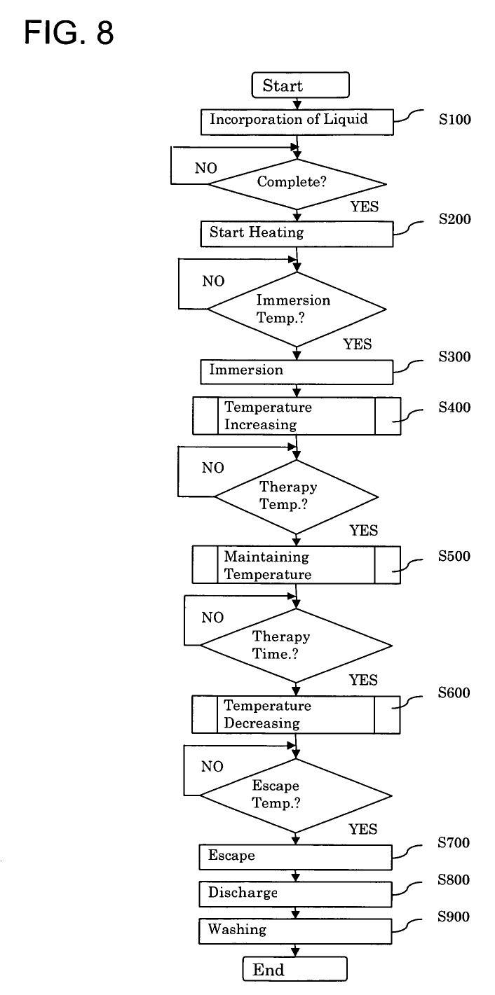

Subsequently, functions for controlling therapy of the thermotherapeutic apparatus according to the present invention will now be described. FIG. 8 shows a therapeutic control flow of the thermotherapeutic apparatus according to the present invention by the control device.

First, a prescribed amount of the liquid W is incorporated in the therapeutic tank 10 and the heating tank 12 (S100). After the completion, the liquid W is heated to a immersing temperature (for example, 40° C.) (S200). When the liquid temperature is arriving at the immersing temperature, the patient is immersed (S300). After the completion of the immersion, temperature increasing which increases the depth temperature of the patient is conducted (S400). When the depth body temperature f the patient is arriving at the set therapeutic temperature, the temperature maintaining treatment which maintains the depth body temperature of the patient until arriving at a prescribed therapeutic calorie is carried out (S500). When the set therapeutic period has been gone, the therapy is completed, and a temperature decreasing treatment in which the depth body temperature of the patient is increased is carried out (S600). When the depth body temperature of the patient is decreased to not more than the escaping temperature, the patient is escaped (S700). Finally, the liquid W is discharged (S800), and the therapeutic tank 10 and other equipments are washed (S90) to finish a series of the therapeutic control.

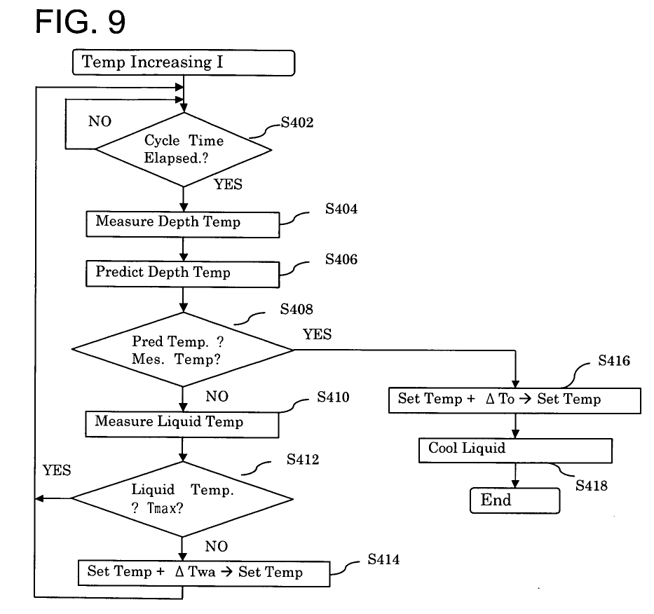

FIG. 9 shows a processing flow of the temperature increasing treatment (S400) according to the first example. This temperature increasing treatment is to increase the liquid temperature at a preset temperature increasing rate ΔTwa. First, a time elapse for a prescribed cycle time is waiting (S402). The cycle time is determined by a response time of the depth temperature sensor or such. In this treatment, since the cycle time is a unit period. The temperature increasing rate ΔTwa is set as a temperature of increasing the liquid per one cycle time.

When the cycle time is elapsed, the depth body temperature is measured (S404), the depth body temperature after elapse of a prescribed period is predicted (S406). The prediction of the depth body temperature may be approximated from the difference with the last time measurement or highly approximated from three or more measured depth body temperatures.

The prediction time is decided based on the response time of the body temperature of the patient to the liquid temperature or such. The flowing predictions of the depth body temperature are all conducted in a similar manner. Next, the calculated prediction temperature is comparison with the therapeutic temperature (S408). If it does not yet reach, the liquid temperature is measured (S410), ΔTwa is added to the set temperature within an extent where the measured liquid temperature does not exceed the maximum liquid temperature Tmax (S414). Here, the maximum liquid temperature Tmax is set so as not to too exceed the liquid temperature, and usually a temperature of 45° C. is selected. It may be possible to restrict the difference between the depth temperature of the patient and the liquid temperature to be a constant temperature. This makes it possible to decrease the pain due to the temperature generated due to the difference between the depth body temperature and the liquid temperature, increasing the temperature in much more safety manner.

The treatments described above are repeated from S402, and when the predicted temperature in S408 is arriving t the therapeutic temperature, a prescribed offset temperature To is added to the therapeutic temperature to be a set temperature (S416), the liquid W is substituted with a prescribed amount of the cooling water for cooling the liquid temperature to be the set temperature to carry out cooling of the liquid (S418), after which the temperature increasing treatment is completed. Here the offset temperature To is a temperature difference between the liquid temperature required for maintaining the depth body temperature at the therapeutic temperature and the depth body temperature, and is decided considering this thermotherapeutic apparatus and metabolism of the patient.

The liquid cooling by substituting the liquid W with the cooling liquid is carried out by calculating a required liquid substitution amount from the total liquid amount of the therapeutic tank 10, the heating tank 12, and the circulation line 20, the present liquid temperature and the temperature of the cooling liquid, discharging a prescribed amount of the liquid W by opening the discharge valves (1), and (2), while monitoring the flow sensors 76, and 78, and supplying the same amount of the cooling liquid by opening the water supply valve (8), while monitoring the flow sensor 74. Here, the temperature of the cooling liquid in which the warm liquid is mixed with the cooling liquid at the temperature control valve 42 has a marginal error at the time of starting the water supply and, thus, after the water is discharged by opening the discharge value (5) for a prescribed period, the temperature is measured by the thermo sensor 66. The following liquid cooling is carried out in a similar treatment.

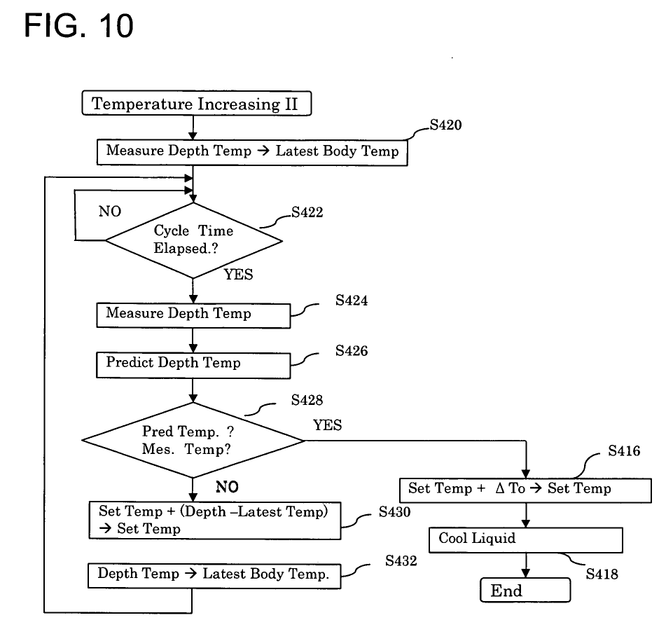

FIG. 10 shows a processing flow of the temperature increasing treatment (S400) according to the second example. This temperature increasing treatment is conducted while keeping the temperature difference between the depth body temperature of the patient and the liquid temperature at a constant. First, as an initial vale for calculating the temperature increasing rate of the depth body temperature of the patient, the depth body temperature is measured, which is used as the latest temperature (S420).

As in the first example, waiting for the elapse of cycle time (S422), the depth body temperature is measured (S424), and the depth body temperature is predicted (S426). The predicted temperature is compared with the therapeutic temperature (S428), if it is not yet arriving at the therapeutic temperature, the difference between the measured depth body temperature and the latest temperature is added to the set temperature (S430), the measured depth body temperature is set to the latest body temperature (S432), and the treatments is repeated from S422. In S428, if the predicted temperature is arriving at the therapeutic temperature, a prescribed offset To is added to the therapeutic temperature to be the set temperature (S432) as in the first example, the liquid is cooled to the set temperature (S436) to complete the temperature increasing treatment.

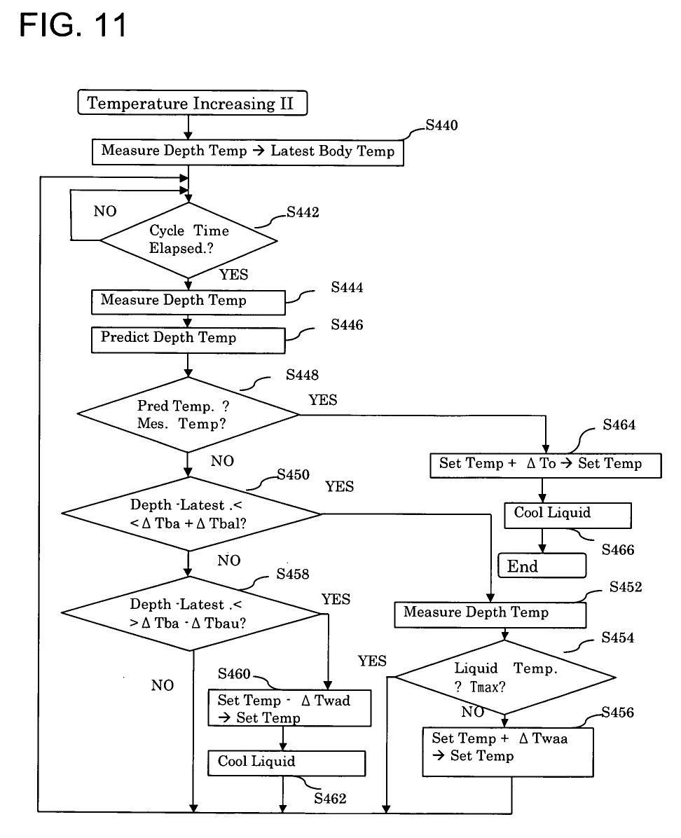

FIG. 11 shows a processing flow of the temperature increasing treatment (S400) according to the third example. This temperature increasing treatment is to increase the depth body temperature at a preset rate of increasing the temperature ΔTba. If the increasing of the depth body temperature is ΔTbal or more lower than ΔTba, the liquid temperature is increased ΔTwaa. If the increasing of the depth body temperature is ΔTbau or more higher than ΔTba, the liquid temperature is decreased ΔTwad. ΔTba sets the increasing temperature of the depth body temperature per a cycle time as in the first example. First, as an initial value for calculating the increasing of the depth body temperature, the depth body temperature is measured to be the latest body temperature (S440). As in the first example, waiting for the elapse of cycle time (S442), the depth body temperature is measured (S444), and the depth body temperature is predicted (S446). The predicted temperature is compared with the therapeutic temperature (S448). If the temperature is not yet arriving at the therapeutic temperature, the difference between the depth body temperature and the latest temperature is compared with ΔTba−Δtbau (S458). If the difference between the depth body temperature and the latest temperature is lower than the later, the liquid temperature is measured (S452), the set temperature is increased ΔTwaa within an extent that the liquid temperature does not exceed Tmax (S456). If the difference between the depth body temperature and the latest temperature is larger than or equal to the later, the difference between the depth body temperature and the latest temperature is further compared with ΔTba−Δtbau (S458). If the difference between the depth body temperature and the latest temperature is larger than the later, the set temperature is increased ΔTwad to cool the liquid to the set temperature (S462). In other case, no treatment is carried out. These treatments are repeated from S422, and when the predicted temperature is arriving at the therapeutic temperature in S448, a prescribed offset To is added to the therapeutic temperature to be the set temperature (S464) as in the first example, and the liquid is cooled to the set temperature (S466) to complete the temperature increasing treatment.

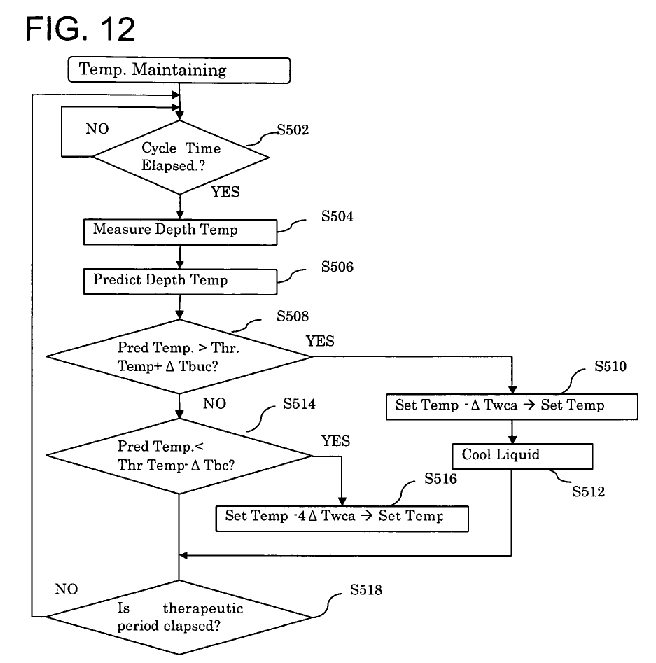

FIG. 12 shows the treatment flow of an example of the temperature maintaining treatment (S500). First, waiting for the elapse of the cycle time (S502), the depth body temperature is measured (S504), and then the depth body temperature is predicted (S506). The predicted temperature is compared with the therapeutic temperature+ΔTbcu (the upper limit of therapeutic temperature deviation) (S508). If the predicted temperature is higher than the later, the set temperature is decreased ΔTwd (small cooling temperature of the liquid at the time of therapy) (S510), the liquid is cooled to the set temperature (S512). If the predicted temperature is smaller than or equal to the later, the predicted temperature is further compared with the therapeutic temperature—Δtbcl (the lower limit of therapeutic temperature deviation) (S514). If the predicted temperature is lower than the later, the set temperature is increased ΔTwca (S516). Finally, whether or not the therapeutic period has been elapsed (S518), if the therapeutic period has not yet been elapsed, treatments are repeated from S502, and if it is elapsed, the temperature maintaining treatment is completed. In the above example, if the predicted temperature is larger in S508, the set temperature is increased ΔTwad and the liquid is cooled in S512, only the set temperature may be decreased if the control is made with a small temperature range. In this case, the liquid temperature is cooled due to a spontaneous cooling and cooling by the cooling fan, and, thus, similar effects can be exhibited.

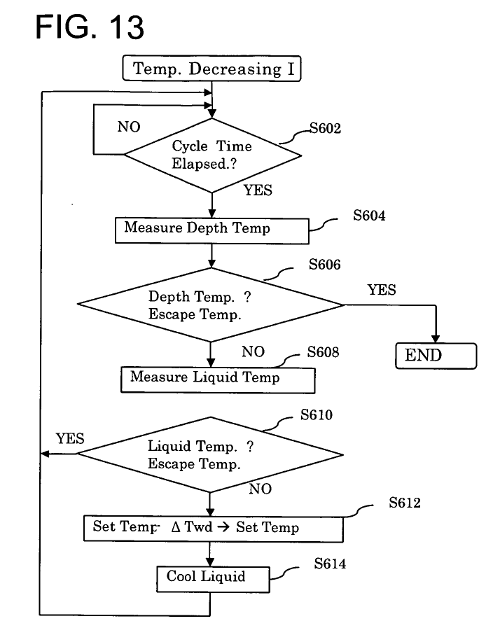

FIG. 13 shows the follow flow for temperature decreasing treatment (S600) according to the first example. This temperature decreasing treatment is to decrease the liquid temperature at a preset temperature decreasing rate ΔTwd. Similarly, ΔTw sets the temperature of decreasing the liquid per a cycle time. First, waiting for the elapse of a the cycle time (S602), the depth body temperature is measured (S604), and the measured depth body temperature is compared with the set escaping temperature (S606). If the measured depth body temperature is higher than the escaping temperature, the liquid temperature is measured (S608), and the set temperature is decreased ΔTwd within a range where the liquid temperature is not lower than Tmin (S612) to cool the liquid to the set temperature (S614). Here, Tmin is a value for the purpose that the liquid temperature is not too decreased, but it is also possible to control the difference between the depth body temperature and the liquid temperature at a constant. This makes it possible to decrease the pain due to the temperature generated due to the difference between the depth body temperature and the liquid temperature, decreasing the temperature in much more safety manner. These treatments are repeated from 602, and the treatment is completed when the depth body temperature becomes a temperature not more than the escaping temperature in S602.

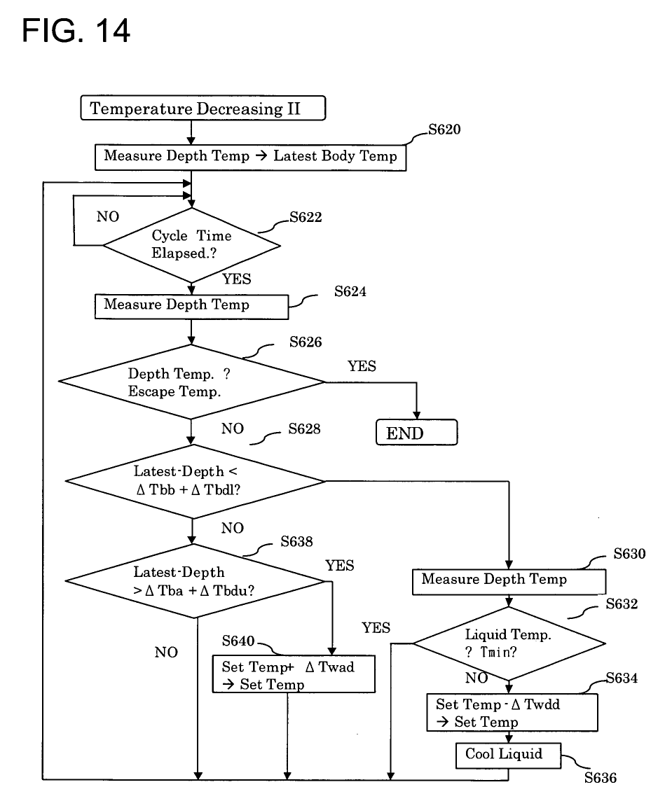

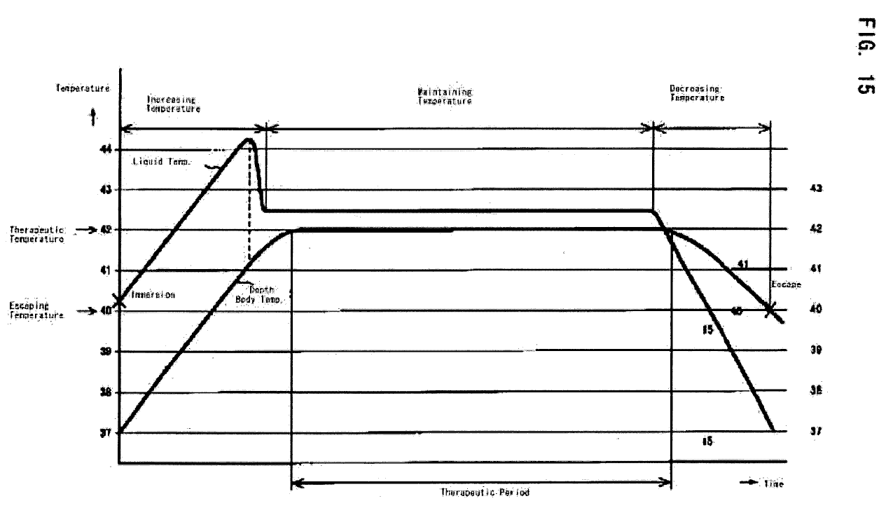

FIG. 14 shows the follow flow for temperature decreasing treatment (S600) according to the first example. This temperature decreasing treatment is to decrease the depth body temperature of the patient at a preset temperature decreasing rate ΔTb. If the decrease in the depth body temperature of the patient is ΔTbdl or more lower than a prescribed temperature decreasing rate, the liquid temperature is decreased ΔTwdd. If the decrease in the depth body temperature is A Tbdu or more higher than a prescribed temperature decreasing rate, the liquid temperature is increased ΔTwda. Similarly, ΔTbd sets a temperature ode decreasing the depth body temperature per a cycle time.

First, as an initial value for calculating the temperature increasing of the depth body temperature, the depth body temperature is measured to be the latest body temperature (S620). Waiting for the elapse of a cycle time (S622), the depth body temperature is measured (S624), and the measured depth body temperature is compared with the escaping temperature (S626). If the measured depth body temperature is higher than the escaping temperature, the difference between the latest body temperature and the measured depth body temperature is compared with ΔTbd−ΔTbdl (S628). If the difference is lower than the later, the liquid temperature is measured (S630), and the set temperature is decreased ΔTwdd within an extent that the liquid temperature is not lower than Tmin to cool the liquid to the set temperature (S636). If the difference is higher than the later, the set temperature is increased ΔTwda. In other case, no special treatment is carried out. These treatments are repeated from S622 and the treatment is completed when the depth body temperature becomes the escaping temperature in S626.

By carrying out the temperature increasing treatment (S400), the temperature maintaining treatment (S500), and the temperature decreasing treatment (S600) as described above, the relation between the depth body temperature and the liquid temperature is controlled as shown in FIG. 15. According to the therapeutic control treatment, since the depth body temperature after the elapse of a prescribed period is predicted at the time of increasing the temperature, the depth body temperature can be increased to the therapeutic temperature without overshoot. Also, since the liquid temperature can be increased at a preset temperature increasing rate, or keeping the difference between the depth body temperature and the liquid temperature at a constant, or the depth body temperature is increased at a preset temperature increasing rate, a temperature increasing manner can be selected to meet the situations of the patient with a low loading. At the time of therapy, since the liquid temperature is controlled by predicting the depth body temperature after the elapse of a prescribed period from the change in the depth body temperature, the depth body temperature can be kept constant at a high accuracy. Also, at the time of decreasing the temperature, since the liquid temperature can be decreased at a preset temperature decreasing rate, or the depth body temperature can be decreasing at a preset temperature decreasing rate, an temperature decreasing method can be selected to meet the situation of the patient with a low loading, making it possible to decrease the depth body temperature the escaping temperature without overload.

Also, there is a function that the liquid temperature or the difference between the liquid temperature and the depth body temperature does not exceed a prescribed range at the time of increasing and decreasing the temperature, a stress of the patient undergone due to the temperature difference between the body temperature and the liquid temperature such as temperature pain can be reduced.

Part or whole of the references such as scientific papers, patent documents, patent applications cited herein may be incorporated herein in such an extent that they are specifically described.

While preferred embodiments of the present invention have been described, the present invention is not restricted thereto. It should be understood that the scope of the present invention is interoperated by Claims. It should been understood by the artisan that equivalent can be put into practical use based on the description of the specific preferred embodiments of the present invention based on the description and the technical commonsense. It also should be understood that part or whole of the references such as scientific papers, patents, patent applications cited herein may be incorporated herein in such an extent that they are specifically described.

### EXAMPLES

In the following examples, therapeutic examples of various patients. The symbol arrow in measured value shows values before treatment→after treatment.

### Example 1A

### Treatment of Patient Suffering from Acquired Immune Deficiency Syndrome (AIDS)

In this example, Mr. N. S suffering from AIDS was treated.

### (Situation Before Treatment)

According to doctor's diagnosis, the situations of this patient were as follows:

The diagnosis makes it clear that the patient suffers from AIDS. Two years after the first diagnosis, the patient underwent medical examination for the treatment.

The results are as follows:

| Number of Leukocyte: | 4400 (/μl) |
|---|---|
| Lymphocyte Percentage: | 28.6% |
| Number of lymphocyte | 1258 (/μl) |
| CD4 (μl): | 388 (According to WHO standard, a value not |
| | more than 200 indicates onset of AIDS, a value |
| | not more than 350 is a threshold value |
| | considering the initiation of therapeutic |
| | treatment, and a value not less than 500 is |
| | considered to be a dangerous area for initiation |
| | of the treatment) |
| CD8 (/μl) : | 614 |

### (Collection of Data for Thermotherapy)

Under observation by a doctor, a standard thermotherapy was conducted (41.6° C., 23 minutes ‘(whole body bathing), 57 minutes (half body bathing)). In this case, the following data was collected:

Electric potential of oxidation-reduction (or pH) of blood Biochemistry of hemocyte fractionation, disease marker, SpO₂, and hart rate

The data before treatment is as follows:

| Rectal temperature: | 37.7° C. |
|---|---|
| Number of Lymphocytes: | 1258 μl |
| CD4 (/μl): | 388 (According to WHO standard, a value not |
| | more than 200 indicates onset of AIDS, a value |
| | not more than 350 is a threshold value |
| | considering the initiation of therapeutic |
| | treatment, and a value not less than 500 is |
| | considered to be a dangerous area for initiation |
| | of the treatment) |
| CD8 (/μl): | 614 |
| SpO₂: | 96% |
| Hart rate: | 92 |

(At the time of the maximum temperature)

| | |
|---|---|
| Rectal temperature: | 39.8° C. |
| SpO₂: | 97% |
| Hart rate: | 133 |

(After treatment)

| | |
|---|---|
| Number of Leukocyte: | 5700/μl |
| Number of Lymphocytes: | 1373/μl |
| CD4 (/μl): | 490 (According to WHO standard, a value not |
| | more than 200 indicates onset of AIDS, a value |
| | not more than 350 is a threshold value |
| | considering the initiation of therapeutic |
| | treatment, and a value not less than 500 is |
| | considered to be a dangerous area for initiation |
| | of the treatment) |
| CD8 (/μl): | 642 |
| SpO₂: | 97% |
| Hart rate: | 110 |

When pH value was measured at this time, in comparison with before treatment (pH=7.40) with during the course of the treatment (pH 7.60), the absolute pH value under treatment is 0.2 higher than that before treatment.

### (Thermotherapy to be Applied)

In each therapeutic treatment, the basic data and data concerning the disease (in this case, AIDS, according to WHO standard, a value not more than 200 indicates onset of AIDS, a value not more than 350 is a threshold value considering the initiation of therapeutic treatment, and a value not less than 500 is considered to be a dangerous area for initiation of the treatment).

From the above results, the treatment is as follows:

Whole body bathing at 42° C. over a period of 21 minutes

### (Therapeutic Method)

From the data given from the above standard thermotherapy the therapy described above was applied after permission of his own doctor.

### (Passage Information)

Data concerning the disease (which is AIDS: According to WHO standard, a value not more than 200 indicates onset of AIDS, a value not more than 350 is a threshold value considering the initiation of therapeutic treatment, and a value not less than 500 is considered to be a dangerous area for initiation of the treatment) was collected per every treatment.

After treatment of treatment at 35th day

| Number of Leukocyte: | 4200/μl |
|---|---|
| Number of Lymphocytes: | 2276/μl |
| CD4 (/μl): | 632 (According to WHO standard, a value not |
| | more than 200 indicates onset of AIDS, |
| | a value not more than 350 is a threshold |
| | value considering the initiation of |
| | therapeutic treatment, and a value not |
| | less than 500 is considered to be a |
| | dangerous area for initiation of the |
| | treatment). |
| CD8 (/μl): | 1038 |
| SpO₂: | 97% |
| Hart rate: | 133 |

Treatment at 1 year and 3 month

| | |
|---|---|
| Number of Leukocyte: | 3970/μl |
| Number of Lymphocytes: | 2199/μl |
| CD4 (/μl): | 594 (According to WHO standard, a value not |
| | more than 200 indicates onset of AIDS, |
| | a value not more than 350 is a threshold |
| | value considering the initiation of |
| | therapeutic treatment, and a value not |
| | less than 500 is considered to be a |
| | dangerous area for initiation of the |
| | treatment). |
| CD8 (/μl): | 1160 |

### (Results)

AIDS disappeared from the patient approximately one after from the therapy, and he returned to be in a substantial normal state, and his immunological parameters were returned to be approximately within normal values. Although the number of virus was not decreased, as for CD4, it has been proven that the value which should be treated according to WHO standard was change into the value, which is in a normal state.

Consequently, it has been proven that thermotherapy utilizing reduction-oxidation state or pH value as an index induces therapeutic effects at the maximum extent.

### Example 1B

### Treatment of Patient Suffering from Acquired Immune Deficiency Syndrome (AIDS))

In this example, Mrs. T. N (pregnant woman) suffering from AIDS was treated.

### (Situation Before Treatment)

According to doctor's diagnosis, at the time of pregnancy examination, it was found to be infected with HIV. As for onset of AIDS, the doctor notified to be dangerous situations that CD positive lymphocyte number was drawing near the threshold value considering initiation of treatment, which was not more than 350.

(Before Treatment)

| | |
|---|---|
| Rectal Temperature | 37.5° C. |
| pH | 7.373 |
| pCO₂: | 39 mmHg |
| pO₂: | 28 mmHg |
| Number of Leukocyte | 8400/μl |
| Number of erythrocyte | 356 × 10⁴/μl |
| Platelet: | 29.4 × 10⁴/μl |
| Number of Lymphocyte | 1798/μl |
| Number of Granulocyte | 6250/μl |
| Amount of HIV-1 RNA: | 1.2 × 10³ copies |
| CD4: | 363/μl |
| CD8 | 430/μl |

Under observation by a doctor, a standard thermotherapy was conducted (41.6° C., 23 minutes ‘(whole body bathing), 57 minutes (half body bathing)). In this case, the following data was collected:

Electric potential of oxidation-reduction (or pH) of blood

Biochemistry of hemocyte fractionation, disease marker, SpO₂, and hart rate

The data before treatment is as follows:

| | |
|---|---|
| pH | 7.373 |
| pCO₂: | 39 mmHg |
| pO₂: | 28 mmHg |
| Number of Leukocyte | 8400/μl |
| Number of erythrocyte | 356 (×10⁴/μl) |
| Platelet: | 29.9 (×10⁴/μl) |
| Number of Lymphocyte | 1798 (/μl) |
| Number of Granulocyte | 6250 (/μl) |
| Amount of HIV-1 RNA: | 1.2 × 10³ copies |
| CD4: | 363/μl 632 (According to WHO standard, a |
| | value not more than 200 indicates onset |
| | of AIDS, a value not more than 350 is a |
| | threshold value considering the initiation |
| | of therapeutic treatment, and a value not |
| | less than 500 is considered to be a |
| | dangerous area for initiation of the |
| | treatment). |
| CD8 | 430/μl |
| SpO₂: | 99% |
| Hart rate: | 70 |

(At time of bathing +1° C.)

| | |
|---|---|
| Rectal Temperature | 37.5° C. |
| SpO₂: | 99% |
| Hart rate: | 70 |

At time of Rectal temperature equaling to 39.0° C.

| | |
|---|---|
| Rectal Temperature | 39.0° C. |
| SpO₂: | 100% |
| Hart rate: | 99 |

At time of the maximum temperature

| | |
|---|---|
| Rectal Temperature | 39.2° C. |
| SpO₂: | 98% |
| Hart rate: | 106. |

(After Treatment)

| | |
|---|---|
| Rectal Temperature | 39.24° C. |
| pH | 7.466 |
| pCO₂: | 28.9 mmHg |
| pO₂: | 56 mmHg |
| Number of Leukocyte | 7400/μl |
| Number of erythrocyte | 395 × 10⁴/μl |
| Platelet: | 33.5 × 10⁴/μl |
| Number of Lymphocyte | 2183/μl |
| Number of Granulocyte | 4988/μl |
| (/μl) | |
| Amount of HIV-1 RNA: | 1.2 × 10⁴ copies |
| CD4: | 435/μl 632 (According to WHO standard, a |
| | value not more than 200 indicates onset |
| | of AIDS, a value not more than 350 is a |
| | threshold value considering the initiation of |
| | therapeutic treatment, and a value not less |
| | than 500 is considered to be a dangerous |
| | area for initiation of the treatment). |
| CD8 | 454/μl |
| SpO₂: | 100% |
| Hart rate: | 110 |

In comparison with pH values before and during the course of treatment, the absolute pH value under treatment was increased to be 0.1 or more than that before treatment.

### (Thermotherapy to be Applied)

From the above, the thermotherapy was determined as follows:

Whole body bathing 22 minutes; half body bathing 38 minutes; temperature at the time of bating 42° C.

### (Therapeutic Method)

From the data given from the above standard thermotherapy the therapy described above was applied after permission of his own doctor.

### (Passage Information)

Data concerning the disease (which is AIDS: According to WHO standard, a value not more than 200 indicates onset of AIDS, a value not more than 350 is a threshold value considering the initiation of therapeutic treatment, and a value not less than 500 is considered to be a dangerous area for initiation of the treatment) was collected per every treatment.

(After 2nd treatment (2 weeks after the first treatment))

| | |
|---|---|
| pH | 7.409 |
| Number of Leukocyte | 7200/μl |
| Number of Lymphocyte | 1771/μl |
| Amount of HIV-1 RNA: | 1.5 × 10³ copies |
| CD4: | 483/μl |
| CD8 | 574/μl |

(After 3rd treatment (2 weeks after the 2nd treatment))

| | |
|---|---|
| pH | 7.374 |
| Number of Leukocyte | 11100/μl |
| Number of Lymphocyte | 2564/μl |
| Amount of HIV-1 RNA: | 1.6 × 10³ copies |
| CD4: | 800/μl |
| CD8 | 690/μl |

### (Results)

AIDS substantially disappeared two weeks after the therapy, and the patient substantially returned to be normal situations. It has been found that even after the first treatment, the value of “CD42 as an index drastically changed for the better. In the situations of passage, the CD4 value surely changed for the better by cycle treatments in which 17 days after the first treatment, drastic improvement effect has been found, CD value from 363/μl to 800/μl.

At this time, her redox electric potential and her immunological parameters were returned to be approximately within normal values. Although the number of virus was not decreased, as for CD4, it has been proven that the value which should be treated according to WHO standard was change into the value, indicating the healthy state.

Consequently, it has been proven that thermotherapy utilizing reduction-oxidation state or pH value as an index induces therapeutic effects at the maximum extent.

### Example 2

### Treatment of Patient Suffering from Hepatitis B (HBV))

In this example, Mr. N. M (male; 53 years old) suffering from hepatitis B was treated.

### (Situation Before Treatment)

According to diagnosis by a doctor, the situations of the patient were as follows:

Subjective symptom of neuralgia; DNA probe revealed infection of HBV.

### (Collection of Data for Thermotherapy)

Under observation by a doctor, a standard thermotherapy was conducted (42° C., 24 minutes ‘(whole body bathing), 36 minutes (half body bathing)). In this case, the following data was collected:

Electric potential of oxidation-reduction (or pH) of blood

Biochemistry of hemocyte fractionation, disease marker, SpO₂, and hart rate

The data before treatment is as follows:

Number of Lymphocytes: 2778→3683 μl

Hypoglossal Temperature: 36.7° C.→38.3° C.

In comparison with pH values before and during the course of treatment, the absolute pH value under treatment was increased to be 0.1 or more than that before treatment.

### (Standard Thermotherapy)

From the above, the thermotherapy was determined as follows:

Whole body bathing 24 minutes; half body bathing 36 minutes; temperature at the time of bating 42° C.

### (Therapeutic Method)

From the data given from the above standard thermotherapy the therapy described above was applied after permission of his own doctor. Six sets of thermotherapeutic treatment (whole body bathing 24 minutes; half body bathing 36 minutes; temperature at the time of bating 42° C.) were conducted to six months at an interval of 2 weeks to 4 weeks)

### (Passage Information)

In each therapy, basic data and data for the disease (HBV) were collected.

HBV-DNA Probe: immediately after treatment: 9.4 (Standard value not more than 0.7)

Two moths after: not more than 0.7

Five months after: not more than 0.7

### (Results)

Two months after treatment, HBV substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 3

### Treatment of Patient Suffering from Hepatitis C (HBV)

In this example, Mrs. T (female; 56 years old) suffering from hepatitis HCV was treated.

### (Situation Before Treatment)

According to diagnosis by a doctor, the situations of the patient were as follows:

After antigen inspection, affection with HCV was understood by DNA probe.

### (Collection of Data for Thermotherapy)

Under observation by a doctor, a standard thermotherapy was conducted (42° C., 24 minutes (whole body bathing), 36 minutes (half body bathing)). In this case, the following data was collected:

Electric potential of oxidation-reduction (or pH) of blood

Gas analysis in blood, Biochemistry of hemocyte fractionation, disease marker, SpO₂, hart rate and blood flow rate.

In comparison with pH values before and during the course of treatment, the absolute pH value under treatment was increased to be 0.1 or more than that before treatment.

### (Standard Thermotherapy)

The thermotherapy was determined as follows:

Whole body bathing 24 minutes; half body bathing 36 minutes; temperature at the time of bating 42 degree C.

### (Therapeutic Method)

From the data given from the above standard thermotherapy the therapy described above was applied after permission of his own doctor. The thermotherapeutic treatment (whole body bathing 24 minutes; half body bathing 36 minutes; temperature at the time of bating 42 degree C) were conducted over a period of six months at an interval of 2 weeks to 4 weeks.

### (Passage Information)

In each therapy, basic data and data for the disease (HCV) were collected.

Examination by HCV-DNA probe, HBV substantially disappeared two moths after the treatment.

### (Results)

Two months after treatment, HBV substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 4

### Treatment of Patient Suffering from Diabetes Mellitus

In this example, Mr. K. T (male; 52 years old) suffering from Diabetes mellitus was treated.

### (Situation Before Treatment)

According to doctor's diagnosis, the situations of this patient were as follows: The blood glucose level was 181 mg/dl which was substantially twice the standard (70-109 mg/dl).

Under observation by a doctor, a standard thermotherapy was conducted (42° C., 24 minutes ‘(whole body bathing), 36 minutes (half body bathing)). In this case, the following data was collected:

Electric potential of oxidation-reduction (or pH) of blood

Gas analysis in blood, Biochemistry of hemocyte fractionation, disease marker, SpO₂, hart rate and blood flow rate.

The data before treatment was as follows:

| Rectal temperature: | 36.61° C. |
|---|---|
| Hypoglottis Temperature: | 36.60° C. |
| pH: | 7.339 |
| pCO₂: | 30.0 mmHg |
| pO₂: | 52.3 mmHg |
| Number of Leukocyte | 8500/μl |
| Number of erythrocyte | 487 × 10⁴/μl |
| Number of platelet: | 15.6 × 10⁴/μl |
| Number of Lymphocyte | 3340.5/μl |
| Number of Granulocyte | 5040.5/μl |
| Blood Glucose Level | 157 |
| SpO₂: | 99% |
| Hart Rate: | 86 |

(Arriving at 39° C.)

| | |
|---|---|
| Rectal temperature: | 39.00° C. |
| SpO₂: | 99% |
| Hart Rate: | 138 |

(Before Treatment)

| | |
|---|---|
| Rectal temperature: | 38.15° C. |
| Hypoglottis Temperature: | 36.50° C. |
| pH: | 7.5007 |
| pCO₂: | 76.0 mmHg |
| pO₂: | 31.0 mmHg |
| Number of Leukocyte | 10900/μl |
| Number of erythrocyte | 531 × 10⁴/μl |
| Number of platelet: | 20.0 × 10⁴/μl |
| Number of Lymphocyte | 4599.8/μl |
| Number of Granulocyte | 6114.9/μl |
| Blood Glucose Level | 177 |
| SpO₂: | 99% |
| Hart Rate: | 144 |

### (Thermotherapy)

The thermotherapy was determined as follows:

Whole body bathing 24 minutes; half body bathing 36 minutes; temperature at the time of bating 42° C.

### (Therapeutic Method)

From the data given from the above standard thermotherapy the therapy described above was applied after permission of his own doctor. The thermotherapeutic treatment (whole body bathing 23 minutes; half body bathing 36 minutes; temperature at the time of bating 42° C.) were conducted repeatedly at an interval of 1 week to 2 months.

### (Passage Information)

In each therapy, basic data and data for the disease (Diabetes mellitus) were collected.

(Two Months After)

| Rectal temperature: | 36.74° C. |
|---|---|
| Hypoglottis Temperature: | 36.50° C. |
| pH: | 7.361 |
| pCO₂: | 52.4 mmHg |
| pO₂: | 25 mmHg |
| Number of Leukocyte | 7400/μl |
| Number of erythrocyte | 461 × 10⁴/μl |
| Number of platelet: | 17.1 × 10⁴/μl |
| Number of Lymphocyte | 2967/μl |
| Number of Granulocyte | 4196/μl |
| Blood Glucose Level | 109 |
| SpO₂: | 99% |
| Hart Rate: | 69 |

(Six Months After)

| | |
|---|---|
| Rectal temperature: | 37.04° C. |
| Hypoglottis Temperature: | 36.8° C. |
| pH: | 7.382 |
| pCO₂: | 41.25 mmHg |
| pO₂: | 42 mmHg |
| Number of Leukocyte | 7500/μl |
| Number of erythrocyte | 499 × 10⁴/μl |
| Number of platelet: | 15.8 × 10⁴/μl |
| Number of Lymphocyte | 3233/μl |
| Number of Granulocyte | 4080/μl |
| Blood Glucose Level | 125 |
| SpO₂: | 98% |
| Hart Rate: | 76 |

Two months after treatment, Diabetes mellitus substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects against Diabetes mellitus at the fullest extent.

### Example 5

### Treatment of Patient Suffering from Benign Prostatic Hyperplasia

In this example, Mr. N. M suffering from D benign prostatic hyperplasia was treated.

### (Situation Before Treatment)

According to doctor's diagnosis, the situations of this patient were as follows: The patient was suffering from gout, hypertension and had a symptom of benign prostatic hyperplasia. Allopurinol was administrated for treatment of the gout, and AVAPRO (for hypertension) and FLOMAX (for prostatic cancer) were also administrated.

### (Data Collection for Thermotherapy)

Under observation by a doctor, a standard thermotherapy was conducted (42° C., 60 minutes ‘(whole body bathing) In this case, the following data was collected:

Electric potential of oxidation-reduction (or pH) of blood

Gas analysis in blood, Biochemistry of hemocyte fractionation, disease marker, SpO₂, hart rate and blood flow rate.

The data before treatment was as follows:

| | |
|---|---|
| Rectal temperature: | 36.6° C. |
| Hypoglottis Temperature: | 37.03° C. |
| pH: | 7.344 |
| pCO₂: | 52.5 mmHg |
| pO₂: | 30 mmHg |
| Number of Leukocyte | 5000/μl |
| Number of erythrocyte | 438 × 10⁴/μl |
| Number of platelet: | 18.3 × 10⁴/μl |
| Number of Lymphocyte | 1250/μl |
| Number of Granulocyte | 3600/μl |
| Uric Acid Value: | 9.8 (mg/dl; Standard: not more than |
| | 7.0) |
| Blood Pressure | 158/76 (Marginal 140/85) |
| Benign Prostatic Hyperplasia: | Observed |
| SpO₂: | 94% |
| Hart Rate: | 86 |
| Electric Potential: | −70 mV |

(Arriving at 39° C.)

| | |
|---|---|
| Rectal temperature: | 39.00° C. |
| SpO₂: | 98% |
| Hart Rate: | 110 |
| Electric Potential: | −70 mV |

(Arriving at the Maximum Temperature (39.42° C.))

| | |
|---|---|
| Rectal temperature: | 39.42° C. |
| SpO₂: | 97% |
| Hart Rate: | 88 |
| Electric Potential: | −72 mV |

After Bathing

| | |
|---|---|
| Rectal temperature: | 39.35° C. |
| SpO₂: | 94% |
| Hart Rate: | 92 |
| Electric Potential: | −71 mV |

(After Treatment)

| | |
|---|---|
| Hypoglottis Temperature: | 36.7° C. |
| pH: | 7.551 |
| pCO₂: | 27.2 mmHg |
| pO₂: | 32 mmHg |
| Number of Leukocyte | 5100/μl |
| Number of erythrocyte | 498 × 10⁴/μl |
| Number of platelet: | 13 |
| Number of Lymphocyte | 2743/μl |
| Number of Granulocyte | 2859/μl |
| Blood Pressure | 135/66 |
| SpO₂: | 94% |
| Hart Rate: | 73 |

### (Standard Thermotherapy)

The thermotherapy was determined as follows:

Whole body bathing 20 minutes; half body bathing 40 minutes; temperature at the time of bating 42° C.

### (Therapeutic Method)

From the data given from the above standard thermotherapy the therapy described above was applied after permission of his own doctor. The thermotherapeutic treatment (whole body bathing 20 minutes; half body bathing 40 minutes; temperature at the time of bating 42° C.) were conducted at an interval of from 5 to 7 days.

### (Passage Information)

In each therapy, basic data and data for the disease (gout) were collected. The index of the gout is uric acid value.

(One Week After)

| Hypoglottis Temperature: | 37.2° C. |
|---|---|
| pH: | 7.384 |
| pCO₂: | 44.6 mmHg |
| pO₂: | 39 mmHg |
| Number of Leukocyte | 5000/μl |
| Number of erythrocyte | 399 × 10⁴/μl |
| Number of platelet: | 11.4 × 10⁴/μl |
| Number of Lymphocyte | 1845/μl |
| Number of Granulocyte | 3744/μl |
| Blood Pressure | 172/89 |
| SpO₂: | 98% |
| Hart Rate: | 82 |

(Two Week After)

| | |
|---|---|
| Hypoglottis Temperature: | 36.13° C. |
| pH: | 7.389 |
| pCO₂: | 42 mmHg |
| pO₂: | 60 mmHg |
| Number of Leukocyte | 5900/μl |
| Number of erythrocyte | 436 × 10⁴/μl |
| Number of platelet: | 12.2 × 10⁴/μl |
| Number of Lymphocyte | 2331/μl |
| Number of Granulocyte | 3398/μl |
| Blood Pressure | 157/89 |
| SpO₂: | 97% |
| Hart Rate: | 70 |

### (Results)

Two weeks after the treatment, Benign Prostatic Hyperplasia substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 6

### Treatment of Patient Suffering from Gout

In this example, Mr. N. M suffering from gout was treated.

### (Situation Before Treatment)

According to doctor's diagnosis, the situations of this patient were as follows: The patient was suffering from gout, hypertension and had a symptom of benign prostatic hyperplasia. Allopurinol was administrated for treatment of the gout, and AVAPRO (for hypertension) and FLOMAX (for prostatic cancer) were also administrated.

### (Data Collection for Thermotherapy)

Under observation by a doctor, a standard thermotherapy was conducted (42° C., 60 minutes ‘(whole body bathing). In this case, the following data was collected:

Electric potential of oxidation-reduction (or pH) of blood

Gas analysis in blood, Biochemistry of hemocyte fractionation, disease marker, SpO₂, hart rate and blood flow rate.

The data before treatment was as follows:

| Rectal temperature: | 37.03° C. |
|---|---|
| Hypoglottis Temperature: | 36.6° C. |
| pH: | 7.344 |
| pCO₂: | 52.5 mmHg |
| pO₂: | 30 mmHg |
| Number of Leukocyte | 5100/μl |
| Number of erythrocyte | 447 × 10⁴/μl |
| Number of platelet: | 4.2 × 10⁴/μl |
| Number of Lymphocyte | 2509/μl |
| Number of Granulocyte | 2387/μl |
| Uric Acid Value: | 9.8 (mg/dl; Standard: not more than |
| | 7.0) |
| Blood Pressure | 158/76 (Marginal 140/85) |
| Benign Prostatic Hyperplasia: | Observed |
| SpO₂: | 94% |
| Hart Rate: | 54 |

(Arriving at 39° C.)

| | |
|---|---|
| Rectal temperature: | 39.00° C. |
| SpO₂: | 98% |
| Hart Rate: | 110 |

(Arriving at the Maximum Temperature (39.42° C.))

| | |
|---|---|
| Rectal temperature: | 39.42° C. |
| SpO₂: | 97% |
| Hart Rate: | 88 |

After Bathing

| | |
|---|---|
| Rectal temperature: | 39.35° C. |
| SpO₂: | 96% |
| Hart Rate: | 92 |

(After Treatment)

| | |
|---|---|
| Rectal Temperature: | 36.7° C. |
| pH: | 7.551 |
| pCO₂: | 27.2 |
| pO₂: | 32 |
| Number of Leukocyte | 5100/μl |
| Number of erythrocyte | 498 × 10⁴/μl |
| Number of platelet: | 13 |
| Number of Lymphocyte | 2743/μl |
| Number of Granulocyte | 2859/μl |
| Blood Pressure | 135/66 |
| SpO₂: | 94% |
| Hart Rate: | 73 |

### (Standard Thermotherapy)

The thermotherapy was determined as follows:

Whole body bathing 20 minutes; half body bathing 40 minutes; temperature at the time of bating 42° C.

### (Therapeutic Method)

From the data given from the above standard thermotherapy the therapy described above was applied after permission of his own doctor. The thermotherapeutic treatment (whole body bathing 20 minutes; half body bathing 40 minutes; temperature at the time of bating 42° C.) were conducted at an interval of from 5 to 7 days.

### (Passage Information)

In each therapy, basic data and data for the disease (gout) were collected. The index of the gout is uric acid value.

(After The Final Treatment)

| Rectal Temperature: | 39.09° C. |
|---|---|
| pH: | 7.535 |
| pCO₂: | 25.6 |
| pO₂: | 51 |
| Number of Leukocyte | 5800/μl |
| Number of erythrocyte | 447 × 10⁴/μl |
| Number of platelet: | 12.2 × 10⁴/μl |
| Lymphocyte Percentage | 51.7 |
| Granulocyte Percentage | 45.6 |
| Uric Acid Value | 9.8 |
| Blood Pressure | 160/68 |
| Benign Prostatic Hyperplasia: | Not Observed |
| SpO₂: | 94% |
| Hart Rate: | 68 |

### (Results)

Two months after the treatment, gout substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 7

### Treatment of Patient Suffering from Autoimmune Disease

In this example, a patient suffering from autoimmune disease was treated.

### (Situation Before Treatment)

According to doctor's diagnosis, the patient was diagnosed to be autoimmune disease.

### (Data Collection for Thermotherapy)

Under observation by a doctor, a standard thermotherapy was conducted (42° C., 60 minutes ‘(whole body bathing). In this case, the following data was collected:

Electric potential of oxidation-reduction (or pH) of blood

Gas analysis in blood, Biochemistry of hemocyte fractionation, disease marker, SpO₂, hart rate and blood flow rate.

### (Standard Thermotherapy)

The thermotherapy was determined as follows:

Bating for 60 minutes at 42° C. (Whole body bathing 45 minutes)

### (Therapeutic Method)

From the data given from the above standard thermotherapy the therapy described above was applied after permission of his own doctor.

### (Passage Information)

In each therapy, basic data and data for the disease (autoimmune disease) were collected.

### (Results)

Two months after the treatment, autoimmune disease substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 8

### Treatment of Patient Suffering from Malignant Lymphoma (Non-Hodgkin Lymphoma)

In this example, Mrs. T. N (female) suffering from malignant lymphoma was treated.

### (Situation Before Treatment)

According to doctor's diagnosis, the situations of this patient were as follows: After left side renal cancer was extirpated in a hospital, metastasized to ovarian cancer and malignant lymphoma. These cancers were extirpated at the same time, GSS was also found. The right ovary was totally extirpated and a part of the left side was excised. A series of four administration of anti-cancer agent was conducted twice.

### (Data Collection for Thermotherapy)

Under observation by a doctor, a standard thermotherapy was conducted (41° C., 32 minutes ‘(whole body bathing), 41.5° C. for 27 minutes (half body bathing). In this case, the following data was collected:

Electric potential of oxidation-reduction (or pH) of blood

Gas analysis in blood, Biochemistry of hemocyte fractionation, disease marker, SpO₂, hart rate and blood flow rate.

The data before treatment was as follows:

| Rectal Temperature: | 37.51° C. |
|---|---|
| Hypoglottis Temperature: | 37.1° C. |
| pH: | 7.353 |
| Number of Leukocyte | 4300/μl |
| Number of erythrocyte | 303 × 10⁴/μl |
| Number of platelet: | 11.1 × 10⁴/μl |
| Number of Lymphocyte | 1023/μl |
| Number of Granulocyte | 3066/μl |
| SpO₂: | 99% |
| Hart Rate: | 87 |

(After Treatment)

| | |
|---|---|
| Rectal Temperature: | 39.66° C. |
| Hypoglottis Temperature: | 39.2° C. |
| pH: | 7.439 |
| Number of Leukocyte | 5400/μl |
| Number of erythrocyte | 310 × 10⁴/μl |
| Number of platelet: | 13.3 × 10⁴/μl |
| Number of Lymphocyte | 1517/μl |
| Number of Granulocyte | 3586/μl |
| SpO₂: | 99% |
| Hart Rate: | 108 |

### (Thermotherapy)

The thermotherapy was determined as follows:

42° C. for 60 minutes (whole body bathing 45 minutes)

### (Therapeutic Method)

From the data given from the above standard thermotherapy the therapy described above was applied after permission of his own doctor. The thermotherapeutic treatment (42° C. for 60 minutes (whole body bathing 45 minutes)) was conducted at an interval of from 5 to 7 days.

### (Passage Information)

In each therapy, basic data and data for the disease (malignant lymphoma) were collected.

(After 3rd Treatment (9 days after initiation of treatment)

| Rectal Temperature: | 37.43° C. → Unknown |
|---|---|
| Hypoglottis Temperature: | 36.9° C. → 38.8° C. |
| pH: | 7.325 → 7.429 |
| pCO₂: | 53.5 → 37.0 |
| pO₂: | 30 → 77 |
| Number of Leukocyte | 4100/μl → 5400 μl |
| Number of erythrocyte | 305 → 319(×10⁴/μl) |
| Number of platelet: | 12.9 → 13.7 (×10⁴/μl) |
| Number of Lymphocyte | 1611 → 2300/μl |
| Number of Granulocyte | 2210 → 2765/μl |
| CA19-9 (malignant lymphoma | 179.3 → 194.6 |
| marker): | |
| SpO₂: | 99% |
| Hart Rate: | 153 |

(After 6th Treatment (One month after initiation of treatment)

| Rectal Temperature: | 37.35° C. → 39.30° C. |
|---|---|
| Hypoglottis Temperature: | 37.0° C. → 37.2° C. |
| pH: | 7.350 → 7.436 |
| pCO₂: | 51.8 → 38.5 |
| pO₂: | 35 → 69 |
| Number of Leukocyte | 4100/μl → 5300 μl |
| Number of erythrocyte | 303 → 328(×10⁴/μl) |
| Number of platelet: | 13.6 → 16.8 (×10⁴/μl) |
| Number of Lymphocyte | 1181 → 1802/μl |
| Number of Granulocyte | 2781 → 3291/μl |
| CA19-9 (malignant lymphoma marker): | 31.8 → 34.1 |
| | (Standard not more than 37.0) |
| SpO₂: | 97% → 95% |
| Hart Rate: | 85 → 143 |
| Blood Flow: | 4.2 → 18.2 |

(After 16th Treatment (Two months after initiation of treatment)

| Rectal Temperature: | 36.7° C. → 37.9° C. |
|---|---|
| Hypoglottis Temperature: | 37.0° C. → 37.2° C. |
| pH: | 7.212 → 7.468 |
| pCO₂: | 68.8 → 40.7 |
| pO₂: | 50 → 82 |
| Number of Leukocyte | 4300/μl → 5300 μl |
| Number of erythrocyte | 334 → 368(×10⁴/μl) |
| Number of platelet: | 14.9 → 16.3 (×10⁴/μl) |
| Number of Lymphocyte | 1346 → 1754/μl |
| Number of Granulocyte | 2804 → 3355/μl |
| CA19-9 (malignant lymphoma | 35.4 (Standard not |
| marker): | more than 37.0) |
| SpO₂: | 99% → 99% |
| Hart Rate: | 70 → 158 |

### (Results)

Two months after the treatment, malignant lymphoma substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 9

### Treatment of Patient Suffering from Pancreas Cancer

In this example, O. H suffering from pancreas cancer was treated.

### (Situation Before Treatment)

According to doctor's diagnosis, the situations of this patient were as follows: Pancreas cancer and its metastasis to liver had been observed.

### (Basic Data Collection for Thermotherapy)

Under observation by a doctor, a standard thermotherapy was conducted (42° C., 60 minutes (whole body bathing 24 minutes). In this case, the following data was collected:

Electric potential of oxidation-reduction (or pH) of blood

Gas analysis in blood, Biochemistry of hemocyte fractionation, disease marker, SpO₂, hart rate and blood flow rate.

The data before treatment was as follows:

| Rectal Temperature: | 36.94° C. |
|---|---|
| pH: | 7.382 |
| pCO₂: | 44.0 mmHg |
| pO₂: | 67 mmHg |
| Number of Leukocyte | 8300/μl |
| Number of erythrocyte | 464 × 10⁴/μl |
| Number of platelet: | 20.1 × 10⁴/μl |
| Number of Lymphocyte | 4000.6/μl |
| Number of Granulocyte | 4058.7/μl |
| Remark: | Pancreas cancer and its metastasis to |
| | liver observed |
| SpO₂: | 100.0% |
| Hart Rate: | 52 |
| Blood Flow: | 4.2 |

(Arriving at 39.0° C.)

| | |
|---|---|
| Rectal Temperature: | 39.00° C. |
| SpO₂: | 98.0% |
| Hart Rate: | 82 |
| Blood Flow: | 14.5 |

(Arriving at the Maximum Temperature)

| | |
|---|---|
| Rectal Temperature: | 39.68° C. |
| SpO₂: | 99.0% |
| Hart Rate: | 86 |
| Blood Flow: | 16.7. |

(After Treatment)

| | |
|---|---|
| Hypoglottis Temperature: | 38.1° C. |
| pH: | 7.501 |
| pCO₂: | 30.2 mmHg |
| pO₂: | 65 mmHg |
| Number of Leukocyte | 9700/μl |
| Number of erythrocyte | 476 × 10⁴/μl |
| Number of platelet: | 21.9 × 10⁴/μl |
| Number of Lymphocyte | 2124.3/μl |
| Number of Granulocyte | 7410.8/μl |
| SpO₂: | 99.0% |

### (Standard Thermotherapy)

The thermotherapy was determined as follows:

42° C. for 24 minutes whole body bathing; 36 minutes Half body bathing

### (Therapeutic Method)

From the data given from the above standard thermotherapy the therapy described above was applied after permission of his own doctor. The thermotherapeutic treatment (42° C. for 24 minutes whole body bathing; 36 minutes Half body bathing) was repeatedly conducted at an interval of from 5 to 7 days.

### (Passage Information)

In each therapy, basic data and data for the disease (pancreas cancer) were collected.

Passage after Treatment

(One Month After)

| | |
|---|---|
| Hypoglottis Temperature: | 37.0° C. |
| pH: | 7.427 |
| pCO₂: | 36.8 mmHg |
| pO₂: | 68 mmHg |
| Number of Leukocyte | 5700/μl |
| Number of erythrocyte | 421 × 10⁴/μl |
| Number of platelet: | 21.5 × 10⁴/μl |
| Number of Lymphocyte | 2171.7/μl |
| Number of Granulocyte | 3290.0/μl |
| Remark: | Pancreas cancer and liver cancer were |
| | shrunk and no need for administration of |
| | insulin |

(3 Months After)

| | |
|---|---|
| Rectal Temperature: | 37.18° C. |
| pH: | 7.434 |
| pCO₂: | 38.7 mmHg |
| pO₂: | 68.0 mmHg |
| Number of Leukocyte | 7100/μl |
| Number of erythrocyte | 447 × 10⁴/μl |
| Number of platelet: | 21.2 × 10⁴/μl |
| Number of Lymphocyte | 2591/μl |
| Number of Granulocyte | 2877/μl |
| Remark: | Pancreas cancer and liver cancer were |
| | shrunk and no need for administration of |
| | insulin |

Although insulin was used before treatment, the use of insulin was stopped after 3 months, self production being observed.

(4 Months After)

| | |
|---|---|
| Rectal Temperature: | 36.97° C. |
| pH: | 7.468 |
| pCO₂: | 33.4 mmHg |
| pO₂: | 108.0 mmHg |
| Number of Leukocyte | 5300/μl |
| Number of erythrocyte | 432 × 10⁴/μl |
| Number of platelet: | 17.7 × 10⁴/μl |
| Number of Lymphocyte | 2067.0/μl |
| Number of Granulocyte | 3068.7/μl |
| Remark: | Pancreas cancer and liver cancer were |
| | shrunk and no need for administration of |
| | insulin |

Also 4 months after the treatment, pancreas cancer and liver cancer were shrunk, and the self production was continued.

(5 Months After)

| | |
|---|---|
| Rectal Temperature: | 36.74° C. |
| pH: | 7.411 |
| pCO₂: | 43.3 mmHg |
| pO₂: | 53.0 mmHg |
| Number of Leukocyte | 7100/μl |
| Number of erythrocyte | 468 × 10⁴/μl |
| Number of platelet: | 17.4 × 10⁴/μl |
| Number of Lymphocyte | 2520.5/μl |
| Number of Granulocyte | 4416.2/μl |
| Remark: | Pancreas cancer and liver cancer were |
| | shrunk and no need for administration of |
| | insulin |

Also 5 months after the treatment, pancreas cancer and liver cancer were shrunk, and the self production was continued.

### (Results)

Pancreas cancer substantially disappeared two months after the therapy, and the subjective substantially returned to the normal state. The patient remarked that the body was refreshed and became healthy. The immunological parameters at this time also substantially returned to the original states. Insulin required at the time of the therapy was not required 3 months after the therapy, and the self production was started. This state was continued up to now. The liver cancer was also cured.

Consequently, it has been clarified that thermotherapy conducted utilizing states of redox electric potential as an index induced the therapeutic effects at the fullest extent.

### Example 10

### Treatment of Patient Suffering from Uterine Cervix Cancer

In this example, Mrs. O. A (female) suffering from uterine cervix cancer was treated.

### (Situation Before Treatment)

According to doctor's diagnosis, the situations of this patient were as follows:

### (Basic Data Collection for Thermotherapy)

Under observation by a doctor, a standard thermotherapy was conducted (42° C., for 24 minutes whole body bathing; 36 minutes half body bathing). In this case, the following data was collected:

Electric potential of oxidation-reduction (or pH) of blood

Gas analysis in blood, Biochemistry of hemocyte fractionation, disease marker, SpO₂, hart rate and blood flow rate.

### (Standard Thermotherapy)

The thermotherapy was determined as follows:

42° C. for 24 minutes whole body bathing; 36 minutes Half body bathing

### (Therapeutic Method)

From the data given from the above standard thermotherapy the therapy described above was applied after permission of his own doctor. The thermotherapeutic treatment (42° C. for 24 minutes whole body bathing; 36 minutes half body bathing) was conducted for 5 weeks at an interval of one week.

### (Passage Information)

In each therapy, basic data and data for the disease (uterine cervix cancer) were collected.

| | |
|---|---|
| Number of Lymphocyte | 2140 → 2156 |
| One Week after CA125 (Uterine Cervix Cancer: standard | 45.5 |
| not more than 35) | |
| Two Weeks after CA125 (Uterine Cervix Cancer: | 32.7 → 26.2 |
| standard not more than 35) | |
| Three Weeks after CA125 (Uterine Cervix Cancer: | 20.9 → 20.1 |
| standard not more than 35) | |
| Four Weeks after CA125 (Uterine Cervix Cancer: | 16.9 → 13.6 |
| standard not more than 35) | |

### (Results)

Two months after the treatment, uterine cervix cancer substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 10

### Treatment of Patient Suffering from Oral Cavity Fundus Cancer

In this example, Mrs. S (female) suffering from oral cavity fundus cancer was treated.

### (Situation Before Treatment)

According to doctor's diagnosis, the situations of this patient were as follows:

### (Basic Data Collection for Thermotherapy)

Under observation by a doctor, a standard thermotherapy was conducted (42° C., for 24 minutes whole body bathing; 36 minutes half body bathing). In this case, the following data was collected:

Electric potential of oxidation-reduction (or pH) of blood

Gas analysis in blood, Biochemistry of hemocyte fractionation, disease marker, SpO₂, hart rate and blood flow rate.

### (Standard Thermotherapy)

The thermotherapy was determined as follows:

42° C. for 24 minutes whole body bathing; 36 minutes half body bathing

### (Therapeutic Method)

From the data given from the above standard thermotherapy the therapy described above was applied after permission of his own doctor. The thermotherapeutic treatment (42° C. for 24 minutes whole body bathing; 36 minutes half body bathing) was conducted for 5 months at an interval of one month.

### (Passage Information)

In each therapy, basic data and data for the disease (oral cavity fundus cancer) were collected.

| | |
|---|---|
| Number of Lymphocyte | 1734 → 1928 |
| Two Months after CA125 (Oral Cavity Fundus Cancer: | 63 → 62 |
| standard not more than 35) | |
| Four Months after CA125 (Oral Cavity Fundus Cancer: | 40.0 → 58.6 |
| standard not more than 35) | |
| Five Months after CA125 (Oral Cavity Fundus Cancer: | 39.5 |
| standard not more than 35) | |
| Six Months after CA125 (Oral Cavity Fundus Cancer: | 16.1. |
| standard not more than 35) | |

### (Results)

Two months after the treatment, oral cavity fundus cancer substantially disappeared, the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 12

### Treatment of Patient Suffering from Bladder Cancer

In this example, Mrs. S (female) suffering from bladder cancer was treated.

### (Situation Before Treatment)

According to doctor's diagnosis, the situations of this patient were as follows:

### (Basic Data Collection for Thermotherapy)

Under observation by a doctor, a standard thermotherapy was conducted (42° C., for 24 minutes whole body bathing; 36 minutes half body bathing). In this case, the following data was collected:

Electric potential of oxidation-reduction (or pH) of blood

Gas analysis in blood, Biochemistry of hemocyte fractionation, disease marker, SpO₂, hart rate and blood flow rate.

### (Standard Thermotherapy)

The thermotherapy was determined as follows:

42° C. for 24 minutes whole body bathing; 36 minutes half body bathing

### (Therapeutic Method)

From the data given from the above standard thermotherapy the therapy described above was applied after permission of his own doctor. The thermotherapeutic treatment (42° C. for 24 minutes whole body bathing; 36 minutes half body bathing) was conducted for 8 weeks at an interval of one week.

### (Passage Information)

In each therapy, basic data and data for the disease (bladder cancer) were collected.

| | |
|---|---|
| Number of Lymphocyte | 1267 → 1526 |
| One Week after IAP | 282 → 253 |
| Two Weeks after IAP | 280 → 284 |
| Four Weeks after IAP | 267 → 269 |
| Eight Weeks after IAP | 217 → 210 |

At this time, disappearing of the bladder cancer was confirmed.

### (Results)

Two months after the treatment, the bladder cancer substantially disappeared, the subjective substantially returned to the original state. The immunological parameters at this time also substantially returned to the original states. The patient also suffered from malignant lymphoma, which was also improved.

Consequently, it has been clarified that thermotherapy conducted utilizing states of redox electric potential as an index induced the therapeutic effects at the fullest extent.

### Example 13

### Treatment of Patient Suffering from Hypertension

In this example, Mr. N. M suffering from D benign prostatic hyperplasia was treated.

### (Situation Before Treatment)

According to doctor's diagnosis, the situations of this patient were as follows:

The patient was suffering from gout, hypertension and had a symptom of benign prostatic hyperplasia. Allopurinol was administrated for treatment of the gout, and AVAPRO (for hypertension) and FLOMAX (for prostatic cancer) were also administrated.

### (Data Collection for Thermotherapy)

Under observation by a doctor, a standard thermotherapy was conducted (42° C., 60 minutes (whole body bathing). In this case, the following data was collected:

Electric potential of oxidation-reduction (or pH) of blood

Gas analysis in blood, Biochemistry of hemocyte fractionation, disease marker, SpO₂, hart rate and blood flow rate.

The data before treatment was as follows:

| Rectal temperature: | 36.6° C. |
|---|---|
| Hypoglottis Temperature: | 37.03° C. |
| pH: | 7.344 |
| pCO₂: | 52.5 mmHg |
| pO₂: | 30 mmHg |
| Number of Leukocyte | 5100/μl |
| Number of erythrocyte | 447 × 10⁴/μl |
| Number of platelet: | 4.2 × 10⁴/μl |
| Number of Lymphocyte | 2509/μl |
| Number of Granulocyte | 2387/μl |
| Uric Acid Value: | 9.8 (mg/dl; Standard: not more than |
| | 7.0) |
| Blood Pressure | 158/76 (Marginal 140/85) |
| Benign Prostatic Hyperplasia: | Observed |
| SpO₂: | 96% |
| Hart Rate: | 54 |

(Arriving at 39° C.)

| | |
|---|---|
| Rectal temperature: | 39.00° C. |
| SpO₂: | 98% |
| Hart Rate: | 110 |

(Arriving at the Maximum Temperature (39.42° C.))

| | |
|---|---|
| Rectal temperature: | 39.42° C. |
| SpO₂: | 97% |
| Hart Rate: | 88 |

(After Bathing)

| | |
|---|---|
| Rectal temperature: | 39.35° C. |
| SpO₂: | 96% |
| Hart Rate: | 92 |

(After Treatment)

| | |
|---|---|
| Hypoglottis Temperature: | 36.7° C. |
| pH: | 7.551 |
| pCO₂: | 27.2 mmHg |
| pO₂: | 32 mmHg |
| Number of Leukocyte | 5100/μl |
| Number of erythrocyte | 498 × 10⁴/μl |
| Number of platelet: | 13 |
| Number of Lymphocyte | 2743/μl |
| Number of Granulocyte | 2859/μl |
| Blood Pressure | 135/66 |
| SpO₂: | 94% |
| Hart Rate: | 73 |

### (Standard Thermotherapy)

The thermotherapy was determined as follows:

Whole body bathing 20 minutes; half body bathing 40 minutes; temperature at the time of bating 42° C.

### (Therapeutic Method)

From the data given from the above standard thermotherapy the therapy described above was applied after permission of his own doctor. The thermotherapeutic treatment (whole body bathing 20 minutes; half body bathing 40 minutes; temperature at the time of bating 42° C.) were conducted at an interval of from 5 to 7 days.

### (Passage Information)

In each therapy, basic data and data for the disease (gout) were collected. The index of the gout is uric acid value.

### (After the Final Treatment)

| Rectal Temperature: | 39.09° C. |
|---|---|
| pH: | 7.535 |
| pCO₂: | 25.6 |
| pO₂: | 51 |
| Number of Leukocyte | 5800/μl |
| Number of erythrocyte | 447 × 10⁴/μl |
| Number of platelet: | 12.2 × 10⁴/μl |
| Lymphocyte Percentage | 51.7 |
| Granulocyte Percentage | 45.6 |
| Uric Acid Value | 9.8 |
| Blood Pressure | 160/68 |
| Benign Prostatic Hyperplasia: | Not Observed |
| SpO₂: | 94% |
| Hart Rate: | 68 |

### (Results)

Two months after the treatment, as for the hypertension substantially, in spite of stopping the drug administration, the value before treatment is not indicated, remaining unchanged. Consequently, the subjective substantially returned to the original state. The immunological parameters at this time also substantially returned to the original states.

Accordingly, correlation between the redox situation and hypertension was qualified.

Consequently, it has been clarified that thermotherapy conducted utilizing states of redox electric potential as an index induced the therapeutic effects at the fullest extent.

### Example 14

### Treatment of Patient Suffering from Ulcerative Colitis

In this example, Mr. N. T (male) suffering from ulcerative colitis was treated.

### (Situation Before Treatment)

According to doctor's diagnosis, the situations of this patient were as follows:

The patient was suffering from ulcerative colitis and osteoporosis and Bonalon®, calcium agent, vitamin agent were administrated.

### (Data Collection for Thermotherapy)

Under observation by a doctor, a standard thermotherapy was conducted (42° C., 27 minutes whole body bathing and 33 minutes half body bathing). In this case, the following data was collected:

Electric potential of oxidation-reduction (or pH) of blood

Gas analysis in blood, Biochemistry of hemocyte fractionation, disease marker, SpO₂, hart rate and blood flow rate.

The data before treatment was as follows:

| Rectal temperature: | 36.75° C. |
|---|---|
| Hypoglottis Temperature: | 36.56° C. |
| pH: | 7.336 |
| pCO₂: | 52.9 mmHg |
| pO₂: | 34.0 mmHg |
| Number of Leukocyte | 6400/μl |
| Number of erythrocyte | 494 × 10⁴/μl |
| Number of platelet: | 15.1 × 10⁴/μl |
| Number of Lymphocyte | 1472/μl |
| Number of Granulocyte | 4806.4/μl |
| Remark of ulcerative | colitis |
| SpO₂: | 100% |
| Hart Rate: | 64 |

(At the time of Bathing +1° C.)

| | |
|---|---|
| Rectal temperature: | 37.75° C. |
| pH: | 7.424 |
| pCO₂: | 40.0 mmHg |
| pO₂: | 74.0 mmHg |
| Number of Leukocyte | 6000/μl |
| Number of erythrocyte | 483 × 10⁴/μl |
| Number of platelet: | 16.0 × 10⁴/μl |
| Number of Lymphocyte | 1248/μl |
| Number of Granulocyte | 4644/μl |
| SpO₂: | 98% |
| Hart Rate: | 103 |

(Rectal Temperature of 39° C.)

| | |
|---|---|
| Rectal temperature: | 39.00° C. |
| pH: | 7.424 |
| pCO₂: | 40.6 mmHg |
| pO₂: | 108.0 mmHg |
| Number of Leukocyte | 6600/μl |
| Number of erythrocyte | 509 × 10⁴/μl |
| Number of platelet: | 17.0 × 10⁴/μl |
| Number of Lymphocyte | 1392.6/μl |
| Number of Granulocyte | 5088.6/μl |
| SpO₂: | 100% |
| Hart Rate: | 113 |

(Arriving at the Maximum Temperature)

| | |
|---|---|
| Rectal temperature: | 39.16° C. |
| SpO₂: | 98% |
| Hart Rate: | 126 |

(After Bathing)

| | |
|---|---|
| Rectal temperature: | 39.12° C. |
| SpO₂: | 99% |
| Hart Rate: | 107 |

(After Treatment)

| | |
|---|---|
| Rectal temperature: | 38.35° C. |
| Hypoglottis Temperature: | 37.48° C. |
| pH: | 7.383 |
| pCO₂: | 44.5 mmHg |
| pO₂: | 51.0 mmHg |
| Number of Leukocyte | 6000/μl |
| Number of erythrocyte | 499 × 10⁴/μl |
| Number of platelet: | 17.1 × 10⁴/μl |
| Lymphocyte Percentage | 20.1% |
| Number of Lymphocyte | 1206/μl |
| Granulocyte Percentage | 78.4% |
| Number of Granulocyte | 4704/μl |
| Hart Rate: | 85 |

### (Standard Thermotherapy)

The thermotherapy was determined as follows:

Whole bodybathing 27 minutes at 42° C.; half bodybathing 33 minutes.

### (Therapeutic Method)

From the data given from the above standard thermotherapy the therapy described above was applied after permission of his own doctor. The thermotherapeutic treatment (whole body bathing 27 minutes at 42° C.; half body bathing 33 minutes) were conducted for 5 weeks at an interval of from 5 to 7 days.

### (Passage Information)

In each therapy, basic data and data for the disease (Ulcerative Colitis) were collected.

(Passage after Treatment)

One Week After

| Rectal temperature: | 39.40° C. |
|---|---|
| Hypoglottis Temperature: | 38.89° C. |
| pH: | 7.376 |
| pCO₂: | 40.4 mmHg |
| pO₂: | 85.0 mmHg |
| Number of Leukocyte | 6100/μl |
| Number of erythrocyte | 497 × 10⁴/μl |
| Number of platelet: | 21.0 × 10⁴/μl |
| Number of Lymphocyte | 1549.4/μl |
| Number of Granulocyte | 4367.6/μl |
| SpO₂: | 97% |
| Hart Rate: | 109 |

(Two Weeks After)

| | |
|---|---|
| Rectal temperature: | 36.81° C. |
| Hypoglottis Temperature: | 36.56° C. |
| pH: | 7.336 |
| pCO₂: | 52.9 mmHg |
| pO₂: | 34.9 mmHg |
| Number of Leukocyte | 6400/μl |
| Number of erythrocyte | 494 × 10⁴/μl |
| Number of platelet: | 15.1 × 10⁴/μl |
| Number of Lymphocyte | 1472/μl |
| Number of Granulocyte | 4806/μl |
| SpO₂: | 100% |
| Hart Rate: | 78 |

(Six Weeks After)

| | |
|---|---|
| Rectal temperature: | 37.04° C. |
| Hypoglottis Temperature: | 36.24° C. |
| pH: | 7.344 |
| pCO₂: | 48.3 mmHg |
| pO₂: | 34.9 mmHg |
| Number of Leukocyte | 5900/μl |
| Number of erythrocyte | 482 × 10⁴/μl |
| Number of platelet: | 17.2 × 10⁴/μl |
| Number of Lymphocyte | 1558/μl |
| Number of Granulocyte | 4195/μl |
| SpO₂: | 100% |
| Hart Rate: | 87 |

### (Results)

Two months after the treatment, ulcerative colitis substantially disappeared, and the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 15

### Treatment of Patient Suffering from Chronic Rheumatoid Arthritis

In this example, the treatment of chronic rheumatoid arthritis was conducted.

### (Situation Before Treatment)

According to doctor's diagnosis, the patient was diagnosed to be chronic rheumatoid arthritis.

### (Data Collection for Thermotherapy)

Under observation by a doctor, a standard thermotherapy was conducted (42° C., 60 minutes). In this case, the following data was collected:

Electric potential of oxidation-reduction (or pH) of blood

Gas analysis in blood, Biochemistry of hemocyte fractionation, disease marker, SpO₂, hart rate and blood flow rate.

### (Standard Thermotherapy)

The thermotherapy was determined as follows:

42° C., 60 minutes.

### (Therapeutic Method)

From the data given from the above standard thermotherapy the therapy described above was applied after permission of his own doctor.

### (Passage Information)

In each therapy, basic data and data for the disease (chronic rheumatoid arthritis) were collected.

### (Results)

Two months after the treatment, chronic rheumatoid arthritis substantially disappeared, and the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 16

### Treatment of Patient Suffering from Chronic Granuloma

In this example, the treatment of chronic rheumatoid arthritis was conducted.

### (Situation Before Treatment)

According to doctor's diagnosis, the patient was diagnosed to be chronic granuloma.

### (Data Collection for Thermotherapy)

Under observation by a doctor, a standard thermotherapy was conducted (42° C., 60 minutes). In this case, the following data was collected:

Electric potential of oxidation-reduction (or pH) of blood

Gas analysis in blood, Biochemistry of hemocyte fractionation, disease marker, SpO2, hart rate and blood flow rate.

### (Standard Thermotherapy)

The thermotherapy was determined as follows:

42° C., 60 minutes.

### (Therapeutic Method)

From the data given from the above standard thermotherapy the therapy described above was applied after permission of his own doctor.

### (Passage Information)

In each therapy, basic data and data for the disease (chronic granuloma) were collected.

### (Results)

Two months after the treatment, chronic granuloma substantially disappeared, and the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 17

### Treatment of Patient Suffering from Inflamed Bowel Disease

In this example, the treatment of chronic rheumatoid arthritis was conducted.

### (Situation Before Treatment)

According to doctor's diagnosis, the patient was diagnosed to be inflamed bowel disease.

### (Data Collection for Thermotherapy)

Under observation by a doctor, a standard thermotherapy was conducted (42° C., 60 minutes). In this case, the following data was collected:

Electric potential of oxidation-reduction (or pH) of blood

Gas analysis in blood, Biochemistry of hemocyte fractionation, disease marker, SpO₂, hart rate and blood flow rate.

### (Standard Thermotherapy)

The thermotherapy was determined as follows:

42° C., 60 minutes.

### (Therapeutic Method)

From the data given from the above standard thermotherapy the therapy described above was applied after permission of his own doctor.

### (Passage Information)

In each therapy, basic data and data for the disease (inflamed bowel disease) were collected.

### (Results)

Two months after the treatment, inflamed bowel disease substantially disappeared, and the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 18

### Treatment of Patient Suffering from Neutropenia

In this example, the treatment of chronic rheumatoid arthritis was conducted.

### (Situation Before Treatment)

According to doctor's diagnosis, the patient was diagnosed to be neutropenia.

### (Data Collection for Thermotherapy)

Under observation by a doctor, a standard thermotherapy was conducted (42° C., 60 minutes). In this case, the following data was collected:

Electric potential of oxidation-reduction (or pH) of blood

Gas analysis in blood, Biochemistry of hemocyte fractionation, disease marker, SpO₂, hart rate and blood flow rate.

### (Standard Thermotherapy)

The thermotherapy was determined as follows:

42° C., 60 minutes.

### (Therapeutic Method)

From the data given from the above standard thermotherapy the therapy described above was applied after permission of his own doctor.

### (Passage Information)

In each therapy, basic data and data for the disease (neutropenia) were collected.

### (Results)

Two months after the treatment, neutropenia substantially disappeared, and the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 19

### Treatment of Patient Suffering from Neutrophilia

In this example, the treatment of chronic rheumatoid arthritis was conducted.

### (Situation Before Treatment)

According to doctor's diagnosis, the patient was diagnosed to be neutrophilia.

### (Data Collection for Thermotherapy)

Under observation by a doctor, a standard thermotherapy was conducted (42° C., 60 minutes). In this case, the following data was collected:

Electric potential of oxidation-reduction (or pH) of blood

Gas analysis in blood, Biochemistry of hemocyte fractionation, disease marker, SpO₂, hart rate and blood flow rate.

### (Standard Thermotherapy)

The thermotherapy was determined as follows:

42° C., 60 minutes.

### (Therapeutic Method)

From the data given from the above standard thermotherapy the therapy described above was applied after permission of his own doctor.

### (Passage Information)

In each therapy, basic data and data for the disease (neutrophilia) were collected.

### (Results)

Two months after the treatment, neutrophilia substantially disappeared, and the subjective substantially returned to the original state. The immunological parameters at this time also substantially returned to the original states.

Consequently, it has been clarified that thermotherapy conducted utilizing states of redox electric potential as an index induced the therapeutic effects at the fullest extent.

### Example 20

### Summary of Correlation of Redox Electric Potential

Summarizing the results thus obtained, it has been clarified that pH value of 7.35 is corresponding to electric potential of the living body (redox electric potential) of approximately −75 mV. In the actual therapy, the conditions where variation exceeding +−0.05 which is usual pH variation range (increasing) are discovered, and therapy is carried out under such conditions, obtaining good therapeutic effects. Variation in the pH value is not less than 0.1 and in the most cases; it is within from 0.1 to 0.3. In some cases, the pH value varies 0.5. In this case, the immune situations are drastically improved.

### Example 21

### Determination of Therapeutic Temperature With hsp 72 as Index

Peripheral blood (5 ml) was collected from a patient. By Lymphoprep (Nycomed Pharma As, Oslo, Norway), peripheral mononuclear leukocyte was separated from the peripheral blood. Approximately 1×10⁶ of peripheral mononuclear leukocyte was dissolved in a solution buffer (containing Funakoshi, hsp 70 ELISA kit). The solution was slowly warmed from 37° C. An aliquot was taken from the solution at every 0.5° C. From the aliquot of the solution was extracted a protein by Funakoshi, hsp 70 ELISA kit, and an expression amount of hsp 72 was quantitatively determined by ELISA kit (Stressgen Biotechnology, Sydney, Canada). The temperature where the expression amount of hsp 72 is converted from increasing into decreasing was determined to be the therapeutic temperature of the patient. Specifically, the expression amount was the maximum at this therapeutic temperature.

The expression amount of hsp 72 was parallel to the redox electric potential of the living body or pH value.

### Example 22

### Determination of Therapeutic Temperature With HLA-Dr as Index

Peripheral blood (5 ml) was collected from a patient. By Lymphoprep (Nycomed Pharma As, Oslo, Norway), peripheral mononuclear leukocyte was separated from the peripheral blood. Approximately 1×10⁶ of peripheral mononuclear leukocyte was doubly stained with antigen against CD4, CD6, CD 16, CD 56 or CD 57, and with anti-HLA antibody, and then an expression amount of HLA-DR was quantitatively determined with FACS analysis for each cell population. The temperature where the expression amount of HLA-DR is converted from increasing into decreasing, when the peripheral blood of the patient was heated, was determined to be the therapeutic temperature of the patient. Specifically, the expression amount was the maximum at this therapeutic temperature.

The expression amount of HLA-DR was parallel to the redox electric potential of the living body or pH value.

### Example 23

### Thermotherapy of Non-Hodgkin Malignant Lymphoma Utilizing Thermotherapeutic Apparatus According to the Present Invention

As described in Example 21 or Example 22, the therapeutic temperature was decided for a patient suffering from Non-Hodgkin malignant lymphoma, and the patient was heated to the decided temperature, and was kept at this temperature for a constant period. At this time, as a result of a therapeutic effects, an IPA value which is a tumor marker for a malignant lymphoma, of the patient was decreased to 242 μg/ml (normal value: not more than 500 μg/ml), CA19-9 value was decreased from 179.3 U/ml to 23 U/ml (normal value: not more than 37.0 U/ml), and CA125 value was decreased from 25.9 U/ml to 9.1 U/ml (normal value: not more than 35.0 U/ml).

The therapy at this time was adapted to the therapy based on the redox electric potential or pH of the living body.

### Example 24

### Thermotherapy of Bladder Cancer Utilizing Thermotherapeutic Apparatus According to the Present Invention

As described in Example 21 or Example 22, the therapeutic temperature was decided for a patient suffering from bladder cancer, and the patient was heated to the decided temperature, and was kept at this temperature for a constant period. As a result of the thermotherapy, all of the tumors of the bladder were confirmed to didapper through an endoscope. As a result of the thermotherapy, IAP value of the patient was decreased from 397 μl/ml to 217 μl/ml (normal value: not more than 500 μl/ml). This patient exhibited a high SIL2-R value, which was reported to be increased in a solid cancer and lymphoma, (850 U/ml) but by the treatment, the value was decreased and normalized to be 617 U/ml (normal value: 190 U/ml to 650 U/ml).

The therapy at this time was adapted to the therapy based on the redox electric potential or pH of the living body.

### Example 25

### Thermotherapy of Atopic dermatitis Utilizing Thermotherapeutic Apparatus According to the Present Invention

As described in Example 21 or Example 22, the therapeutic temperature was decided for a patient suffering from atopic dermatitis, and the patient was heated to the decided temperature, and was kept at this temperature for a constant period. As a result of the thermotherapy, the symptom of the atopic dermatitis was improved.

The therapy at this time was adapted to the therapy based on the redox electric potential or pH of the living body.

### Example 26

### Thermotherapy of Oral Cavity Fundus Cancer Utilizing Thermotherapeutic Apparatus According to the Present Invention

As described in Example 21 or Example 22, the therapeutic temperature was decided for a patient suffering from oral cavity fundus cancer, and the patient was heated to the decided temperature, and was kept at this temperature for a constant period. In this patient, the facilitation of IL2 productivity activating T cell (normal value: 92 pg/ml to 1574 pg/ml) was observed. Specifically, 691 pg/ml of IL2 productivity at the time of starting the therapy was enhanced to 2678 pg/ml after 4 days, 2126 pg/ml after 6 days, and 2185 pg/ml after 8 days, meaning that the cellar immune was activated.

The therapy at this time was adapted to the therapy based on the redox electric potential or pH of the living body.

### Example 27

### Thermotherapy of Ovarian Cancer Utilizing Thermotherapeutic Apparatus According to the Present Invention

As described in Example 21 or Example 22, the therapeutic temperature was decided for a patient suffering from ovarian cancer, and the patient was heated to the decided temperature, and was kept at this temperature for a constant period. In this patient, a value of CA125, which is a tumor marker for ovarian cancer, was decreased from 400 U/ml to 186 U/ml (Standard value: 35 U/ml)

The therapy at this time was adapted to the therapy based on the redox electric potential or pH of the living body.

### Example 28

### Thermotherapy of Patient Infected with hepatitis B (HBV) Utilizing Thermotherapeutic Apparatus According to the Present Invention

As described in Example 21 or Example 22, the therapeutic temperature was decided for a patient infected with HBV, and the patient was heated to the decided temperature, and was kept at this temperature for a constant period. In this patient, an amount of HBV DNA detected by using a DNA probe for HBV infection was decreased. The change indicated the existence of HBV.

The therapy at this time was adapted to the therapy based on the redox electric potential or pH of the living body.

### Example 29

### Thermotherapy of Uterine Cervix Utilizing Thermotherapeutic Apparatus According to the Present Invention

As described in Example 21 or Example 22, the therapeutic temperature was decided for a patient suffering from uterine cervix cancer, and the patient was heated to the decided temperature, and was kept at this temperature for a constant period. In this patient, as a result of thermotherapy, a value of a tumor marker for uterine cervix cancer was decreased.

The therapy at this time was adapted to the therapy based on the redox electric potential or pH of the living body.

### Example 30

### Thermotherapy of Infection Utilizing Thermotherapeutic Apparatus According to the Present Invention

As described in Example 21 or Example 22, the therapeutic temperature was decided for a patient suffering from an infection, and the patient was heated to the decided temperature, and was kept at this temperature for a constant period. In this patient, as a result of thermotherapy, the infection was improved or cured. This indicted that immunity is activity.

The therapy at this time was adapted to the therapy based on the redox electric potential or pH of the living body.

### Example 31

### Thermotherapy of Chronic Disease Utilizing Thermotherapeutic Apparatus According to the Present Invention

As described in Example 21 or Example 22, the therapeutic temperature was decided for a patient suffering from a chronic disease, and the patient was heated to the decided temperature, and was kept at this temperature for a constant period. In this patient, as a result of thermotherapy, the chronic disease was improved or cured.

The therapy at this time was adapted to the therapy based on the redox electric potential or pH of the living body.

### Example 32

### Thermotherapy of Lifestyle-Related Disease Utilizing Thermotherapeutic Apparatus According to the Present Invention

As described in Example 21 or Example 22, the therapeutic temperature was decided for a patient suffering from a lifestyle-related disease (gout and hypertension), and the patient was heated to the decided temperature, and was kept at this temperature for a constant period. In this patient, as a result of thermotherapy, the lifestyle-related disease was improved or cured.

The therapy at this time was adapted to the therapy based on the redox electric potential or pH of the living body.

### Example 33

### Thermotherapy of Vermination Utilizing Thermotherapeutic Apparatus According to the Present Invention

As described in Example 21 or Example 22, the therapeutic temperature was decided for a patient suffering from a vermination, and the patient was heated to the decided temperature, and was kept at this temperature for a constant period. In this patient, as a result of thermotherapy, the vermination was improved or cured.

The therapy at this time was adapted to the therapy based on the redox electric potential or pH of the living body.

### Example 34

### Thermotherapy for Facilitating Immunity Utilizing Thermotherapeutic Apparatus According to the Present Invention

As described in Example 21 or Example 22, the therapeutic temperature was decided for a patient required for facilitating immunity, and the patient was heated to the decided temperature, and was kept at this temperature for a constant period. In this patient, as a result of thermotherapy, the immunity was facilitated.

The therapy at this time was adapted to the therapy based on the redox electric potential or pH of the living body.

### Example 35

### Thermotherapy of Immune Deficiency Utilizing Thermotherapeutic Apparatus According to the Present Invention

As described in Example 21 or Example 22, the therapeutic temperature was decided for a patient suffering from an immune deficiency (HIV), and the patient was heated to the decided temperature, and was kept at this temperature for a constant period. In this patient, as a result of thermotherapy, the immune deficiency was improved or cured.

The therapy at this time was adapted to the therapy based on the redox electric potential or pH of the living body.

### Example 36

### Thermotherapy of Drug Poisoning Utilizing Thermotherapeutic Apparatus According to the Present Invention

As described in Example 21 or Example 22, the therapeutic temperature was decided for a patient suffering from a drug poisoning, and the patient was heated to the decided temperature, and was kept at this temperature for a constant period. In this patient, as a result of thermotherapy, the drug poisoning was improved or cured.

The therapy at this time was adapted to the therapy based on the redox electric potential or pH of the living body.

### Example 37

### Thermotherapy of Disease Curable by Improvement of Immune System Utilizing Thermotherapeutic Apparatus According to the Present Invention

As described in Example 21 or Example 22, the therapeutic temperature was decided for a patient suffering from a disease curable by improvement of immune system, and the patient was heated to the decided temperature, and was kept at this temperature for a constant period. In this patient, as a result of thermotherapy, the disease curable by improvement of immune system was improved or cured.

The therapy at this time was adapted to the therapy based on the redox electric potential or pH of the living body.

### Example 38

### Thermotherapy of Patient infected with hepatitis C (HCV) Utilizing Thermotherapeutic Apparatus According to the Present Invention

As described in Example 21 or Example 22, the therapeutic temperature was decided for a patient infected with HCV, and the patient was heated to the decided temperature, and was kept at this temperature for a constant period. In this patient, an amount of HCV DNA detected by using a DNA probe for HCV infection was decreased. The change indicated the existence of HCV.

The therapy at this time was adapted to the therapy based on the redox electric potential or pH of the living body.

While preferred embodiments of the present invention have been described, the present invention is not restricted thereto. It should be understood that the scope of the present invention is interoperated by Claims. It should been understood by the artisan that equivalent can be put into practical use based on the description of the specific preferred embodiments of the present invention based on the description and the technical commonsense. It also should be understood that part or whole of the references such as scientific papers, patents, patent applications cited herein may be incorporated herein in such an extent that they are specifically described.

### INDUSTRIAL APPLICABILITY

According to the present invention, any of disease can be treated. The methods, apparatuses, production of the system, and application for attaining the therapy are of industrial applicability.

1. A method for regulating a parameter for treating or preventing a situation of a disease or disorder of a patient comprising:
(A) a step for measuring a redox potential of the patient; and
(B) a step for deciding parameters of the thermotherapy suitable for the patient.

2. The method according to claim 1, wherein said thermotherapy include immersing the patient in a warm water bath.

3. The method according to claim 1, wherein said redox electric potential is determined by measuring the redox electric potential or a pH value of a peripheral blood.

4. The method according to claim 1, wherein said body temperature is observed by a rectal temperature.

5. The method according to claim 1, wherein said parameters of the thermotherapy are decided considering at least one factor selected from gas analysis, hemocyte fractionation biochemistry, disease marker, SpO₂, hart rate, and a blood flow rate.

6. The method according to claim 1, wherein said parameters of the thermotherapy include a heating temperature and a heating period.

7. The method according to claim 1, which further comprises: a step for obtaining the Redox electric potential and further controlling the control of the body temperature.

8. The method according to claim 7, wherein said further controlling step is carried out at least one point in time when the body temperature of the patient is increased to 0.1° C., arrives at 39° C., and arrives at the maximum temperature.

9. The method according to claim 7, wherein said further controlling step is carried out at all points in time when the body temperature of the patient is increased to 0.1° C., arrives at 39° C., and arrives at the maximum temperature.

10. The method according to claim 7, wherein said further controlling step is carried out considering at least one factor selected from gas analysis, hemocyte fractionation biochemistry, disease marker, SpO₂, hart rate, and a blood flow rate.

11. The method according to claim 1, which further comprises a step for further measuring the Redox electric potential after controlling of the body temperature of the patient.

12. The method according to claim 11, wherein said further controlling is carried out by considering at one factor selected from gas analysis, hemocyte fractionation biochemistry, disease marker, SpO₂, hart rate, and a blood flow rate.

13. The method according to claim 1, wherein the decision of the parameters is carried out based on the treatment of the patient within a warm bath at a temperature 3 to 5° C. higher than the rectal temperature.

14. The method according to claim 1, wherein a parameter for the disease, if present, is considered.

15. The method according to claim 1, wherein the redox electric potential is decided by the measurement of the redox electric potential from the blood of the patient.

16. The method according to claim 1, wherein said disease includes a disease related to symptoms of immune.

17. The method according to claim 1, wherein said disease is selected from the group consisting of cancers, virus-infected diseases, metabolic diseases, circulatory organ system diseases, alimentary system, inflammatory diseases, central nerve system disease, immunological diseases, infections, and lifestyle related diseases.

18. The method according to claim 17, wherein said virus-infected disease is selected from the group consisting of hepatitis B, hepatitis Candy acquired immune deficiency (AIDS).

19. The method according to claim 17, wherein said metabolic disease is selected from the group consisting of diabetes mellitus, complication of diabetes mellitus, benign prostatic hyperplasia, gout and hepatitis.

20. The method according to claim 17, wherein said immunological disease is selected from the group consisting of autoimmune disease, and acquired immune deficiency syndrome.

21. The method according to claim 17, wherein said cancer is selected from the group consisting of malignant lymphoma, pancreas cancer, uterine cervix cancer, oral cavity fundus cancer, and kidney cancer.

22. The method according to claim 17, wherein said circulatory organ system disease includes hypertension.

23. The method according to claim 17, wherein said circulatory organ system disease includes ulcerative colitis.

24. The method according to claim 17, wherein said immunological disease is selected from the group consisting of immune deficiency (e.g., AIDS), malignant lymphoma, chronic rheumatoid arthritis, chronic granulomatosis, inflammatory enteropathy, and neutropenia.

25. The method according to claim 17, wherein said disease is accompanied by decreasing of the number of the lymphocytes.

26. A method for treating or preventing a diseases or disorder of a patient, which comprises;
a step for applying the patient to the thermotherapy based on the parameters decided according to claim 1.

27. The method according to claim 26, which further comprises:
a step for measuring the redox electric potential of the patient, and then modifying the parameter based on the measured redox electric potential.

28. The method according to claim 26, wherein the thermotherapy is continued until the redox electric potential is recovered.

29. The method according to claim 26, wherein the thermotherapy is continued until the pH value of the patient becomes at least 0.05 higher than that before the treatment.

30. The method according to claim 26, wherein the thermotherapy is continued until the pH value of the patient becomes at least 0.1 higher than that before the treatment.

31. The method according to claim 26, wherein the thermotherapy is continued until the redox electric potential of the patient becomes at least 5 MV at an absolute value higher than the pH value before the treatment.

32. The method according to claim 26, wherein the thermotherapy is continued until the redox electric potential of the patient becomes between −75 mV and −80 mV.

33. The method according to claim 26, including:
increasing the rectal temperature of the patient to at least 39° C.

34. The method according to claim 26, wherein the thermotherapy is carried out by maintaining the rectal temperature of the patient to at least 39° C. for at least 10 minutes.

35. The method according to claim 26, wherein the temperature difference between the rectal temperature before the treatment and the temperature of the warming bath is within 0.5° C.

36. A system for controlling parameters for thermotherapy for treating or preventing a diseases or disorder of a patient, which comprises;
A) means for measuring redox electric potential of the patient; and
B) means for determining parameters for thermotherapy suitable for the patient based on the redox electric potential.

37. The system according to claim 36, wherein said thermotherapy comprises immersing the patient in a warm bath.

38. The system according to claim 36, wherein redox electric potential is conducted by measuring the redox electric potential or a pH value of a peripheral blood.

39. The system according to claim 36, wherein said body temperature is observed by a rectal temperature.

40. The system according to claim 36, wherein said parameters of the thermotherapy are decided considering at least one factor selected from gas analysis, hemocyte fractionation biochemistry, disease marker, SpO₂, hart rate, and a blood flow rate.

41. The system according to claim 36, wherein said parameters of the thermotherapy include a heating temperature and a heating period.

42. The system according to claim 36, which further comprises: means for obtaining the Redox electric potential and further controlling the control of the body temperature.

43. The system according to claim 42, wherein said further controlling means is carried out at least one point in time when the body temperature of the patient is increased to 0.1° C., arrives at 39° C., and arrives at the maximum temperature.

44. The system according to claim 42, wherein said further controlling means is carried out at all points in time when the body temperature of the patient is increased to 0.1° C., arrives at 39° C., and arrives at the maximum temperature.

45. The system according to claim 42, wherein said further controlling is carried out considering at least one factor selected from gas analysis, hemocyte fractionation biochemistry, disease marker, SpO₂, hart rate, and a blood flow rate.

46. The system according to claim 36, which further comprises a step for further measuring the Redox electric potential after controlling of the body temperature of the patient.

47. The system according to claim 46, wherein said further controlling is carried out by considering at one factor selected from gas analysis, hemocyte fractionation biochemistry, disease marker, SpO₂, hart rate, and a blood flow rate.

48. The system according to claim 36, wherein the decision of the parameters is carried out based on the treatment of the patient within a warm bath at a temperature 3 to 5° C. higher than the rectal temperature.

49. The system according to claim 36, wherein a parameter for the disease, if present, is considered.

50. The system according to claim 36, wherein the redox electric potential is decided by the measurement of the redox electric potential from the blood of the patient.

51. The system according to claim 36, wherein said disease includes a disease related to symptoms of immune.

52. The system according to claim 36, wherein said disease is selected from the group consisting of cancers, virus-infected diseases, metabolic diseases, circulatory organ system diseases, alimentary system, inflammatory diseases, central nerve system disease, immunological diseases, infections, and lifestyle related diseases.

53. The system according to claim 52, wherein said virus-infected disease is selected from the group consisting of hepatitis B, hepatitis C, and acquired immune deficiency (AIDS).

54. The system according to claim 52, wherein said metabolic disease is selected from the group consisting of diabetes mellitus, complication of diabetes mellitus, benign prostatic hyperplasia, gout and hepatitis.

55. The system according to claim 52, wherein said immunological disease is selected from the group consisting of autoimmune disease, and acquired immune deficiency syndrome.

56. The system according to claim 52, wherein said cancer is selected from the group consisting of malignant lymphoma, pancreas cancer, uterine cervix cancer, oral cavity fundus cancer, and kidney cancer.

57. The system according to claim 52, wherein said circulatory organ system disease includes hypertension.

58. The system according to claim 52, wherein said circulatory organ system disease includes ulcerative colitis.

59. The system according to claim 52, wherein said immunological disease is selected from the group consisting of immune deficiency (e.g., AIDS), malignant lymphoma, chronic rheumatoid arthritis, chronic granulomatosis, inflammatory enteropathy, and neutropenia.

60. The system according to claim 52, wherein said disease is accompanied by decreasing of the number of the lymphocytes.

61. A system for treating or preventing a diseases or disorder of a patient, which comprises;
A) means for measuring redox electric potential of the patient;
B) means for determining parameters for thermotherapy suitable for the patient based on the redox electric potential; and
C) means for applying the patient to the thermotherapy based on the parameters.

62. The system according to claim 61, which further comprises:
means for measuring the redox electric potential of the patient, and then modifying the parameter based on the measured redox electric potential.

63. The system according to claim 61, wherein the thermotherapy is continued until the redox electric potential is recovered.

64. The system according to claim 61, wherein the thermotherapy is continued until the pH value of the patient becomes at least 0.05 higher than that before the treatment.

65. The system according to claim 61, wherein the thermotherapy is continued until the pH value of the patient becomes at least 0.1 higher than that before the treatment.

66. The system according to claim 61, wherein the thermotherapy is continued until the redox electric potential of the patient becomes at least 5 MV at an absolute value higher than the pH value before the treatment.

67. The system according to claim 61, wherein the thermotherapy is continued until the redox electric potential of the patient becomes between −75 mV and −80 mV.

68. The system according to claim 61, including:
increasing the rectal temperature of the patient to at least 39° C.

69. The system according to claim 61, wherein the thermotherapy is carried out by maintaining the rectal temperature of the patient to at least 39° C. for at least 10 minutes.

70. The system according to claim 61, wherein the temperature difference between the rectal temperature before the treatment and the temperature of the warming bath is within 0.5° C.

71. A system for treating or preventing a diseases or disorder of a patient, which comprises;
A) means for specifying a therapeutic temperature for exhibiting the thermo therapeutic effect against the patient based on a Redox electric potential or pH value of the patient;
B) thermo therapeutic means;
C) temperature detecting means for detecting the body temperature of the patient; and
D) a control device which calculates a command to direct to control the body temperature of the patient from the temperature information to said thermo therapeutic means from the temperature information based on the body temperature information from the temperature detecting means,
wherein said control device is connected to said means for specifying a therapeutic temperature so as to receive information for the body temperature and information for the therapeutic temperature, respectively, and calculates orders to the thermotherapeutic means.

72. The system according to claim 71, wherein said means (A) for specifying a therapeutic temperature specifies the therapeutic temperature further based on the change in the living body selected from the group consisting of:
a) an amount and a function of hsp 72 in the blood of the patient;
b) a change in blood pressure pg the patient;
c) a hart rate of the patient;
d) a blood flow of the patient;
e) a pH of the blood of the patient;
f) an amount of expressing HLA in the blood of the patient; and
g) a number of lymphocytes in the blood of the patient.

73. The system according to claim 71, wherein said means (A) for specifying a therapeutic temperature specifies the therapeutic temperature utilizing as an index hsp 72 or HLA varied by varying the temperature of the peripheral blood collected from the patient in vitro.

74. The system according to claim 71, wherein said thermo therapeutic means has a heating tank.

75. The system according to claim 71, wherein said thermo therapeutic means heat the temperature through a liquid.

76. The system according to claim 71, wherein said thermo therapeutic means has a safety device so that the temperature is not increasing to be a prescribed level.

77. The system according to claim 71, wherein said thermo therapeutic means comprises a bathing apparatus.

78. The system according to claim 71, wherein said thermo therapeutic means has a temperature maintaining device.

79. The system according to claim 71, wherein said thermo therapeutic means has a warm water supply device or a heating device, temperature controlling means, and cooling means.

80. The system according to claim 71, wherein said temperature detecting means is a clinical thermometer for measuring a body temperature selected from the group consisting of an axillary thermometer, a sublingual thermometer, a rectal thermometer, a deep subcutaneous thermometer, a drum membrane thermometer, and an esophagus thermometer.

81. The system according to claim 80, wherein said temperature detecting means is a sublingual thermometer, or a rectal thermometer.

82. The system according to claim 71, which further comprises means for storing a normal temperature of the patient.

83. The system according to claim 71, which further comprises means for recording a body temperature of the patient.

84. The system according to claim 71, further comprises:
two temperature control means of first temperature control means and second temperature control means having a specific heat or a performance for varying the temperature lower than that of the first temperature means; and
wherein said control device orders to actuate the first temperature control means when the subjective to be thermally controlled has a temperature deviating from a prescribed range, and orders so that the first temperature control means is stopped and the second temperature control means is actuated when the subjective to be thermally controlled has a temperature within the prescribed range; or
wherein said control device orders so that the first temperature control means is actuated and the second temperature control means is placed so as to be thermally insulated from the subject when the subjective to be thermally controlled has a temperature deviating from a prescribed range, and the first temperature control means is stopped and is placed so as to be thermally insulated from the subject and the second is actuated when the subjective to be thermally controlled has a temperature within the prescribed range.

85. The system according to claim 71, wherein said control device calculates an order that the thermo therapeutic means is heated to a temperature lower than the temperature 5° C. higher than the body temperature.

86. The system according to claim 71, wherein said control device calculates an order that temperature is maintained at a temperature lower than the temperature 5° C. higher than the body temperature.

87. The system according to claim 71, wherein said control device calculates an order that the thermo therapeutic means is heated until the measured body temperature becomes the therapeutic temperature.

88. The system according to claim 71, wherein said disease or disorder is selected from the group consisting of cancers, infections, chronic diseases, lifestyle related diseases, paracite related disease, immune facilitation, immune dificiency, and drug poisoning.

89. The system according to claim 71, wherein said disease or disorder includes a disorder curable by an immune system.

90. The system according to claim 71, wherein said disease or disorder includes a cancer.

91. A system for regulating a body temperature of a patient, which comprises;
A) means for specifying a therapeutic temperature for exhibiting the thermo therapeutic effect against the patient based on a Redox electric potential or pH value of the patient;
B) thermo therapeutic means;
C) temperature detecting means for detecting the body temperature of the patient; and
D) a control device which calculates a command to direct to control the body temperature of the patient from the temperature information to said thermo therapeutic means from the temperature information based on the body temperature information from the temperature detecting means,
wherein said control device is connected to said means for specifying a therapeutic temperature so as to receive information for the body temperature and information for the therapeutic temperature, respectively, and calculates orders to the thermotherapeutic means.

92. A system for regulating an expression and function of hsp 72 of a patient, which comprises;
A) means for specifying a therapeutic temperature for regulating an expression and function of hsp 72 of the patient based on a Redox electric potential or pH value of the patient;
B) thermo therapeutic means;
C) temperature detecting means for detecting the body temperature of the patient; and
D) a control device which calculates a command to direct to control the body temperature of the patient from the temperature information to said thermo therapeutic means from the temperature information based on the body temperature information from the temperature detecting means,
wherein said control device is connected to said means for specifying a therapeutic temperature so as to receive information for the body temperature and information for the therapeutic temperature, respectively, and calculates orders to the thermotherapeutic means.

93. The system according to claim 92, which activates immune system by the regulation of expression and function of hsp 72.

94. A system for regulating an expression and function of HLA of a patient, which comprises;
A) means for specifying a therapeutic temperature for regulating an expression and function of HLA of the patient based on a Redox electric potential or pH value of the patient;
B) thermo therapeutic means;
C) temperature detecting means for detecting the body temperature of the patient; and
D) a control device which calculates a command to direct to control the body temperature of the patient from the temperature information to said thermo therapeutic means from the temperature information based on the body temperature information from the temperature detecting means,
wherein said control device is connected to said means for specifying a therapeutic temperature so as to receive information for the body temperature and information for the therapeutic temperature, respectively, and calculates orders to the thermotherapeutic means.

95. The system according to claim 94, which activates immune system by the regulation of expression and function of HLA.

96. A system for treating or preventing a diseases or disorder of a patient, which comprises;
A) thermo therapeutic means;
B) means for acquiring a sample from the patient;
C) means for measuring a heat schlock protein (hsp) within said sample; and
D) means for regulating the thermo therapeutic means based on an expression pattern of hsp.

97. The system according to claim 96, wherein the expression pattern of hsp includes an expression pattern of hsp 72.

98. The system according to claim 96, wherein the regulation includes an expression of hsp.

99. A system for treating or preventing a diseases or disorder of a patient, which comprises;
A) thermo therapeutic means;
B) means for acquiring a sample from the patient;
C) means for measuring HLA within said sample; and
D) means for regulating the thermo therapeutic means based on an expression pattern of HLA.

100. The system according to claim 99, wherein the expression pattern of HLA includes an expression pattern of HLA-DR.

101. The system according to claim 99, wherein the regulation includes such a regulation as to enhance an expression of HLA.

102. A method for treating or preventing a diseases or disorder of a patient, which comprises;
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature.

103. The method according to claim 102, wherein said information of normal body temperature of the patient is obtained by temperature detecting means.

104. The method according to claim 102, which further comprises: D) a step for specifying a therapeutic temperature for exhibiting the thermo therapeutic effect against the patient based on a Redox electric potential or pH value of the patient at the maximum.

105. The method according to claim 104, wherein the body temperature of the patient is increased to and maintained at a temperature of the therapeutic temperature specified in step D) plus minus 1.0° C.

106. The method according to claim 104, wherein the body temperature of the patient is increased to and maintained at a temperature of the therapeutic temperature specified in step D) plus minus 0.3° C.

107. The method according to claim 104, wherein said step D) is based on the change in the living body selected from the group consisting of:
a) an amount and a function of hsp 72 in the blood of the patient;
b) a change in blood pressure pg the patient;
c) a hart rate of the patient;
d) a blood flow of the patient;
e) a pH of the blood of the patient;
f) an amount of expressing HLA in the blood of the patient; and
g) a number of lymphocytes in the blood of the patient.

108. The method to claim 104, wherein the step D) is carried out by utilizing as index hsp 72 or HLA varied by varying the temperature of the peripheral blood collected from the patient in vitro.

109. The method according to claim 102, wherein said disease or disorder is selected from the group consisting of cancers, infections, chronic diseases, lifestyle related diseases, paracite related disease, immune facilitation, immune dificiency, and drug poisoning.

110. The method according to claim 102, wherein said disease or disorder includes a disorder curable by an immune system.

111. The method according to claim 102, wherein said disease or disorder includes a cancer.

112. A program for executing a method for treating or preventing a diseases or disorder of a patient, said method comprising;
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature.

113. The program according to claim 112, wherein said method further comprises: D) a step for specifying a therapeutic temperature for exhibiting the thermo therapeutic effect against the patient based on a Redox electric potential or pH value of the patient at the maximum.

114. The program according to claim 112, which calculates an order that the thermo therapeutic means is heated to a temperature lower than the temperature 5° C. higher than the body temperature.

115. The program according to claim 112, which calculates an order that temperature is maintained at a temperature lower than the temperature 5° C. higher than the body temperature.

116. The program according to claim 112, which calculates an order that the thermo therapeutic means is heated until the measured body temperature becomes the therapeutic temperature.

117. A method for regulating an expression and function of hsp 72 in the patient, which comprises:
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature.

118. The method according to claim 117, which further comprises: D) a step for specifying a therapeutic temperature for expressing hsp 72 of the patient based on a Redox electric potential or pH value of the patient at the maximum.

119. The method according to claim 117, wherein said information of normal body temperature of the patient is obtained by temperature detecting means.

120. The method according to claim 118, wherein the body temperature of the patient is increased to and maintained at a temperature of the therapeutic temperature specified in step D) plus minus 1.0° C.

121. The method according to claim 118, wherein the body temperature of the patient is increased to and maintained at a temperature of the therapeutic temperature specified in step D) plus minus 0.3° C.

122. The method according to claim 118, wherein said step D) is based on the change in the living body selected from the group consisting of:
a) an amount and a function of hsp 72 in the blood of the patient;
b) a change in blood pressure pg the patient;
c) a hart rate of the patient;
d) a blood flow of the patient;
e) a pH of the blood of the patient;
f) an amount of expressing HLA in the blood of the patient; and
g) a number of lymphocytes in the blood of the patient.

123. The method to claim 118, wherein the step D) is carried out by utilizing as index hsp 72 or HLA varied by varying the temperature of the peripheral blood collected from the patient in vitro.

124. The method to claim 117, which regulates an expression and function of hsp 72 without modification, necrosis or destroy of granulocytes.

125. A program for executing a method for regulating an expression and function of hsp 72 in the patient, said method comprising:
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature.

126. The program according to claim 125, wherein said method further comprises: D) a step for specifying a therapeutic temperature for expressing hsp 72 of the patient based on a Redox electric potential or pH value of the patient at the maximum.

127. A method for using a thermo therapy for treating or preventing a diseases or disorder of a patient, which comprises:
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature, over a period until an expression of hsp 72 is varied.

128. The method according to claim 127, which further comprises; D) a step for specifying a therapeutic temperature for exhibiting the thermo therapeutic effect against the patient based on a Redox electric potential or pH value of the patient at the maximum.

129. The method to claim 127, which regulates an expression and function of hsp 72 without modification, necrosis or destroy of granulocytes.

130. A program for executing a thermo therapeutic method for treating or preventing a diseases or disorder of a patient, said method comprising:
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature, over a period until an expression of hsp 72 is varied.

131. The program according to claim 130, wherein said method further comprises; D) a step for specifying a therapeutic temperature for exhibiting the thermo therapeutic effect against the patient based on a Redox electric potential or pH value of the patient at the maximum.

132. A method for increasing an expression of HLA in a patient, which comprises:
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature.

133. The method according to claim 132, which further comprises: D) a step for specifying a therapeutic temperature for expressing HLA of the patient based on a Redox electric potential or pH value of the patient at the maximum.

134. The method according to claim 132, wherein said information of normal body temperature of the patient is obtained by temperature detecting means.

135. The method according to claim 132, wherein the body temperature of the patient is increased to and maintained at a temperature of the therapeutic temperature specified in step D) plus minus 1.0° C.

136. The method according to claim 132, wherein the body temperature of the patient is increased to and maintained at a temperature of the therapeutic temperature specified in step D) plus minus 0.3° C.

137. The method to claim 132, which regulates an expression of HLA without modification, necrosis or destroy of granulocytes.

138. A program for executing a method for increasing an expression of HLA in a patient, said method comprising comprises:
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature.

139. The program according to claim 138, wherein said method further comprises: D) a step for specifying a therapeutic temperature for expressing HLA of the patient based on a Redox electric potential or pH value of the patient at the maximum.

140. A method for using a thermo therapy for treating or preventing a diseases or disorder of a patient, which comprises:
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature, over a period until an expression of HLA is confirmed to be increased.

141. The method according to claim 140, which further comprises; D) a step for specifying a therapeutic temperature for exhibiting the thermo therapeutic effect against the patient based on a Redox electric potential or pH value of the patient at the maximum.

142. The method to claim 140, wherein said constant period is a period for which no modification, necrosis nor destroy of granulocytes can be confirmed.

143. A program for executing a method for using a thermo therapy for treating or preventing a diseases or disorder of a patient, said method comprising:
A) a step for acquiring information of normal body temperature of the patient;
B) a step for increasing the body temperature of the patient to a therapeutic temperature higher than the normal body temperature by means of a thermo therapeutic means; and
C) maintaining the body temperature of the patient at the therapeutic temperature, over a period until an expression of HLA is confirmed to be increased.

144. The program according to claim 143, wherein said method further comprises; D) a step for specifying a therapeutic temperature for exhibiting the thermo therapeutic effect against the patient based on a Redox electric potential or pH value of the patient at the maximum.

145. A temperature control system having at least two kinds of temperature control means;
said temperature control means each having different specific heat or difference performance for varying the temperature.

146. The temperature control system according to claim 145, wherein said at least two kinds of temperature control means comprise first temperature control means and second temperature control means, and
the system further comprises means which orders to actuate the first temperature control means when the subjective to be thermally controlled has a temperature deviating from a prescribed range, and orders so that the first temperature control means is stopped and the second temperature control means is actuated when the subjective to be thermally controlled has a temperature within the prescribed range.

147. The temperature control system according to claim 145, wherein said at least two kinds of temperature control means comprise first temperature control means and second temperature control means, and
the system further comprises means which orders so that the first temperature control means is actuated and the second temperature control means is placed so as to be thermally insulated from the subject when the subjective to be thermally controlled has a temperature deviating from a prescribed range, and the first temperature control means is stopped and is placed so as to be thermally insulated from the subject and the second is actuated when the subjective to be thermally controlled has a temperature within the prescribed range.

148. A method for regulating a temperature of a subjective to a therapeutic temperature, which comprises:
A) a step for actuating first temperature control means when the subjective to be thermally controlled has a temperature deviating from a prescribed range, and
B) a step for stopping the first temperature control means and actuating the second temperature control means having a specific heat or a performance for varying the temperature lower than that of the first temperature means when the subjective to be thermally controlled has a temperature within the prescribed range.

149. The method according to claim 148, which further comprises C) a step for stopping the first temperature control means when the temperature of the subjective is arriving at the therapeutic temperature.

150. A system for specifying a therapeutic temperature of a patient for exhibiting the thermo therapeutic effect against the patient at the maximum, which comprises
an assay system for detecting the therapeutic temperature based on redox electric potential or a pH value of the patient.

151. The system according to claim 150. wherein said therapeutic temperature of the patient is determined further based on the change in the living body selected from the group consisting of:
a) an amount and a function of hsp 72 in the blood of the patient;
b) a change in blood pressure pg the patient;
c) a hart rate of the patient;
d) a blood flow of the patient;
e) a pH of the blood of the patient;
f) an amount of expressing HLA in the blood of the patient; and
g) a number of lymphocytes in the blood of the patient.

152. The system according to claim 150, which further comprises means for extracting a sample of living body from the patient.
